(19) United States
(12) Patent Application Publication
(10) Pub. No.: US 2002/0058211 A1
(43) Pub. Date: May 16, 2002

(54) Photothermographic material

(76) Inventor: Takeshi Sampei, Tokyo (JP)

Correspondence Address: BIERMAN MUSERLIAN AND LUCAS, 600 THIRD AVENUE, NEW YORK, NY, 10016

(21) Appl. No.: 09/804,329

(22) Filed: Mar. 12, 2001

(30) Foreign Application Priority Data
Mar. 16, 2000 (JP) 074048/2000

(51) Int. Cl. G03C 1/498; G03C 5/00

(52) U.S. Cl. 430/353; 430/620; 430/607

(57) ABSTRACT

A photothermographic material is disclosed, comprising a support, a silver halide, an organic silver salt and a reducing agent, wherein the photothermographic material meets the following requirement:

γ₂₁/γ₀>0.7

where γ₀ and γ₂₁ are each a slope of a straight line connecting densities of 0.1 and 2.5 on a characteristic curve obtained when the photographic material is subjected to thermal development at 120° C. for 25 sec., and at 118° C. for 25 sec., respectively.

### FIELD OF THE INVENTION

The present invention relates to thermally developable photothermographic materials exhibiting superior transportability when being subjected to thermal processing by an automatic thermal processor, little fogging after processing and improved stability toward variation in processing conditions, and an imaging method by the use thereof.

### BACKGROUND OF THE INVENTION

In the field of graphic arts and medical treatment, there have been problems in working property with respect to effluents produced from wet-processing of image forming materials, and recently, reduction of the processing effluent is strongly demanded in terms of environmental protection and space saving.

Accordingly, there are needed techniques regarding photothermographic materials for photographic use which are capable of forming black images exhibiting high sharpness, enabling efficient exposure by means of a laser imager or laser image setter. As such a technique known are thermally developable photothermographic materials, which comprise a support having thereon an organic silver salt, light-sensitive silver halide grains, a reducing agent and a binder, as described in U.S. Pat. Nos. 3,152,904 and 3,487,075; and Morgan, “Dry Silver Photographic Material” (Handbook of Imaging Materials, page 48, 1991, Marcel Dekker Inc.) etc.

The photothermographic materials described above contain a reducing agent, producing problems in raw stock stability, in particular storage stability at a relatively high temperature. Further, there have been problems that no fixing treatment is conducted after thermal development, resulting in increased fogging after storage. Improvements of such problems are therefore desired in photothermographic materials.

### SUMMARY OF THE INVENTION

Accordingly, it is an object of the present invention to provide thermally developable photothermographic materials exhibiting superior transportability when being subjected to thermal processing by an automatic thermal processor, little fogging after processing and improved stability toward variation in processing conditions, and an imaging method by the use thereof.

The object of the invention can be accomplished by the following constitution:

1. A photothermographic material comprising a support, a silver halide, an organic silver salt and a reducing agent, wherein the photothermographic material meets the following requirement:

γ₂₁/γ₀>0.7

wherein γ₀ is a gamma value obtained when the photographic material is subjected to thermal development at 120° C. for 25 sec., and γ₂₁ is a gamma value obtained when the photographic material is subjected to thermal development at 118° C. for 25 sec., provided that the gamma value is represented by a slope of a straight line connecting densities of 0.1 and 2.5 on a characteristic curve obtained when the photographic material is subjected to the thermal development;

2. The photothermographic material described in 1, wherein the photothermographic material comprises an image forming layer, the image forming layer containing the silver halide and the organic silver salt;

3. The photothermographic material described in 2, wherein the image forming layer contains the reducing agent;

4. The photothermographic material described in 2, wherein the photothermographic material comprises a component layer adjacent to the image forming layer, the component layer containing the reducing layer;

5. The photothermographic material described in 1, wherein the photothermographic material comprises a contrast-increasing agent;

6. The photothermographic material described in 1, wherein the photothermographic material comprises an acid anhydride;

7. The photothermographic material described in 1, wherein the photothermographic material comprises a compound represented by formula (1) or (2):

formula (1)

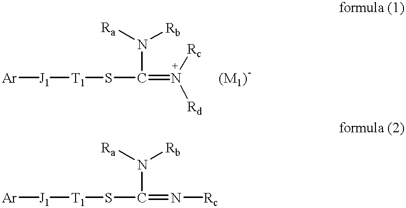

wherein Ar is an aromatic hydrocarbon group or an aromatic heterocyclic group; T₁ is a bivalent linkage group comprised of an aliphatic hydrocarbon group or a bond; J₁ is a bivalent linkage group containing at least one of an oxygen atom, a sulfur atom and a nitrogen atom or a bond; Ra, Rb, Rc and Rd are each a hydrogen atom, an acyl group, an aliphatic hydrocarbon group, an aryl group or a heterocyclic group, or in formula (1), Ra and Rb, Rc and Rd, Ra and Rc, or Rb and Rd combine with each other to form a nitrogen containing ring and in formula (2) Ra and Rb, Ra and Rc, or Rb and Rc combine with each other to form a nitrogen containing ring; (M₁)⁻ represents an ion necessary to neutralize an intramolecular charge;

8. The photothermographic material described in 1, wherein the photothermographic material exhibits an equilibrium moisture content of not more than 2% by weight;

9. The photothermographic material described in 1, wherein the silver halide comprises silver halide grains having a grain size of less than 0.01 μm;

10. The photothermographic material described in 1, wherein the organic silver salt is comprised of grains exhibiting an average grain diameter of not more than 2 μm;

11. The photothermographic material described in 1, wherein the organic silver salt is comprised of monodisperse grains;

12. The photothermographic material described in 1, wherein the organic silver salt is comprised of tabular grains;

13. The photothermographic material described in 1, wherein the photothermographic material meets the following requirement:

log(S₀/S₁₁)<0.7

wherein S₀ is a sensitivity obtained when the photographic material is subjected to thermal development at 120° C. for 25 sec., and S₁₁ is a sensitivity obtained when the photographic material is subjected to thermal development at 120° C. for 20 sec., provided that the sensitivity is represented by a reciprocal of an exposure amount giving a density of 2.5 when the photographic material is subjected to the thermal development;

14. The photothermographic material described in 1, wherein the photothermographic material meets the following requirement:

γ₁₁/γ₀≦0.8

wherein γ₀ is a gamma value obtained when the photographic material is subjected to thermal development at 120° C. for 25 sec., and γ₁₁ is a gamma value obtained when the photographic material is subjected to thermal development at 120° C. for 20 sec., provided that the gamma value is represented by a slope of a straight line connecting densities of 0.1 and 2.5 on a characteristic curve obtained when the photographic material is subjected to the thermal development;

15. The photothermographic material described in 1, wherein the photothermographic material meets the following requirement:

Dmax₁₁/Dmax₀>0.8

wherein Dmax₀ is a maximum density obtained when the photographic material is subjected to thermal development at 120° C. for 25 sec., and Dmax₁₁ is a maximum density obtained when the photographic material is subjected to the thermal development at 120° C. for 20 sec;

16. The photothermographic material described in 1, wherein the photothermographic material meets the following requirement:

log(S₀/S₂₁)<1.0

wherein S₀ is a sensitivity obtained when the photographic material is subjected to thermal development at 120° C. for 25 sec., and S₂₁ is a sensitivity obtained when the photographic material is subjected to thermal development at 118° C. for 25 sec., provided that the sensitivity is represented by a reciprocal of an exposure amount giving a density of 2.5 when the photographic material is subjected to the thermal development;

17. The photothermographic material described in 1, wherein the photothermographic material meets the following requirement:

Dmax₂₁/Dmax₀>0.7

wherein Dmax₀ is a maximum density obtained when the photographic material is subjected to thermal development at 120° C. for 25 sec., and Dmax₂₁ is a maximum density obtained when the photographic material is subjected to thermal development at 118° C. for 25 sec.;

18. An image forming method of a photothermographic material comprising the steps of:

imagewise exposing the photothermographic material to a laser, and

subjecting the exposed photothermographic material to thermal development by the use of an automatic thermal processor,

wherein the photothermographic material comprising a support, a silver halide, an organic silver salt and a reducing agent, wherein the photothermographic material meets the following requirement:

γ₂₁/γ₀>0.7

wherein γ₀ is a gamma value obtained when the photographic material is subjected to thermal development at 120° C. for 25 sec., and γ₂₁ is a gamma value obtained when the photographic material is subjected to thermal development at 118° C. for 25 sec., provided that the gamma value is represented by a slope of a straight line connecting densities of 0.1 and 2.5 on a characteristic curve obtained when the photographic material is subjected to the thermal development;

19. The image forming method described in 18, wherein the processor comprises a planar heating member and a transport roller and the photothermographic material is allowed to pass through between the transport roller and the planar heating member, while the photothermographic material is brought into contact with the planar heating member to be thermally developed;

20. The image forming method described in 19, wherein the planar heating member comprises a gigged material;

21. A photothermographic material comprising a support having thereon a silver halide, an organic silver salt and a reducing agent, wherein the photothermographic material exhibits a sensitivity meeting the following requirement (1):

requirement (1)

log(S₀/S₁₁)<0.7

wherein S₀ is a sensitivity obtained when the photographic material is subjected to thermal development at 120° C. for 25 sec., and S₁₁ is a sensitivity obtained when the photographic material is subjected to thermal development at 120° C. for 20 sec., provided that the sensitivity is represented by a reciprocal of an exposure amount giving a density of 2.5 when the photographic material is subjected to thermal development;

22. A photothermographic material comprising a support having thereon a silver halide, an organic silver salt and a reducing agent, wherein the photothermographic material exhibits a gamma value meeting the following requirement (2):

requirement (2)

γ₁₁/γ₀>0.8

wherein γ₀ is a gamma value obtained when the photographic material is subjected to thermal development at 120° C. for 25 sec., and γ₁₁ is a gamma value obtained when the photographic material is subjected to thermal development at 120° C. for 20 sec., provided that the gamma value is represented by a slope of a straight line connecting densities of 0.1 and 2.5 on a characteristic curve obtained when the photographic material is subjected to thermal development;

23. A photothermographic material comprising a support having thereon a silver halide, an organic silver salt and a reducing agent, wherein the photothermographic material exhibits a maximum density meeting the following requirement (3):

requirement (3)

Dmax₁₁/Dmax₀>0.8

wherein Dmax₀ is a maximum density obtained when the photographic material is subjected to thermal development at 120° C. for 25 sec., and Dmax₁₁ is a maximum density obtained when the photographic material is subjected to thermal development at 120° C. for 20 sec.;

24. A photothermographic material comprising a support having thereon a silver halide, an organic silver salt and a reducing agent, wherein the photothermographic material exhibits a sensitivity meeting the following requirement (4):

requirement (4)

log(S₀/S₂₁)<1.0

wherein S₀ is a sensitivity obtained when the photographic material is subjected to thermal development at 120° C. for 25 sec., and S₂₁ is a sensitivity obtained when the photographic material is subjected to thermal development at 118° C. for 25 sec., provided that the sensitivity is represented by a reciprocal of an exposure amount giving a density of 2.5 when the photographic material is subjected to thermal development;

25. A photothermographic material comprising a support having thereon a silver halide, an organic silver salt and a reducing agent, wherein the photothermographic material exhibits a gamma value meeting the following requirement (5):

requirement (5)

γ₂₁/γ₀>0.7

wherein γ₀ is a gamma value obtained when the photographic material is subjected to thermal development at 120° C. for 25 sec., and γ₂₁ is a gamma value obtained when the photographic material is subjected to thermal development at 118° C. for 25 sec., provided that the gamma value is represented by a slope of a straight line connecting densities of 0.1 and 2.5 on a characteristic curve obtained when the photographic material is subjected to thermal development;

26. A photothermographic material comprising a support having thereon a silver halide, an organic silver salt and a reducing agent, wherein the photothermographic material exhibits a maximum density meeting the following requirement (6):

requirement (6)

Dmax₂₁/Dmax₀>0.7

wherein Dmax₀ is a maximum density obtained when the photographic material is subjected to thermal development at 120° C. for 25 sec., and Dmax₂₁ is a maximum density obtained when the photographic material is subjected to thermal development at 118° C. for 25 sec.;

27. The photothermographic material described in any one of 21 through 26 above, wherein a component layer provided on the organic silver salt-containing side contains a hardening agent;

28. The photothermographic material described in any one of 21 through 27 above, wherein a component layer provided on the organic silver salt-containing side contains an acid anhydride;

29. The photothermographic material described in any one of 21 through 28 above, wherein a component layer provided on the organic silver salt-containing side contains a compound represented by the following formula (1) or (2):

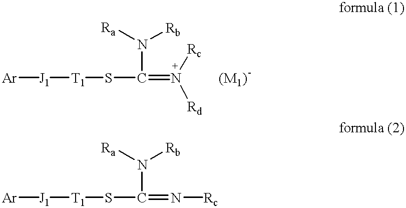

wherein Ar is an aromatic hydrocarbon group or an aromatic heterocyclic group; T₁ is a bivalent linkage group comprised of an aliphatic hydrocarbon group or a direct bond; J₁ is a bivalent linkage group containing at least one of an oxygen atom, a sulfur atom and a nitrogen atom or a bond; Ra, Rb, Rc and Rd are each a hydrogen atom, an acyl group, an aliphatic hydrocarbon group, an aryl group or a heterocyclic group, or in formula (1), Ra and Rb, Rc and Rd, Ra and Rc, or Rb and Rd combine with each other to form a nitrogen containing ring and in formula (2) Ra and Rb, Ra and Rc, or Rb and Rc combine with each other to form a nitrogen containing ring; (M₁)⁻ represents an ion necessary to neutralize an intramolecular charge;

30. The photothermographic material described in any one of 21 through 29 above, wherein the photothermographic material exhibits an equilibrium moisture content of not more than 2% by weight; and

31. An image forming method comprising subjecting the photothermographic material described in any one of 1 through 10 above to exposure and thermal development to form an image.

### BRIEF EXPLANATION OF THE DRAWING

FIG. 1 illustrates an example of thermally processors used in this invention.

### DETAILED DESCRIPTION OF THE PREFERRED EMBODIMENTS

The photothermographic material of this invention comprises a support, a silver halide, an organic silver salt and a reducing agent, meeting the following requirement (5):

requirement (5)

γ₂₁/γ₀>0.7

wherein γ₀ is a gamma value obtained when the photographic material is subjected to thermal development at 120° C. for 25 sec., and γ₂₁ is a gamma value obtained when the photographic material is subjected to thermal development at 118° C. for 25 sec., provided that the gamma value is represented by a slope of a straight line connecting densities of 0.1 and 2.5 on a characteristic curve obtained when the photographic material is subjected to thermal development. In this case, 1.2>γ₂₁/γ₀>0.7 is preferable and 1.0>γ₂₁/γ₀>0.7 is more preferable.

Further, the photothermographic material of this invention preferably meets the following requirements:

requirement (1)

log(S₀/S₁₁)<0.7

wherein S₀ is a sensitivity obtained when the photographic material is subjected to thermal development at 120° C. for 25 sec., and S₁₁ is a sensitivity obtained when the photographic material is subjected to thermal development at 120° C. for 20 sec., provided that the sensitivity is represented by a reciprocal of an exposure amount giving a density of 2.5 when the photographic material is subjected to thermal development, and further, in this case, 0.5<log(S₀/S₁₁)<0.7 is more preferable and 0<log(S₀/S₁₁)<0.7 is preferable;

requirement (2)

γ₁₁/γ₀>0.8

wherein γ₀ is a gamma value obtained when the photographic material is subjected to thermal development at 120° C. for 25 sec., and γ₁₁ is a gamma value obtained when the photographic material is subjected to thermal development at 120° C. for 20 sec., provided that the gamma value is represented by a slope of a straight line connecting densities of 0.1 and 2.5 on a characteristic curve obtained when the photographic material is subjected to thermal development, and further in this case, 1.4>γ₁₁/γ₀>0.8 is preferred and 1.0>γ₁₁/γ₀>0.8 is more preferred;

requirement (3)

Dmax₁₁/Dmax₀>0.8

wherein Dmax₀ is a maximum density obtained when the photographic material is subjected to thermal development at 120° C. for 25 sec., and Dmax₁₁ is a maximum density obtained when the photographic material is subjected to thermal development at 120° C. for 20 sec., and further in this case, 1.3>Dmax₁₁/Dmax₀>0.8 is preferred and 1.1>Dmax₁₁/Dmax₀>0.8 is more preferred;

equation (4)

log(S₀/S₂₁)<1.0

wherein S₀ is a sensitivity obtained when the photographic material is subjected to thermal development at 120° C. for 25 sec., and S₂₁ is a sensitivity obtained when the photographic material is subjected to thermal development at 118° C. for 25 sec., provided that the sensitivity is represented by a reciprocal of an exposure amount giving a density of 2.5 when the photographic material is subjected to thermal development, and further in this case, −0.5<log(S₀/S₂₁)<1.0 is preferred, and 0<log(S₀/S₂₁)<1.0 is more preferred; and

requirement (6)

Dmax₂₁/Dmax₀>0.7

wherein Dmax₀ is a maximum density obtained when the photographic material is subjected to thermal development at 120° C. for 25 sec., and Dmax₂₁ is a maximum density obtained when the photographic material is subjected to thermal development at 118° C. for 25 sec, further in this case, 1.3>Dmax₂₁/Dmax₀>0.7 is preferred, and 1.1>Dmax₂₁/Dmax₀>0.7 is more preferred.

The photothermographic materials according to this invention are applicable for use in graphic arts and medical examination, and preferably for use in graphic arts.

In this invention, the photothermographic material being subjected to thermal development at a developing temperature for a developing time mean that the photothermographic material of this invention is subjected to heating at a prescribed temperature for a prescribed time in an oven maintained at the prescribed temperature.

To meet the foregoing requirements, it is preferred to combine the following means:

1) the photothermographic material having an equilibrium moisture content of not more than 2% by weight,

2) silver halide grains containing silver halide rains of less than 0.01 μm,

3) the organic silver having an average grain size of not more than 2 μm and being a monodisperse tabular grains,

4) a hardening agent being contained on the image forming layer side,

5) an acid anhydride being contained on the image forming layer side, and

6) a compound represented by formula (1) or (2) being contained on the image forming layer side.

The equilibrium moisture content is represented by the following equation:

D (% by weight)=(w/W)×100

where D is a moisture content, W is a weight of a photothermographic material which is at equilibrium under an atmosphere of 25° C. and 60% RH, and w is a weight of moisture contained in the photothermographic material. In this invention, the moisture content of the photothermographic material is preferably not more than 2% by weight, more preferably 0.005 to 2% by weight, and still more preferably 0.01 to 1% by weight.

The moisture content of not more than 2% by weight can be achieved by coating by the use of an organic solvent having a solubility in water of not more than 2% by weight. Examples of such an organic solvent include benzene, toluene, xylene, hexane, cyclohexane, diethyl ether, di-isopropyl ether, hydrofluoroether, methylene chloride, chloroform, and trichloroethylene. The organic solvent having a solubility in water of not more than 2% by weight may be used alone or in combination thereof. Further, within the range meeting the condition that the moisture content of a coating solution is not more than 2% by weight, the water-miscible solvent described below may be used in combination. Alternatively, using a water-miscible solvent, the equilibrium content of not more than 2% by weight can be achieved using a polymer latex having an equilibrium moisture content of 0.01 to 2% by weight, and preferably 0.01 to 1% by weight at 25° C. and 60% RH. Definition and measurements methods of the equilibrium moisture content is referred to, for example, “KOBUNSHI KOHGAKU KOHZA 14, KOBUNSHIZAIRYO SHIKENHO (Series of Polymer Engineering 14, Testing Method of Polymer material, edited by Kobunshi-Gakkai, published by Chijin Shoin). Further alternatively, it is to maintain a photothermographic material, after coating and drying, in the form of a package covered with a packaging material non-water-permeable packaging material and occluding a desiccating agent for removing water. The desiccating agent is not specifically limited, if it can remove water by bringing into contact with it. Examples the desiccating agent include silica gel, molecular sieves, anhydrous magnesium sulfate, anhydrous sodium sulfate, pure iron and an iron compound. Of these, silica gel is preferred.

The equilibrium moisture content can be determined in the following manner. After being allowed to stand in an atmosphere at 25° C. and 60% RH for 24 hrs., a photothermographic material sample is cut to a sheet of 46.5 cm² and after the cut sheet is weighed, the sheet is further finely cut to 5 mm or so, put into a vial and after being shielded with a septum and cap, is set into a head space sampler, e.g., head space sampler HP7694, available from Hewlett-Packard Co. The head space sampler is heated at 120° C. for 20 min. and evaporated moisture is determined by the Karl Fischer's method.

In this invention it is preferred to contain silver halide grains having a grain size of less than 0.01 μm, and more preferably 0.0005 to 0.01 μm. The grain size as described herein is defined as an edge length of silver halide grains, in cases where they are so-called regular crystals in the form of cube or octahedron. Furthermore, in cases where grains are not regular crystals, for example, spherical, cylindrical, and tabular grains, the grain size refers to the diameter of a sphere having the same volume as the silver grain. To provide photosensitivity, it is preferred to contain silver halide grains having a grain size of 0.01 to 0.1 μm.

To prepare silver halide grains having a grain size of less than 0.01 μm, a silver halide-forming component is allowed to act onto a pre-formed organic silver salt solution or dispersion or a sheet material containing an organic silver salt to convert a part of the organic silver salt to photosensitive silver halide. The thus formed silver halide is effectively in contact with the organic silver salt, exhibiting favorable actions. In this case, the silver halide-forming component refers to a compound capable of forming silver salt upon reaction with the organic silver salt. Such a compound can be distinguished by the following simple test. Thus, a compound to be tested is to be mixed with the organic silver salt, and if necessary, the presence of a peal specific to silver halide can be confirmed by the X-ray diffractometry, after heating. Compounds that have been confirmed to be effective as a silver halide-forming component include inorganic halide compounds, onium halides, halogenated hydrocarbons, N-halogeno compounds and other halogen containing compounds. These compounds are detailed in U.S. Pat. Nos. 4,009,039, 3,457,075 and 4,003,749, British Patent 1,498,956 and JP-A Nos. 53-27027 and 53-25420 (hereinafter, the term, JP-A means an unexamined, published Japanese Patent Application). Exemplary examples thereof are shown below:

(1) Inorganic halide compound: e.g., a halide compound represented by formula, MXn, in which M represents H, NH4 or a metal atom; n is 1 when M is H or NH4 and a number equivalent to a valence number of the metal atom when M is the metal atom; the metal atom includes lithium, sodium, potassium, cesium, magnesium, calcium, strontium, barium, zinc, cadmium, mercury, tin, antimony, chromium, manganese, cobalt, rhodium, and cerium, and molecular halogen such as aqueous bromine being also effective;

(2) Onium halide: e.g., quaternary ammonium halides such as trimethylphenylammonium bromide, cetylethyldimethylammonium bromide, and trimethylbenzylammonium bromide; and tertiary sulfonium halides such as trimethylsulfonium iodide;

(3) Halogenated hydrocarbons: e.g., iodoform, bromoform, carbon tetrachloride and 2-brom-2-methylpropane;

(4) N-halogeno compounds: e.g., N-chlorosuccinimide, N-bromosucciimde, N-bromophthalimide, N-bromoacetoamide, N-iodosuccinimide, N-bromophthalazinone, N-bromooxazolinone, N-chlorophthalazinone, N-bromoacetoanilide, N,N-dibromobenzenesulfonamide, N-bromo-N-methylbenzenesulfonamide, 1,3-dibromo-4,4-dimethylhydantoin and N-bromourazole;

(5) Other halogen containing compounds: e.g., triphenylmethyl chloride, triphenylmethyl bromide 2-bromoacetic acid, 2-bromoethanol and dichlorobenzophenone.

Silver halide grains having grain sizes of 0.01 to 0.1 82 m can be prepared according to the methods commonly known in the photographic art, such as single jet or double jet addition, or ammoniacal, neutral or acidic precipitation. Thus, the silver halide emulsion is prepared in advance and then the emulsion is mixed with other components of the invention to be incorporated into the composition used in the invention. To sufficiently bring the photosensitive silver halide into contact with an organic silver salt, there can be applied such techniques that polymers other than gelatin, such as polyvinyl acetal are employed as a protective colloid in the formation of photosensitive silver halide, as described in U.S. Pat. Nos. 3,706,564, 3,706,5653, 713,833 and 3,748,143, British Patent 1,362,970; gelatin contained in a photosensitive silver halide emulsion is degraded with an enzyme, as described in British Patent 1,354,186; or photosensitive silver halide grains are prepared in the presence of a surfactant to save the use of a protective polymer, as described in U.S. Pat. No. 4,076,539.

The silver halide grains having grain sizes of 0.01 to 0.1 μm preferably functions as light sensor. Silver halide grains are preferably small in size to prevent milky-whitening after image formation and obtain superior images. The grain size is preferably not more than 0.1 μm, more preferably, 0.01 to 0.1 μm, and still more preferably, 0.02 to 0.08 μm. The form of silver halide grains is not specifically limited, including cubic or octahedral, regular crystals and non-regular crystal grains in a spherical, bar-like or tabular form. Halide composition thereof is not specifically limited, including any one of silver chloride, silver chlorobromide, silver iodochlorobromide, silver bromide, silver iodobromide, and silver iodide.

The silver halide grains having a grain size of less than 0.01 μm is preferably contained in an amount of not less than 1%, and ore preferably 5 to 70%, based on the total silver halide grains.

Light sensitive silver halide grains used in the photothermographic material of this invention can also prepared in such a manner that in the process of forming the organic silver salt, a halide component such as a halide ion is allowed to be present concurrently with an organic silver salt-forming component and silver ions are added thereto to form silver halide grains simultaneously with the formation of an organic silver salt, as described in British patent No. 1,447,454.

The silver halide forming component is used stoichiometrically in a small amount per organic silver salt. Thus, it is preferably 0.001 to 0.7 mol, and more preferably 0.03 to 0.5 mol per mol of organic silver salt. The silver halide-forming component may be used in combination. Conditions including a reaction temperature, reaction time and reaction pressure during the process of converting a part of the organic silver salt to silver halide using the silver halide forming component can be appropriately set in accordance with the purpose of preparation. The reaction temperature is preferably −20° C. to 70° C., the reaction time is preferably 0.1 sec to 72 hrs. and the reaction pressure is preferably atmospheric pressure. The reaction is performed preferably in the presence of polymer as a binder, wherein the polymer to be used is preferably 0.01 to 100 weight parts, and more preferably 0.1 to 10 weight parts per 1 weight part of an organic silver salt.

The thus formed photosensitive silver halide can be chemically sensitized with a sulfur containing compound, gold compound, platinum compound, palladium compound, silver compound, tin compound, chromium compound or their combination. The method and procedure for chemical sensitization are described in U.S. Pat. No. 4,036,650, British Patent No. 1,518,850, JP-A No. 51-22430, 51-78319 and 51-81124. As described in U.S. Pat. No. 3,980,482, a low molecular weight amide compound may be concurrently present to enhance sensitivity at the time of converting a part of the organic silver salt to photosensitive silver halide.

To improve reciprocity law failure or adjust contrast, the photosensitive silver halide may be contained with metal ions of the 6th group to 10th group in the periodical table, such as Rh, Ru, Re, Ir, Os, Fe and their complexes and complex ions. Specifically, complex ions are preferred, e.g., Ir complex ions such as IrCl₆²⁻ are preferably contained to improve reciprocity law failure.

The light sensitive silver halide grains used in this invention may be subjected to chemical sensitization. Chemical sensitization usable in this invention includes chemical sensitization commonly known in the art, such as sulfur sensitization, selenium sensitization, tellurium sensitization, noble metal sensitization with gold compounds or platinum, palladium and iridium compounds, and reduction sensitization. As a compound used for sulfur sensitization, selenium sensitization, tellurium sensitization, commonly known compounds can be used, for example, as described in JP-A No. 7-128768. Examples of preferred compounds used for noble metal sensitization include chloroauric acid, potassium chloroaurate, potassium auriothiocyanate, gold selenide, gold selenide and compounds described in U.S. Pat. No. 2,448,060 and British Patent No. 618,061. Examples of compounds used for reduction sensitization include stannous chloride, aminoiminomethanesulfinic acid, hydrazine derivatives, borane compounds, silane compounds and polyamini compounds as well as ascorbic acid and thiourea dioxide. The reduction sensitization can be conducted ripening the emulsion at a pH of not less than 7 or at a pAg of nor more than 8.3. Further, reduction sensitization can be achieved by single introduction of silver ions during the grain formation.

Organic silver salts used in the invention are reducible silver source, and silver salts of organic acids or organic heteroacids are preferred and silver salts of long chain fatty acid (preferably having 10 to 30 carbon atom and more preferably 15 to 25 carbon atoms) or nitrogen containing heterocyclic compounds are more preferred. Specifically, organic or inorganic complexes, ligand of which has a total stability constant to a silver ion of 4.0 to 10.0 are preferred. Exemplary preferred complex salts are described in Research Disclosure (hereinafter, also denoted as RD) 17029 and RD29963, including organic acid salts (for example, salts of gallic acid, oxalic acid, behenic acid, stearic acid, palmitic acid, lauric acid, etc.); carboxyalkylthiourea salts (for example, 1-(3-carboxypropyl)thiourea, 1-(3-caroxypropyl)-3,3-dimethylthiourea, etc.); silver complexes of polymer reaction products of aldehyde with hydroxy-substituted aromatic carboxylic acid (for example, aldehydes (formaldehyde, acetaldehyde, butylaldehyde, etc.), hydroxy-substituted acids (for example, salicylic acid, benzoic acid, 3,5-dihydroxybenzoic acid, 5,5-thiodisalicylic acid, silver salts or complexes of thiones (for example, 3-(2-carboxyethyl)-4-hydroxymethyl-4-(thiazoline-2-thione and 3-carboxymethyl-4-thiazoline-2-thione), complexes of silver with nitrogen acid selected from imidazole, pyrazole, urazole, 1.2,4-thiazole, and 1H-tetrazole, 3-amino-5-benzylthio-1,2,4-triazole and benztriazole or salts thereof; silver salts of saccharin, 5-chlorosalicylaldoxime, etc.; and silver salts of mercaptides. Of these organic silver salts, silver behenate, silver arachidate and silver stearate are specifically preferred.

The organic silver salt compound can be obtained by mixing an aqueous-soluble silver compound with a compound capable of forming a complex. Normal precipitation, reverse precipitation, double jet precipitation and controlled double jet precipitation described in JP-A 9-127643 are preferably employed. For example, to an organic acid is added an alkali metal hydroxide (e.g., sodium hydroxide, potassium hydroxide, etc.) to form an alkali metal salt soap of the organic acid (e.g., sodium behenate, sodium arachidate, etc.), thereafter, the soap and silver nitrate are mixed by the controlled double jet method to form organic silver salt crystals. In this case, silver halide grains may be concurrently present.

In the present invention, organic silver salts have an average grain diameter of 2 μm or less and are monodisperse. Monodisperse grains refer to those exhibiting the degree of dispersion defined below of not more than 50%, preferably not more than 40%, and more preferably 0.1 to 35%:

Dispersion (%)=(standard deviation of grain diameter)/(average grain diameter)×100

The average diameter of the organic silver salt as described herein is, when the grain of the organic salt is, for example, a spherical, cylindrical, or tabular grain, a diameter of the sphere having the same volume as each of these grains. The average grain diameter is preferably between 0.05 and 1.5 μm, more preferably between 0.05 and 1.0 μm. It is also preferred that at least 60% of the total of the organic silver salt is accounted for by tabular grains. The tabular grains refer to grains having a ratio of an average grain diameter to grain thickness, i.e., aspect ratio (denoted as AR) of 3 or more:

AR=average diameter (μm)/thickness (μm)

To obtain such tabular organic silver salts, organic silver salt crystals are pulverized together with a binder or surfactant, using a ball mill. Thus, using these tabular grains, photosensitive materials exhibiting high density and superior image fastness are obtained.

To prevent hazing of the photosensitive material, the total amount of silver halide and organic silver salt is preferably 0.5 to 2.2 g in equivalent converted to silver per m², leading to high contrast images. The amount of silver halide is preferably 50% by weight or less, more preferably 25% by weight or less, and still more preferably 0.1 to 15% by weight, based on the total silver amount.

To effectively display the effects of this invention, it is preferred that the photothermographic material of this invention contains a contrast-increasing agent in a layer provided on the image forming layer side. The contrast-increasing agent is preferably hydrazine derivatives, vinyl compounds, or quaternary onium compounds. The vinyl compound and quaternary onium compound are represented by the following formulas (G) and (P), respectively:

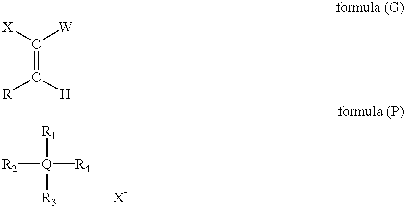

On formula (G), X and R may be either cis-form or trans-form. The structure of its exemplary compounds is also similarly included.

Preferred hydrazine derivatives are represented by the following formula (H):

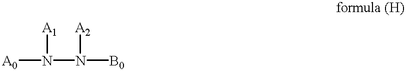

In the formula, A₀ is an aliphatic group, aromatic group, heterocyclic group, each of which may be substituted, or —G₀—D₀ group; B₀ is a blocking group; A₁ and A₂ are both hydrogen atoms, or one of them is a hydrogen atom and the other is an acyl group, a sulfonyl group or an oxalyl group, in which G₀ is a —CO—, —COCO—, —CS—, —C(═NG₁D₁)—, —SO—, —SO₂— or —P(O) (G₁D₁)— group, in which G₁ is a linkage group, or a —O—, —S— or —N(D₁)— group, in which D₁ is a hydrogen atom, or an aliphatic group, aromatic group or heterocyclic group, provided that when a plural number of D₁ are present, they may be the same with or different from each other and D₀ is an aliphatic group, aromatic group, heterocyclic group, amino group, alkoxy group, aryloxy group, alkylthio group or arylthio group.

In formula (H), an aliphatic group represented by A₀ of formula (H) is preferably one having 1 to 30 carbon atoms, more preferably a straight-chained, branched or cyclic alkyl group having 1 to 20 carbon atoms. Examples thereof are methyl, ethyl, t-butyl, octyl, cyclohexyl and benzyl, each of which may be substituted by a substituent (such as an aryl, alkoxy, aryloxy, alkylthio, arylthio, sulfooxy, sulfonamido, sulfamoyl, acylamino or ureido group).

An aromatic group represented by A₀ of formula (H) is preferably a monocyclic or condensed-polycyclic aryl group such as a benzene ring or naphthalene ring. A heterocyclic group represented by A₀ is preferably a monocyclic or condensed-polycyclic one containing at least one hetero-atom selected from nitrogen, sulfur and oxygen such as a pyrrolidine-ring, imidazole-ring, tetrahydrofuran-ring, morpholine-ring, pyridine-ring, pyrimidine-ring, quinoline-ring, thiazole-ring, benzthiazole-ring, thiophene-ring or furan-ring. The aromatic group, heterocyclic group or —G₀—D₀ group represented by A₀ each may be substituted. Specifically preferred A₀ is an aryl group or —G₀-D₀ group.

A₀ contains preferably a non-diffusible group or a group for promoting adsorption to silver halide. As the non-diffusible group is preferable a ballast group used in immobile photographic additives such as a coupler. The ballast group includes an alkyl group, alkenyl group, alkynyl group, alkoxy group, phenyl group, phenoxy group and alkylphenoxy group, each of which has 8 or more carbon atoms and is photographically inert.

The group for promoting adsorption to silver halide includes a thioureido group, thiourethane, mercapto group, thioether group, thione group, heterocyclic group, thioamido group, mercapto-heterocyclic group or a adsorption group as described in JP A 64-90439.

In Formula (H), B₀ is a blocking group, and preferably —G₀—D₀, wherein G₀ is a —CO—, —COCO—, —CS—, —C(═NG₁D₁)—, —SO—, —SO₂— or —P(O) (G₁D₁)— group, and preferred G₀ is a —CO—, —COCOA—, in which G₁ is a linkage, or a —O—, —S— or —N(D₁)— group, in which D₁ represents a hydrogen atom, or an aliphatic group, aromatic group or heterocyclic group, provided that when a plural number of D₁ are present, they may be the same with or different from each other. D₀ is an aliphati group, heterocyclic group, amino group, alkoxy group or mercapto group, and preferably, a hydrogen atom, or an alkyl, alkoxy or amino group. A₁ and A₂ are both hydrogen atoms, or one of them is a hydrogen atom and the other is an acyl group, (acetyl, trifluoroacetyl and benzoyl), a sulfonyl group (methanesulfonyl and toluenesulfonyl) or an oxalyl group (ethoxaly).

A compound represented by formula [H] is exemplified as below, but the present invention is not limited thereto.

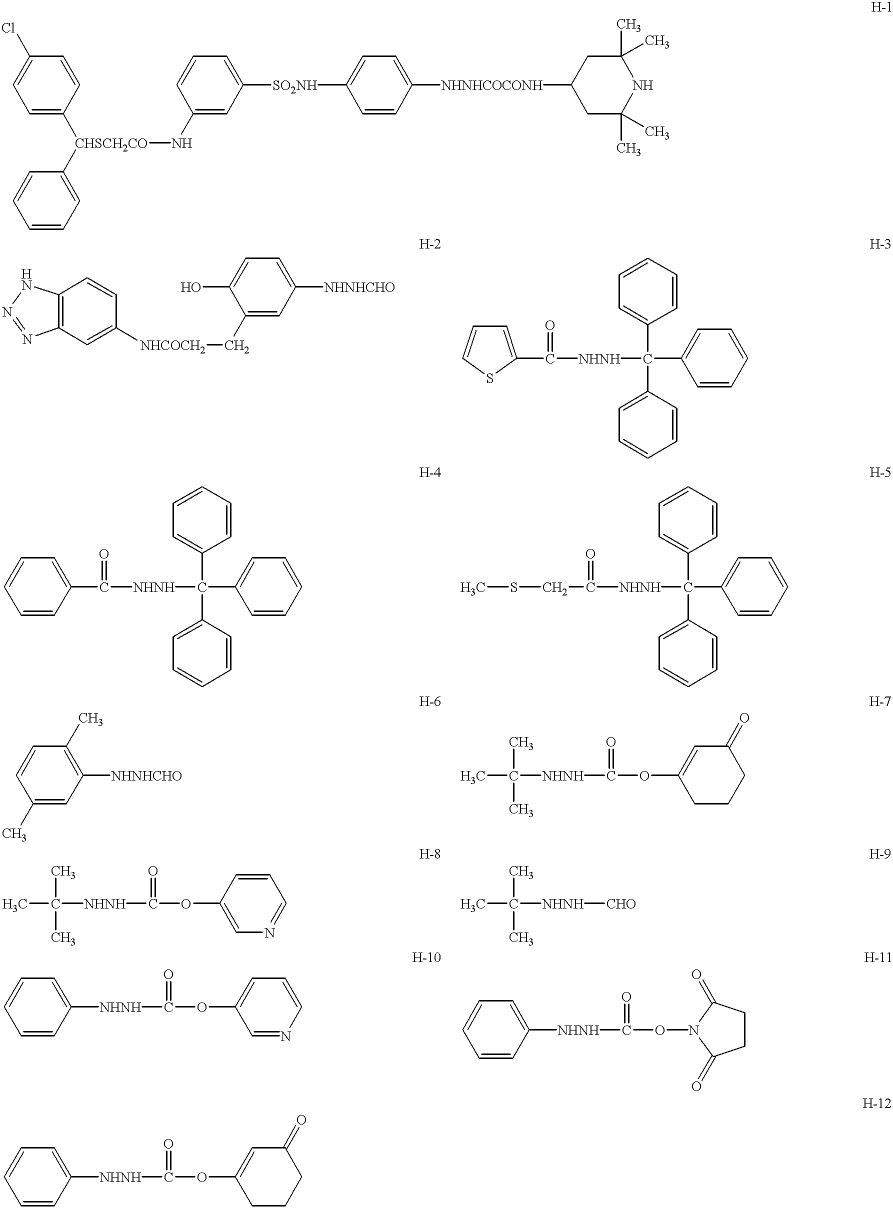

More preferred hydrazine compounds are represented by the following formulas (H-1), (H-2), (H-3) and (H-4):

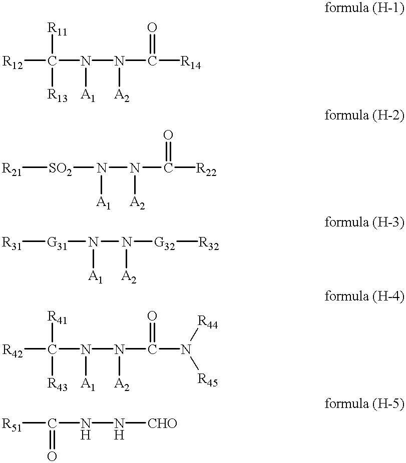

In formula (H-1), R₁₁, R₁₂ and R₁₃ are each a substituted or unsubstituted ary group or substituted or unsubstituted heteroary group (i.e., an aromatic heterocyclic group). Examples of the aryl group represented by R₁₁, R₁₂ or R₁₃ include phenyl, p-methylphenyl and naphthyl and examples of the heteroaryl group include a triazole residue, imidazole residue, pyridine residue, furan residue and thiophene residue. R₁₁, R₁₂ or R₁₃ may combine together with each other through a linkage group. Substituents which R₁₁, R₁₂ or R₁₃ each may have include, for example, an alkyl group, an alkenyl group, an alkynyl group, an aryl group, a heterocyclic group, a quaternary nitrogen containing heterocyclic group (e.g., pyridionyl), hydroxy, an alkoxy group (including containing a repeating unit of ethyleneoxy or propyleneoxy), an aryloxy group, an acyloxy group, an acyl group, an alkoxycarbonyl group, an aryloxycarbonyl group, a carbamoyl group, a urethane group, carboxy, an imodo group, an amino group, a carbonamido group, a sulfonamido group, a ureido group, a thioureido group, a sulfamoylamino group, semicarbazido group, thiosemocarbaido group, hydrazine group, a quaternary ammonio group, an alkyl-, aryl- or heterocyclic-thio group, mercapto group, an alkyl- or aryl-sufonyl group, an alkyl- or aryl-sulfinyl group, sulfo group, sulfamoyl group, an acylsufamoyl group, an alkyl or aryl-sulfonylureido group, an alkyl- or aryl-sulfonylcarbamoyl group, a halogen atom, cyano, nitro, and phosphoric acid amido group. All of R₁₁, R₁₂ and R₁₃ are preferably phenyl groups and more preferably unsubstituted phenyl groups.

R₁₄ is heterocyclic-oxy group or a heteroarylthio group. Examples of the heteroaryl group represented by R₁₄ include a pyridyloxy group, benzimidazolyl group, benzothiazolyl group, benzimidazolyloxy group, furyloxy group, thienyloxy group, pyrazolyloxy group, and imidazolyloxy group; and examples of the the heteroarylthio group include a pyridylthio group, pyrimidylthio group, indolylthio group, benzothiazolylthio, benzoimidazolylthio group, furylthio group, thienylthio group, pyrazolylthio group, and imidazolylthio group. R₁₄ is preferably a pyridyloxy or thenyloxy group.

A₁ and A₂ are both hydrogen atoms, or one of them is a hydrogen atom and the other is an acyl group (e.g., acetyl, trifluoroacetyl, benzoyl, etc.), a sulfonyl (e.g., methanesulfonyl, toluenesulfonyl, etc.), or oxalyl group (e.g., ethoxalyl, etc.). A₁ and A₂ are both preferably hydrogen atoms.

In formula (H-2), R₂₁ is a substituted or unsubstituted alkyl group, aryl group or heteroaryl group. Examples of the alkyl group represented by R₂₁ include methyl, ethyl, t-butyl, 2-octyl, cyclohexyl, benzyl, and diphenylmethyl; the aryl group, the heteroaryl group and the substituent groups are the same as defined in R₁₁, R₁₂ and R₁₃. In cases where R₂₁ is substituted, the substituent groups are the same as defined in R₁₁, R₁₂ and R₁₃. R₂₁ is preferably an aryl group or a heterocyclic group, and more preferably a phenyl group.

R₂₂ is a hydrogen atom, an alkylamino group, an arylamino group, or heteroarylamino group. Examples thereof includemethylamino, ethylamino, propylamino, butylamino, dimethylamino, diethylamino, and ethylmethylamino. Examples of the arylamino group include an anilino group; examples of the heteroaryl group include thiazolylamino, benzimidazolylamino and benzthiazolylamino. R₂₂ is preferably dimethylamino or diethylamino.A₁ and A₂ are the same as defined in formula (H-1).

In formula (H-3), R₃₁ and R₃₂ are each a univalent substituent group and the univalent substituent groups represented by R₃₁ and R₃₂ are the same as defined in R₁₁, R₁₂, and R₁₃ of formula (H-1), preferably an alkyl group, an aryl group, a heteroaryl group, an alkoxy group and an amino group, more preferably an aryl group or an alkoxy group, and specifically preferably, at least one of R₃₁ and R₃₂ t-butoxy and another preferred structure is that when R₃₁ is phenyl, R₃₂ is t-butoxycarbonyl.

G₃₁ and G₃₂ are each a —(CO)p— or —C(═S)— group, a sulfonyl group, a sulfoxy group, a —P(═O)R₃₃— group, or an iminomethylene group, in which R₃₃ is an alkyl group, an alkenyl group, an alkynyl group, an aryl group, an alkoxy group, an alkenyloxy group, an alkynyloxy group, an arylamino group or an amino group, provided that when G₃₁ is a sulfonyl group, G₃₂ is not a carbonyl group. G₃₁ and G₃₂ are preferably —CO—, —COCO—, a sulfonyl group or —CS—, and more preferably —CO— or a sulfonyl group. A₁ and A₂ are the same as defined in A₁ and A₂ of formula (H-1).

In formula (H-4), R₄₁, R₄₂ and R₄₃ are the same as defined in R₁₁, R₁₂ and R₁₃. R₄₁, R₄₂ and R₄₃ are preferably substituted or unsubstituted phenyl group, and more preferably all of R₄₁, R₄₂ and R₄₃ are an unsubstituted phenyl group. R₄₄ and R₄₅ are each an unsubstituted alkyl group and examples thereof include methyl, ethyl, t-butyl, 2-octyl, cyclohexyl, benzyl, and diphenylmethyl. R₄₄ and R₄₅ are preferably ethyl. A₁ and A₂ are the same as defined in A₁ and A₂ of formula (H-1).

In formula (H-5), R₅₁ is a univalent substituent group, and preferably an alkyl group, a phenyl group, a nitrogen-containing heterocyclic group and a sulfur-containing heterocyclic group. Exemplary examples of R₅₁ include an alkyl group such as methyl, ethyl, n-propyl, iso-propyl, n-butyl, iso-butyl, tert-butyl or nonyl; a cycloalkyl group such as cyclopentyl or cyclohexyl; a phenyl group, a substituted phenyl, a naphthyl group, heterocyclic group such as maleimide, phthalimide, succinimide, morpholine group, piperidyl group, pyridyl group, tenoyl group;tolytyl group, ethoxycarbonyl group, methylthiomethyl, di-iso-propylamino group and diphenylamino group. These groups may be further substituted.

Exemplary examples of the compounds represented by formulas (H-1) through (H-4) are shown below but are by no means limited to these.

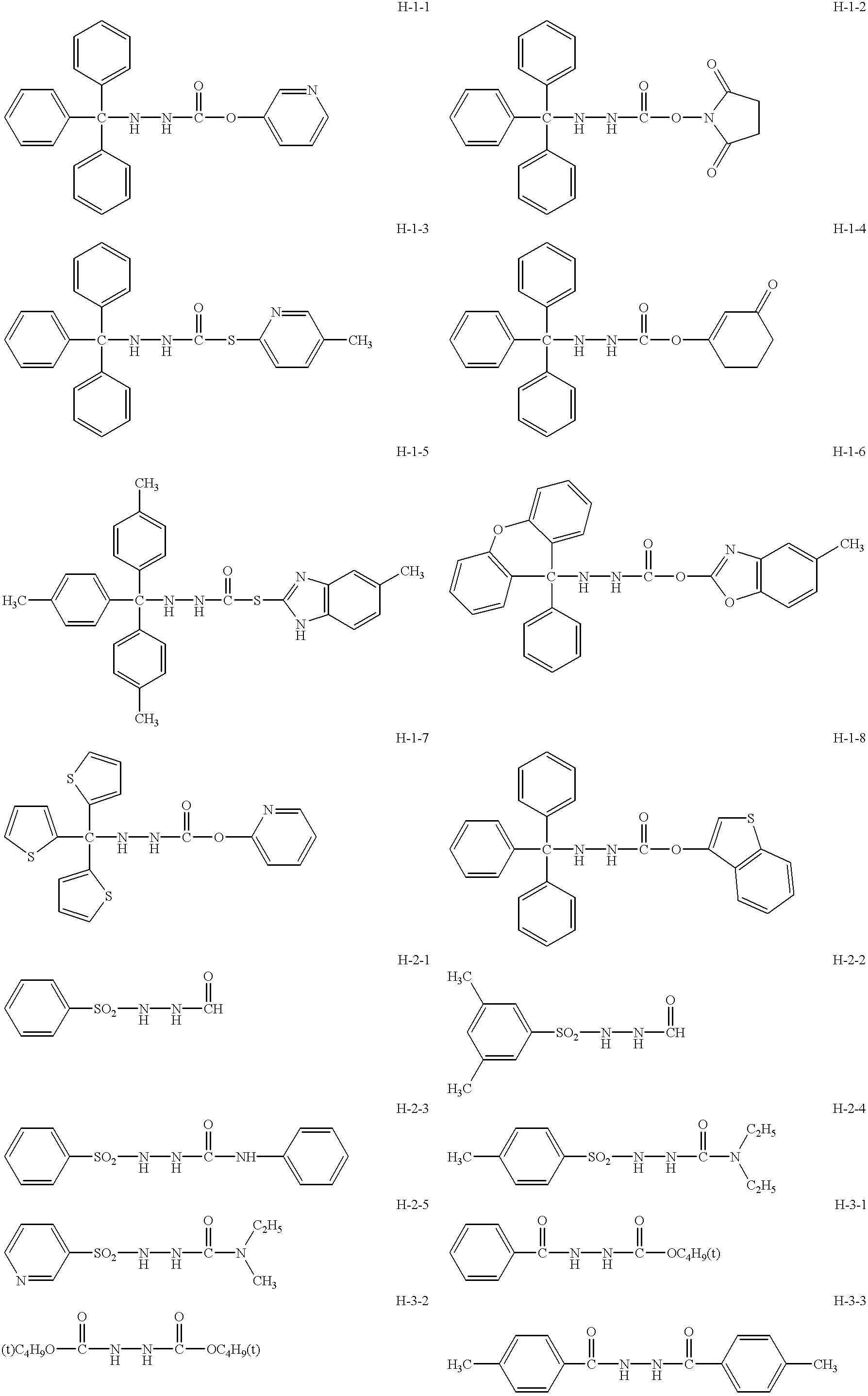

The compounds of formulas (H-1) through (H-4) can be readily synthesized in accordance with methods known in the art, as described in, for example, U.S. Pat. Nos. 5,467,738 and 5,496,695.

Furthermore, preferred hydrazine derivatives include compounds H-1 through H-29 described in U.S. Pat. No. 5,545,505, col. 11 to col. 20; and compounds 1 to 12 described in U.S. Pat. No. 5,464,738, col. 9 to col. 11. These hydrazine derivatives can be synthesized in accordance with commonly known methods.

In formula (G), X is an electron-with drawing group; W is a hydrogen atom, an alkyl group, alkenyl group, an alkynyl group, an aryl group, a heterocyclic group, a halogen atom, an acyl group, a thioacyl group, an oxalyl group, an oxyaxalyl group, a thiooxalyl group, an oxamoyl group, an oxycarbonyl group, a thiocarbonyl group, a carbamoyl group, a thiocarbmoyl group, a sulfonyl group, a sulfinyl group, an oxysulfinyl group, a thiosulfinyl group, a sulfamoyl group, an oxysulfinyl group, a thiosulfinyl group, a sulfinamoyl group, a phosphoryl group, nitro group, an imino grou, a N-carbonylimino group, a N-sulfonylimino group, a dicyanoethylene group, an ammonium group, a sulfonium group, a phosphonium group, pyrylium group, or an inmonium group.

R is a halogen atom, hydroxy, an alkoxy group, an aryloxy group, a heterocyclic-oxy group, an alkenyloxy group, an acyloxy group, an alkoxycarbonyloxy group, an aminocarbonyloxy group, a mercapto group, an alkylthio group, an arylthio group, a heterocyclic-thio group, an alkenylthio group, an acylthio group, an alkoxycarbonylthio group, an aminocarbonylthio group, an organic or inorganic salt of hydroxy or mercapto group (e.g., sodium salt, potassium salt, silver salt, etc.), an amino group, a cyclic amino group (e.g., pyrrolidine), an acylamino group, anoxycarbonylamino group, a heterocyclic group (5- or 6-membered nitrogen containing heterocyclic group such as benztriazolyl, imidazolyl, triazolyl, or tetrazolyl), a ureido group, or a sulfonamido group. X and W, or X and R may combine together with each other to form a ring. Examples of the rinf formed by X and W include pyrazolone, pyrazolidinone, cyclopentadione, β-ketolactone, and β-ketolactam.

In formula (G), the electron-withdrawing group represented by X refers to a substituent group exhibiting a negative Hammett's substituent constant σp. Examples thereof include a substituted alkyl group (e.g., halogen-substituted alkyl, etc.), a substituted alkenyl group (e.g., cyanoalkenyl, etc.), a substituted or unsubstituted alkynyl group (e.g., trifluoromethylacetylenyl, cyanoacetylenyl, etc.), a substituted or unsubstituted heterocyclic group (e.g., pyridyl, triazyl, benzoxazolyl, etc.), a halogen atom, an acyl group (e.g., acetyl, trifluoroacetyl, formyl, etc.), thioacetyl group (e.g., thioacetyl, thioformyl, etc.), an oxalyl group (e.g., methyloxalyl, etc.), an oxyoxalyl group (e.g., ethoxalyl, etc.), a thiooxalyl group (e.g., ethylthiooxalyl, etc.), an oxamoyl group (e.g., methyloxamoyl, etc.), an oxycarbonyl group (e.g., ethoxycarbonyl, etc.), carboxy group, a thiocarbonyl group (e.g., ethylthiocarbonyl, etc.), a carbamoyl group, a thiocarbamoyl group, a sulfonyl group, a sulfinyl group, an oxysulfonyl group (e.g., ethoxysulfonyl), a thiosulfonyl group (e.g., ethylthiosulfonyl, etc.), a sulfamoyl group, an oxysulfinyl group (e.g., methoxysulfinyl, etc.), a thiosulfinyl (e.g., methylthiosulfinyl, etc.), a sulfinamoyl group, phosphoryl group, a nitro group, an imino group, N-carbonylimino group (e.g., N-acetylimino, etc.), a N-sulfonylimino group (e.g., N-methanesufonylimono, etc.), a dicynoethylene group, an ammonium group, a sulfonnium group, a phophonium group, pyrilium group and inmonium grou, and further including a group of a heterocyclic ring formed by an ammonium group, sulfonium group, phosphonium group or immonium group. Of these group, groups exhibiting σp of 0.3 or more are specifically preferred.

Examples of the alkyl group represented by W include methyl, ethyl and trifluoromethyl; examples of the alkenyl include vinyl, halogen-substituted vinyl and cyanovinyl; examples of the aryl group include nitrophenyl, cyanophenyl, and pentafluorophenyl; and examples of the heterocyclic group include pyridyl, pyrimidyl, triazinyl, succinimido, tetrazolyl, triazolyl, imidazolyl, and benzoxazolyl. The group, as W, exhibiting positive σp is preferred and the group exhibiting σp of 0.3 or more is specifically preferred.

Of the groups represented by R, a hydroxy group, a mercapto group, an alkoxy group, an alkylthio group, a halogen atom, an organic or inorganic salt of a hydroxy or mercapto group and a heterocyclic group are preferred, and a hydroxy group, a mercapto group and an organic or inorganic salt of a hydroxy or mercapto group are more preferred.

Of the groups of X and W, the group having a thioether bond is preferred.

Exemplary examples of the compounds represented by formula (G) are shown below, but are not limited to these.

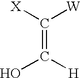

| | W | | | |
|---|---|---|---|---|
| X | —COCH₃ | —COCF₃ | 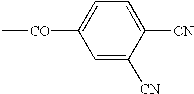 | —CHO |
| —COOC₂H₅ | 1-1 | 2-1 | 3-1 | 4-1 |
| —COCF₃ | 1-2 | 2-2 | 3-2 | 4-2 |
| —SO₂CH₃ | 1-3 | 2-3 | 3-3 | 4-3 |
| —CHO | 1-4 | — | 3-4 | 4-4 |
| 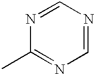 | 1-5 | 2-4 | 3-5 | 4-5 |
| 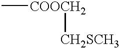 | 1-6 | 2-5 | 3-6 | 4-6 |
| 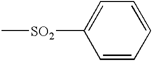 | — | — | — | — |

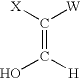

| | W | | | |
|---|---|---|---|---|
| X | —COCH₂SCH₃ | —COCOCH₃ | —COCOOC₂H₅ | —COCOSC₂H₅ |
| —COOC₂H₅ | 5-1 | 6-1 | 7-1 | 8-1 |
| —COCF₃ | 5-2 | 6-2 | — | 8-2 |
| —SO₂CH₃ | 5-3 | 6-3 | 7-2 | 8-3 |
| —CHO | 5-4 | 6-4 | — | 8-4 |
| 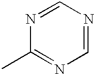 | 5-5 | 6-5 | 7-3 | 8-5 |
| 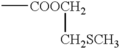 | 5-6 | 6-6 | 7-4 | 8-6 |
| 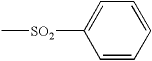 | — | 6-7 | 7-5 | — |

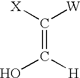

| | W | | | |
|---|---|---|---|---|
| X | —COCONHC₂H₄SCH₃ | 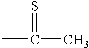 | —COOC₂H₅ | —COSC₂H₅ |
| —COOC₂H₅ | 9-1 | 10-1 | 11-1 | 12-1 |
| —COCF₃ | — | 10-2 | — | 12-2 |
| —SO₂CH₃ | 9-2 | 10-3 | 11-2 | 12-3 |
| —SO₂CF₃ | — | — | — | — |
| —CHO | — | 10-4 | — | 12-4 |
| 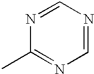 | 9-3 | 10-5 | 11-3 | 12-5 |
| —COOC₂H₄SCH₃ | 9-4 | 10-6 | 11-4 | 12-6 |
| 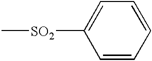 | — | — | 11-5 | — |

| | W | | |
|---|---|---|---|
| X | 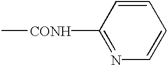 | 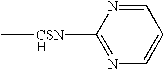 | —SO₂CH₃ |
| —COOC₂H₅ | 13-1 | 14-1 | 15-1 |
| —COCF₃ | 13-2 | 14-2 | — |
| —SO₂CH₃ | 13-3 | 14-3 | 15-2 |
| —SO₂CF₃ | 13-4 | 14-4 | 15-3 |
| —CHO | 13-5 | 14-5 | — |
| 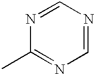 | 13-6 | 14-6 | 15-4 |
| —COOC₂H₄SCH₃ | 13-7 | 14-7 | 15-5 |
| 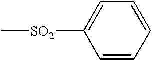 | | | |

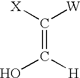

| | W | | | | |
|---|---|---|---|---|---|
| X | —SO₂CF₃ | —SOCH₃ | —SO₂OCH₃ | —SO₂SCH₃ | —SO₂NH₂ |
| —COOC₂H₅ | — | 17-1 | 18-1 | 19-1 | 20-1 |
| —COCF₃ | — | 17-2 | 18-2 | 19-2 | 20-2 |
| —SO₂CH₃ | — | 17-3 | 18-3 | 19-3 | 20-3 |
| —CHO | — | 17-4 | 18-4 | 19-4 | 20-4 |
| 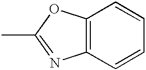 | 16-1 | 17-5 | 18-5 | 19-5 | 20-5 |
| 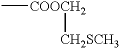 | — | 17-6 | 18-6 | 19-6 | 20-6 |

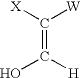

| | W | | | | |
|---|---|---|---|---|---|
| X | 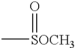 | 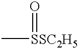 | 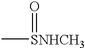 | 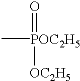 | —NO₂ |
| 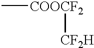 | 21-1 | 22-1 | 23-1 | 24-1 | 25-1 |
| —COCF₃ | 21-2 | 22-2 | 23-2 | 24-2 | 25-2 |
| —SO₂CH₃ | 21-3 | 22-3 | 23-3 | 24-3 | 25-3 |
| —CHO | 21-4 | 22-4 | 23-4 | 24-4 | 25-4 |
| —COCH₂SCH₃ | 21-5 | 22-5 | 23-5 | 24-5 | 25-5 |
| 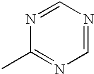 | 21-6 | 22-6 | 23-6 | 24-6 | 25-6 |
| 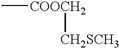 | 21-7 | 22-7 | 23-7 | 24-7 | 25-7 |

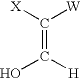

| | W | | | | |
|---|---|---|---|---|---|
| X | 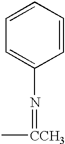 | 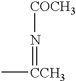 | 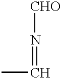 | 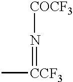 | 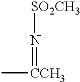 |
| —COOC₂H₅ | 26-1 | 27-1 | 28-1 | 29-1 | 30-1 |
| —COCF₃ | 26-2 | 27-2 | 28-2 | 29-2 | 30-2 |
| —SO₂CH₃ | 26-3 | 27-3 | 28-3 | 29-3 | 30-3 |
| —CHO | 26-4 | 27-4 | 28-4 | 29-4 | 30-4 |
| 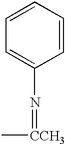 | 26-5 | 27-5 | 28-5 | 29-5 | 30-5 |
| 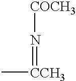 | — | 27-6 | 28-6 | 29-6 | 30-6 |
| 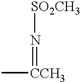 | — | — | — | 29-7 | 30-7 |

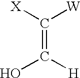

| | W | | | | |
|---|---|---|---|---|---|
| X | 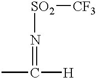 | 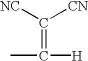 | 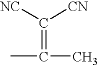 | 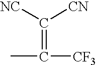 | 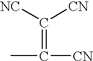 |
| —COOC₂H₅ | 31-1 | 32-1 | 33-1 | 34-1 | 35-1 |
| —COCF₃ | 31-2 | 32-2 | 33-2 | 34-2 | 35-2 |
| —CHO | 31-3 | 32-3 | 33-3 | 34-3 | 35-3 |
| —SO₂CH₃ | 31-4 | 32-4 | 33-4 | 34-4 | 35-4 |
| 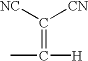 | 31-5 | 32-5 | 33-5 | 34-5 | 35-5 |
| 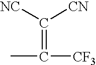 | 31-6 | — | — | 34-6 | 35-6 |
| 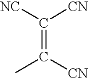 | 31-7 | — | — | — | 35-7 |

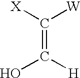

| | W | | | | |
|---|---|---|---|---|---|
| X | —CF₃ | —CH═CHCN | —CH═CHCHO | —C≡CCF₃ | —C≡CCN |
| —COOC₂H₅ | 36-1 | 37-1 | 38-1 | 39-1 | 40-1 |
| —COCF₃ | 36-2 | 37-2 | 38-2 | 39-2 | 40-2 |
| —SO₂CH₃ | 36-3 | 37-3 | 38-3 | 39-3 | 40-3 |
| —SO₂CF₃ | 36-4 | 37-4 | 38-4 | 39-4 | 40-4 |
| —CHO | 36-5 | 37-5 | 38-5 | 39-5 | 40-5 |
| 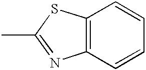 | 36-6 | 37-6 | 38-6 | 39-6 | 40-6 |
| 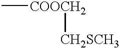 | 36-7 | 37-7 | 38-7 | 39-7 | 40-7 |

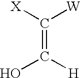

| | W | | | | |
|---|---|---|---|---|---|
| X | 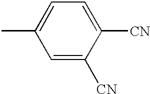 | 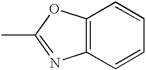 | 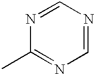 | Cl | H |
| —COOC₂H₅ | 41-1 | 42-1 | 43-1 | 44-1 | 45-1 |
| —COCF₃ | 41-2 | 42-2 | — | 44-2 | 45-2 |
| —SO₂CH₃ | 41-3 | 42-3 | 43-2 | 44-3 | 45-3 |
| —CHO | 41-4 | 42-4 | — | 44-4 | 45-4 |
| 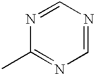 | 41-5 | 42-5 | 43-3 | 44-5 | 45-5 |
| 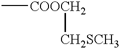 | 41-6 | 42-6 | 43-4 | 44-6 | 45-6 |

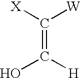

| | W | | | |
|---|---|---|---|---|
| X | 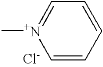 | 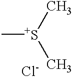 | 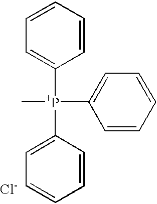 | 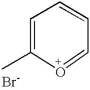 |
| —COOC₂H₅ | 46-1 | 47-1 | 48-1 | 49-1 |
| —COCH₃ | — | — | — | — |
| —COCF₃ | 46-2 | 47-2 | 48-2 | 49-2 |
| —SO₂CH₃ | 46-3 | 47-3 | 48-3 | 49-3 |
| —SO₂CF₃ | — | — | — | — |
| —CHO | 46-4 | 47-4 | 48-4 | 49-4 |
| 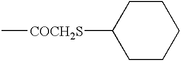 | | | | |
| 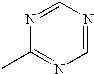 | | | | |
| 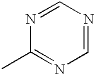 | 46-5 | 47-5 | 48-5 | 49-5 |
| 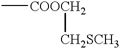 | 46-6 | 47-6 | 48-6 | 49-6 |

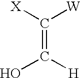

| | W | | |
|---|---|---|---|
| X | 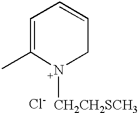 | 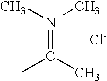 | 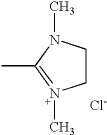 |
| —COOC₂H₅ | 50-1 | 51-1 | 52-1 |
| —COCH₃ | — | 51-2 | 52-2 |
| —COCF₃ | 50-2 | | |
| —SO₂CH₃ | 50-3 | 51-3 | 52-3 |
| —SO₂CF₃ | — | 51-4 | 52-4 |
| —CHO | 50-4 | 51-5 | 52-5 |
| 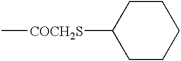 | | 51-6 | 52-6 |
| 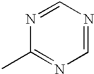 | | 51-7 | 52-7 |
| 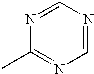 | 50-5 | | |
| 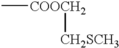 | 50-6 | 51-8 | 52-8 |

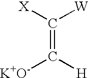

| | W | | | | |
|---|---|---|---|---|---|
| X | —COCH₃ | —COCF₃ | —CHO | —COCH₂SCH₃ | —SO₂CH₃ |
| —COOC₂H₅ | 53-1 | 54-1 | 55-1 | 56-1 | 57-1 |
| —COCF₃ | — | 54-2 | 55-2 | 56-2 | 57-2 |
| —CHO | — | — | 55-3 | 56-3 | 57-3 |
| —SO₂CH₃ | — | — | — | 56-4 | 57-4 |
| —COCH₂SCH₃ | — | — | — | 56-5 | — |
| 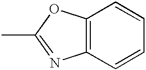 | 53-2 | 54-3 | 55-4 | 56-6 | 57-5 |
| 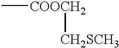 | 53-3 | 54-4 | 55-5 | 56-7 | 57-6 |

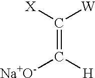

| | W | | | | |
|---|---|---|---|---|---|
| X | —SO₂CF₃ | 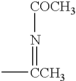 | 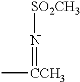 | 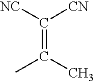 | 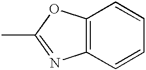 |
| —COOC₂H₅ | 58-1 | 59-1 | 60-1 | 61-1 | 62-1 |
| —COCH₃ | — | 59-2 | 60-2 | 61-2 | — |
| —CHO | — | 59-3 | 60-3 | 61-3 | — |
| —SO₂CF₃ | 58-2 | 59-4 | 60-4 | 61-4 | 62-2 |
| —COCH₂SCH₃ | 58-3 | 59-5 | 60-5 | 61-5 | — |
| 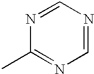 | 58-4 | 59-6 | 60-6 | 61-6 | 62-3 |
| 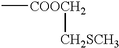 | 58-5 | 59-7 | 60-7 | 61-7 | 62-4 |
| 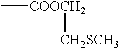 | 58-6 | 59-8 | 60-8 | 61-8 | 62-5 |

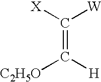

| | W | | | |
|---|---|---|---|---|
| X | —COCCl₃ | 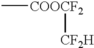 | —CHO | —COCH₂SCH₃ |
| 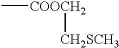 | 63-1 | 64-1 | 65-1 | 66-1 |
| —COCF₃ | 63-2 | 64-2 | 65-2 | 66-2 |
| —CHO | 63-3 | 64-3 | 65-3 | 66-3 |
| —SO₂CF₃ | 63-4 | 64-4 | 65-4 | 66-4 |
| —COCH₂SCH₃ | 63-5 | 64-5 | 65-5 | 66-5 |

| | W | | | | | |
|---|---|---|---|---|---|---|
| X | —COCF₃ | —CHO | —COCH₂SCH₃ | 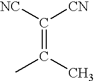 | 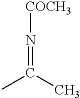 | 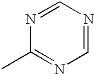 |
| —COOC₂H₅ | 67-1 | 67-2 | — | 67-3 | 67-4 | — |

| | | |
|---|---|---|
| 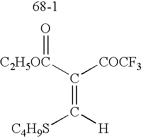 | 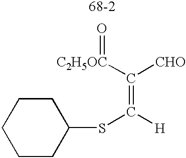 | 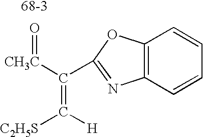 |
| 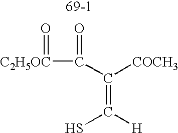 | 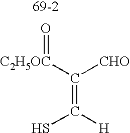 | |

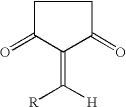

| | | |
|---|---|---|
| R: | —OH | 72-1 |
| | —OC₂H₅ | 72-4 |
| | —SCH₃ | 72-7 |

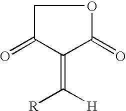

| | | |
|---|---|---|
| R: | —OH | 72-2 |
| | —O⁻Na⁺ | 72-3 |
| | —OCH₃ | 72-5 |
| | —SC₄H₉ | 72-6 |
| | —Cl | 72-8 |
| | 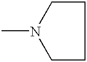 | 72-9 |

| | |
|---|---|
| 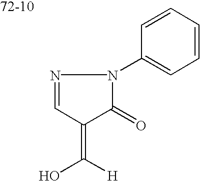 | 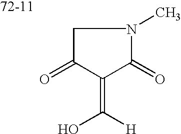 |
| 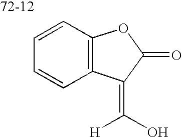 | 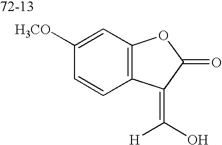 |
| 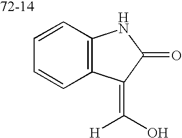 | 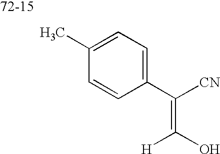 |
| 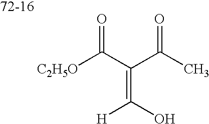 | |

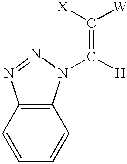

| | W | | | | |
|---|---|---|---|---|---|
| X | —COCH₃ | —COCF₃ | —CHO | —COCH₂SCH₃ | —SO₂CH₃ |
| —COCOOC₂H₅ | 73-1 | 74-1 | 75-1 | 76-1 | 77-1 |
| —COCH₃ | 73-2 | 74-2 | 75-2 | 76-2 | 77-2 |
| —CHO | — | — | 75-3 | 76-3 | 77-3 |
| —SO₂CF₃ | 73-3 | 74-3 | 75-4 | 76-4 | 77-4 |
| 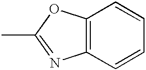 | 73-4 | 74-4 | 75-5 | 76-5 | 77-5 |
| 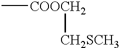 | 73-5 | 74-5 | 75-6 | 76-6 | 77-6 |
| 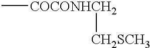 | 73-6 | 74-6 | 75-7 | 76-7 | 77-7 |

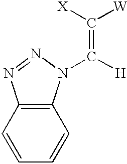

| | W | | | | |
|---|---|---|---|---|---|
| X | —SO₂CF₃ | 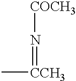 | 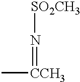 | 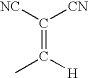 | 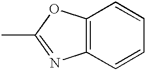 |
| —COCOOC₂H₅ | 78-1 | 79-1 | 80-1 | 81-1 | 82-1 |
| —COCH₃ | — | 79-2 | 80-2 | 81-2 | — |
| —CHO | — | 79-3 | 80-3 | 81-3 | — |
| —SO₂CF₃ | 78-2 | 79-4 | 80-4 | 81-4 | 82-2 |
| 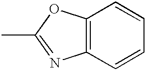 | 78-3 | 79-5 | 80-5 | 81-5 | 82-3 |
| 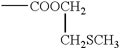 | 78-4 | 79-6 | 80-6 | 81-6 | 82-4 |
| 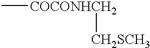 | 78-5 | 79-7 | 80-7 | 81-7 | 82-5 |

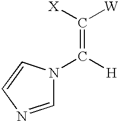

| | W | | | | |
|---|---|---|---|---|---|
| X | —COCH₃ | —COCF₃ | —CHO | —COCH₂SCH₃ | —SO₂CH₃ |
| —COCOOC₂H₅ | 83-1 | 84-1 | 85-1 | 86-1 | 87-1 |
| —COCH₃ | 83-2 | 84-2 | 85-2 | 86-2 | 87-2 |
| —CHO | — | — | 85-3 | 86-3 | 87-3 |
| —SO₂CF₃ | 83-3 | 84-3 | 85-4 | 86-4 | 87-4 |
| 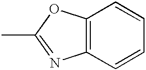 | 83-4 | 84-4 | 85-5 | 86-5 | 87-5 |
| 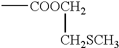 | 83-5 | 84-5 | 85-6 | 86-6 | 87-6 |
| 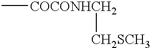 | 83-6 | 84-6 | 85-7 | 86-7 | 87-7 |

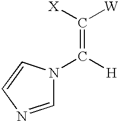

| | W | | | | |
|---|---|---|---|---|---|
| X | —SO₂CF₃ | 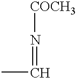 | 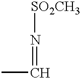 | 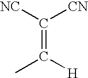 | 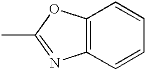 |
| —COCOOC₂H₅ | 88-1 | 89-1 | 90-1 | 91-1 | 92-1 |
| —COCH₃ | — | 89-2 | 90-2 | 91-2 | — |
| —CHO | — | 89-3 | 90-3 | 91-3 | — |
| —SO₂CF₃ | 88-2 | 89-4 | 90-4 | 91-4 | 92-2 |
| 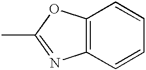 | 88-3 | 89-5 | 90-5 | 91-5 | 92-3 |
| 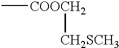 | 88-4 | 89-6 | 90-6 | 91-6 | 92-4 |
| 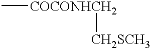 | 88-5 | 89-7 | 90-7 | 91-7 | 92-5 |

In formula (P), Q is a nitrogen atom or a phosphorus atom; R₁, R₂, R₃ and R₄ each are a hydrogen atom or a substituent, provided that R₁, R₂, R₃ and R₄ combine together with each other to form a ring; and X⁻ is an anion.

Examples of the substituent represented by R₁, R₂, R₃ and R₄ include an alkyl group (e.g., methyl, ethyl, propyl, butyl, hexyl, cyclohexyl), alkenyl group (e.g., allyl, butenyl), alkynyl group (e.g., propargyl, butynyl), aryl group (e.g., phenyl, naphthyl), heterocyclic group (e.g., piperidyl, piperazinyl, morpholinyl, pyridyl, furyl, thienyl, tetrahydrofuryl, tetrahydrothienyl, sulforanyl), and amino group. Examples of the ring formed by R₁, R₂, R₃ and R₄ include a piperidine ring, morpholine ring, piperazine ring, pyrimidine ring, pyrrole ring, imidazole ring, triazole ring and tetrazole ring. The group represented by R₁, R₂, R₃ and R₄ may be further substituted by a hydroxy group, alkoxy group, aryloxy group, carboxy group, sulfo group, alkyl group or aryl group. Of these, R₁, R₂, R₃ and R₄ are each preferably a hydrogen atom or an alkyl group. Examples of the anion of X include a halide ion, sulfate ion, nitrate ion, acetate ion and p-toluenesulfonic acid ion.

Further, quaternary onium salt compounds usable in this invention include compounds represented by formulas (Pa), (Pb) and (Pc), or formula (T):

[chemical structure]

[chemical structure]

[chemical structure]

wherein A¹, A², A³, A⁴ and A⁵ are each a nonmetallic atom group necessary to form a nitrogen containing heterocyclic ring, which may further contain an oxygen atom, nitrogen atom and a sulfur atom and which may condense with a benzene ring. The heterocyclic ring formed by A¹, A², A³, A⁴ or A⁵ may be substituted by a substituent. Examples of the substituent include an alkyl group, an aryl group, an aralkyl group, alkenyl group, alkynyl group, a halogen atom, an acyl group, an alkoxycarbonyl group, an aryloxycarbonyl group, a sulfo group, hydroxy, an alkoxyl group, an aryloxy group, an amido group, a sulfamoyl group, a carbamoyl group, a ureido group, an amino group, a sulfonamido group, cyano, nitro, a mercapto group, an alkylthio group, and an arylthio group. Exemplary preferred A¹, A², A³, A⁴ and A⁵ include a 5- or 6-membered ring (e.g., pyridine, imidazole, thiazole, oxazole, pyrazine, pyrimidine) and more preferred is a pyridine ring.

Bp is a divalent linkage group, and m is 0 or 1. Examples of the divalent linkage group include an alkylene group, arylene group, alkenylene group, —SO₂—, —SO—, —O—, —S—, —CO—, —N(R⁶)—, in which R⁶ is a hydrogen atom, an alkyl group or aryl group. These groups may be included alone or in combination. Of these, Bp is preferably an alkylene group or alkenylene group.

R¹, R² and R³ are each an alkyl group having 1 to 20 carbon atoms, and R¹ and R² may be the same. The alkyl group may be substituted and substituent thereof are the same as defined in A¹, A², A³, A⁴ and A⁵. Preferred R¹, R² and R⁵ are each an alkyl group having 4 to 10 carbon atoms, and more preferably an aryl-substituted alkyl group, which may be substituted. Xₚ⁻ is a counter ion necessary to counterbalance overall charge of the molecule, such as chloride ion, bromide ion, iodide ion, sulfate ion, nitrate ion and p-toluenesulfonate ion; nₚ is a counter ion necessary to counterbalance overall charge of the molecule and in the case of an intramolecular salt, nₚ is 0.

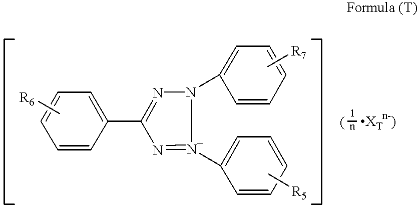

In formula (T), substituent groups R₅, R₆ and R₇, substituted on the phenyl group are preferably a hydrogen atom or a group, of which Hammett's σ-value exhibiting a degree of electron attractiveness is negative.

The σ values of the substituent on the phenyl group are disclosed in lots of reference books. For example, a report by C. Hansch in “The Journal of Medical Chemistry”, vol.20, on page 304(1977), etc. can be mentioned. Groups showing particularly preferable negative σ-values include, for example, methyl group (σₚ=−0.17, and in the following, values in the parentheses are in terms of σₚ value), ethyl group(−0.15), cyclopropyl group(−0.21), n-propyl group(−0.13), iso-propyl group(−0.15), cyclobutyl group(−0.15), n-butyl group(−0.16), iso-butyl group(−0.20), n-pentyl group(−0.15), n-butyl group(−0.16), iso-butyl group(−0.20), n-pentyl group(−0.15), cyclohexyl group(−0.22), hydroxyl group(−0.37), amino group(−0.66), acetylamino group(−0.15), butoxy group(−0.32), pentoxy group(−0.34), etc. can be mentioned. All of these groups are useful as the substituent for the compound represented by the formula T according to the present invention; n is 1 or 2, and as anions represented by X_{T}ⁿ⁻ for example, halide ions such as chloride ion, bromide ion, iodide ion, etc.; acid radicals of inorganic acids such as nitric acid, sulfuric acid, perchloric acid, etc.; acid radicals of organic acids such as sulfonic acid, carboxylic acid, etc.; anionic surface active agents, including lower alkyl benzenesulfonic acid anions such as p-toluenesulfonic anion, etc.; higher alkylbenzene sulfonic acid anions such as p-dodecyl benzenesulfonic acid anion, etc.; higher alkyl sulfate anions such as lauryl sulfate anion, etc.; Boric acid-type anions such as tetraphenyl borone, etc.; dialkylsulfo succinate anions such as di-2-ethylhexylsulfo succinate anion, etc.; higher fatty acid anions such as cetyl polyethenoxysulfate anion, etc.; and those in which an acid radical is attached to a polymer, such as polyacrylic acid anion, etc. can be mentioned.

Exemplary examples of the quaternary onium compounds are shown below, but are not limited to these.

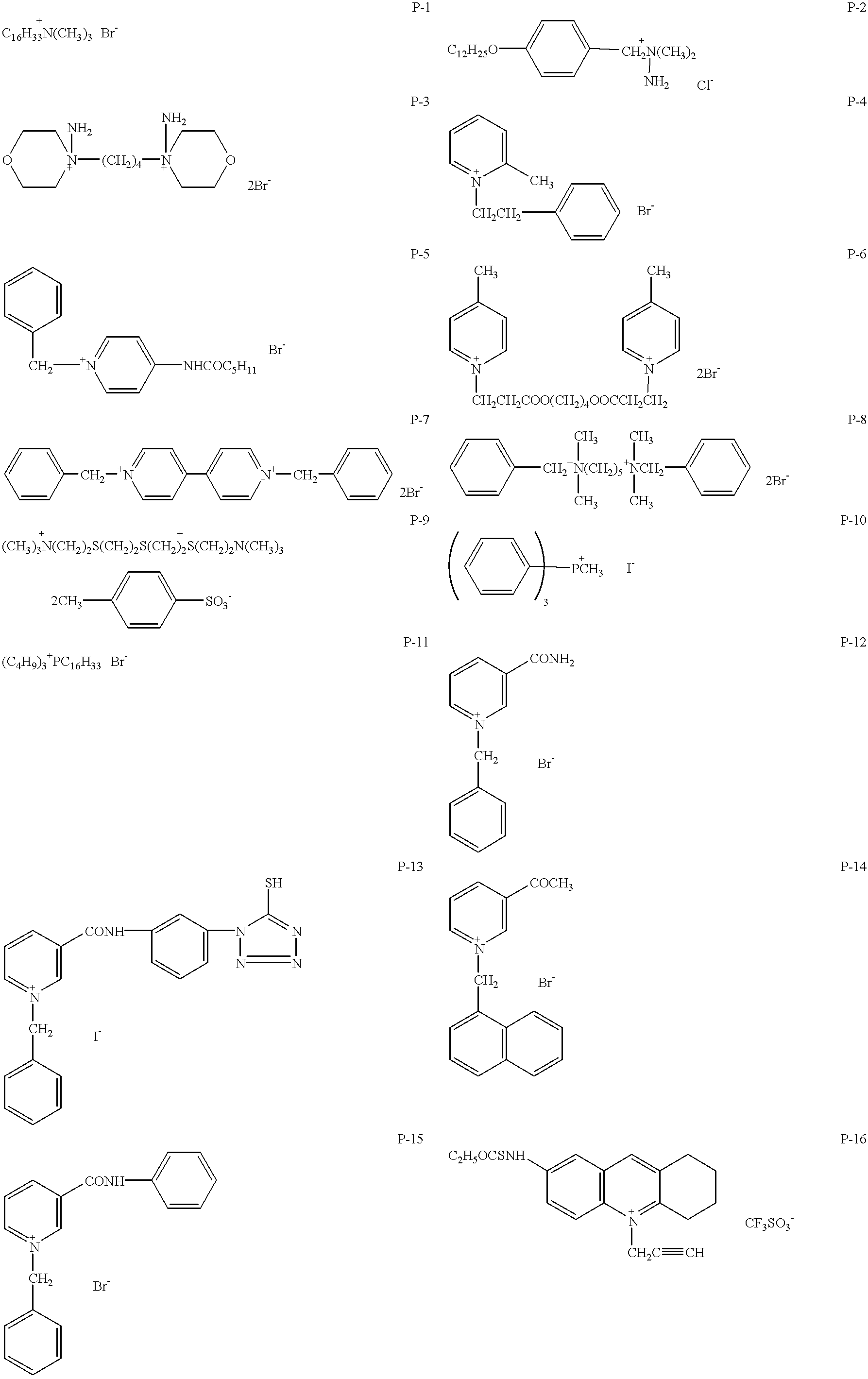

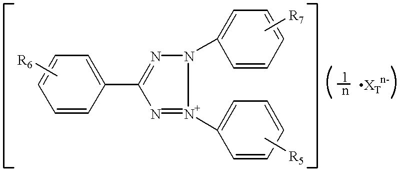

| Compound | | | | |
|---|---|---|---|---|
| No. | R₅ | R₆ | R₇ | X_{T}ⁿ⁻ |
| T-1 | H | H | p-CH₃ | — |
| T-2 | p-OCH₃ | p-CH₃ | p-CH₃ | — |
| T-3 | p-OCH₃ | H | p-CH₃ | — |
| T-4 | p-OCH₃ | H | p-OCH₃ | — |
| T-5 | p-C₃H₇ | H | p-C₃H₇ | — |
| T-6 | p-nC₁₂H₂₅ | H | p-nC₁₂H₂₅ | — |
| T-7 | p-NH₂ | H | H | — |

The quaternary onium salt compounds described above can be readily synthesized according to the methods commonly known in the art. For example, the tetrazolium compounds described above may be referred to Chemical Review 55, page 335-483. The above-described contrast-increasing agent such as hydrazine derivatives, vinyl compounds and quaternary onium compounds is incorporated preferably in an amount of 1×10⁻⁵ to 1 mole, and more preferably 1×10⁻⁴ to 5×10⁻¹ mole per mole of silver halide. The contrast-increasing agent is incorporated preferably into an image forming layer or a layer adjacent to the image forming layer.

Acid anhydrides used in this invention have a structure of A—CO—O—CO—B in the molecule, which is formed through bimolecular dehydration condensation of mono-carboxylic acids, wherein A or B may be a straight chain substituent group or may be a substituent group having a cyclic structure which is formed by partial combination of A or B. The straight chain substituent is one which is formed through dehydration of two aliphatic mono-carboxylic acid molecules. Examples thereof include acetic anhydride, butanoic anhydride, pentanoic anhydride, caproic anhydride, laurylic anhydride, stearic anhydride, cebacic anhydride, arachidic anhydride, and behenic anhydride. The aliphatic carboxylic acid preferably has 1 to 30 carbon atoms. The cyclic substituent group includes aromatic carboxylic acids, such as benzoic anhydride, pyridine-carboxylic acid anhydride and their derivatives, and acid anhydrides represented by the following general formula (3). IN this invention, a cyclic acid anhydride represented by formula (3) is preferred:

[chemical structure]

wherein Z₁ and Z₂ represent an atom group necessary to form a monocyclic or polycyclic ring of an acid anhydride nucleus; R¹¹ and R¹² each represent a hydrogen atom, by a halogen atom (e.g., chlorine, fluorine), nitrile group, hydroxy group, alkoxy group (e.g., methoxy, ethoxy, butoxy), or an aliphatic, aromatic or heterocyclic group, which may be substituted; n and m represent an integer of 0 to 4 and when n is 2 or more, adjacent substituent groups may combine with each other to form a condensation ring; L¹¹ is a linkage group linking Z₁- and Z₂-rings.

Further, as an acid anhydride is also preferred a compound represented by the following formula (4):

[chemical structure]

wherein Z represents an atom group necessary to form a monocyclic or polycyclic ring, which may be substituted or unsubstituted. Examples of substituent groups include an alkyl group (e.g., methyl, ethyl, hexyl), alkoxy group (e.g., methoxy, ethoxy, octyloxy, aryl group (e.g., phenyl, naphthyl, tolyl), hydroxy, aryloxy group (e.g., phenoxy), alkylthio group (e.g., methylthio, butylthio), sulfonyl group (e.g., methylsulfinyl, phenylsulfinyl), acylamino group, sulfonylamino group, acyloxy group (e.g., acetoxy, benzoxy), carboxy group, cyano group, sulfo group, and a halogen atom (e.g., chlorine, bromine).

The atom group constituting an acid anhydride nucleus ring, represented by Z₁ or Z₂ preferably is a saturated or unsaturated ring having 4 to 12 carbon atoms or a heterocyclic ring, in which two adjacent carboxy groups on the ring are condensed. The saturated ring include, for example, a hexyl ring, the unsaturated ring include, for example, a benzene ring and naphthalene ring, and the heterocyclic ring include, for example, a pyridine ring, imidazole ring, pyrimidine ring, oxazole ring and triazole ring.

Examples of the aliphatic group represented by R¹¹ and R₁₂ include an alkyl group such as methyl, ethyl, and butyl, an alkenyl group such as ethenyl, propenyl and butenyl, an alkynyl group such as ethynyl and ethynykethyl, ethylsulfonamido group, octylsulfonamido group, ethylcarbamido group and ethylcarbamido group. Examples of the aromatic group a phenyl group and a naphthalene group, each of which may be substituted with a substituent such as an alkyl group (e.g., methyl, ethyl butyl, octyl), an alkenyl group (e.g., ethenyl, butenyl, octenyl), a halogen atom (chlorine, bromine, fluorine), nitrile group, an alkoxy group (e.g., methoxy, ethoxy), hydroxy group and an amino group. Examples of the heterocyclic group include a pyridine ring, pyrimidine ring, imidazole ring, triazole ring, oxazole ring, thiazole ring, furan ring and thiophen ring.

When n is 2 or more, adjacent R¹¹'s or R¹²'s on the Z₁- or Z₂-ring may combine with each other to form a ring.

R₁ and R₂ may be substituted with a substituent group. Examples of the substituent group include an alkoxy group (e.g., methoxy, ethoxy, propyloxy, butoxy, octoxy, dodecanoxy, docosanoxy, 2-ethylhexanoxy), a halogenated alkoxy group (e.g., trifluoromethoxy, perfluoroocatnoxy), a cycloakoxy group (e.g., cyclohexanoxy, cyclooctanoxy, cyclopentanoxy), an aromatic group (e.g., phenoxy, naphthenoxy), a heterocyclic group (e.g., pyridyl, furyl, thiophenyl, piperazyl, imidazolyl, triazolyl, tetrazolyl), an alkylamino group (e.g., methylamino, propylamino, octylamino, tetradecylamino), a dialkyl amino group (e.g., dimethylamino, diethylamino, dioctylamino) and an alkylthio group (e.g., methylthio, ethylthio, butylthio, octylthio), in which the alkyl group moiety preferably has 1 to 25 carbon atoms. In cases where adjacent R₁ and R₂ combine with each other to form a ring, the formed ring include, for example, a benzene ring, an imidazole ring, a tetrazole ring, a pyridine ring, furyl ring, thiophene ring and a piperadine ring.

Examples of L¹¹ include —SO₂—, —SO—, —S—SO₂—, —S—, —O—, —CONH—, —SO₂NH—, —CONH— and their combinations with an aliphatic group, an aromatic group or a heterocyclic group.

Exemplary examples of the acid anhydride represented by formula (3) are shown below.

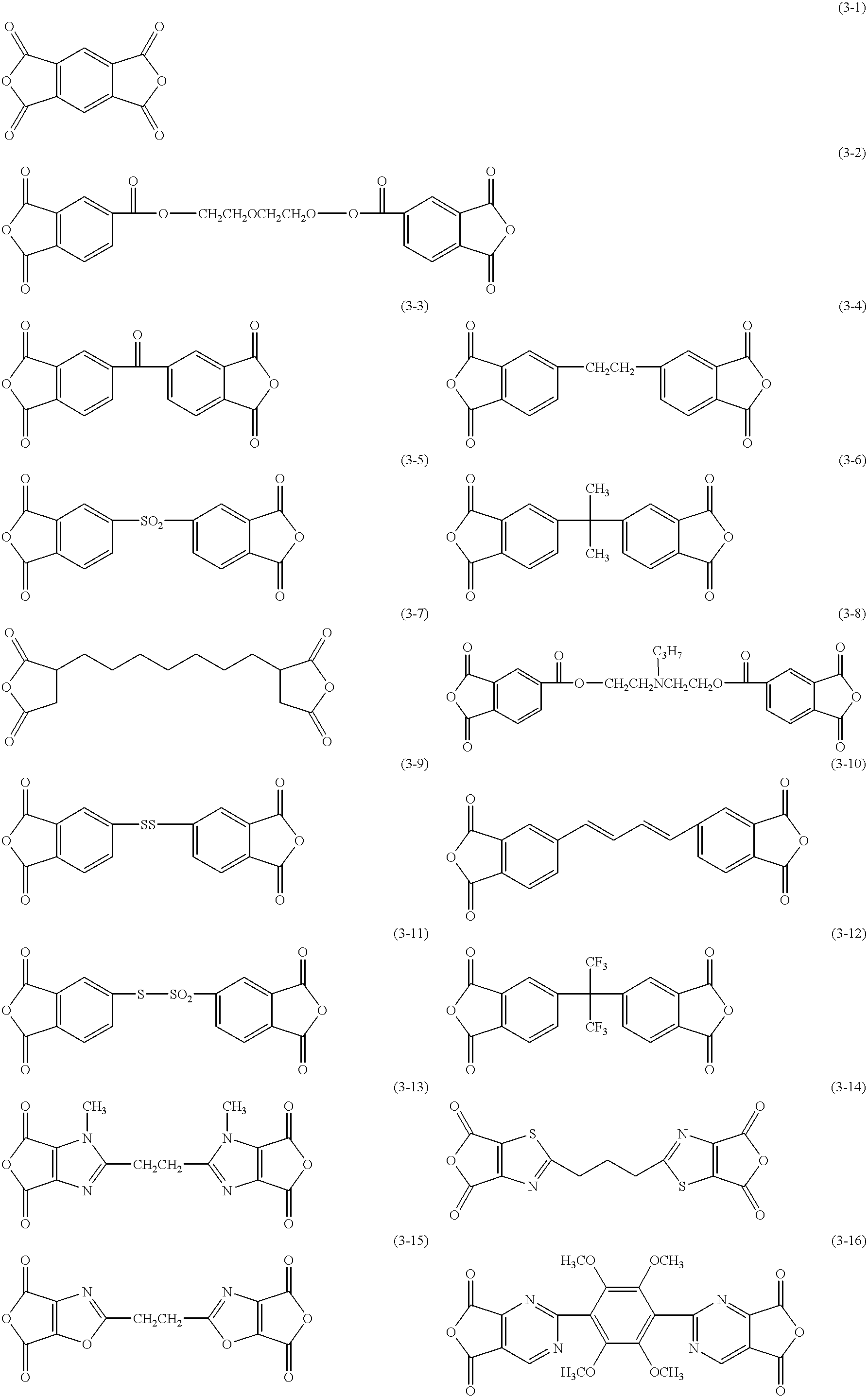

The foregoing acid anhydride compounds can be readily synthesized through conventional dehydration condensation of carboxylic acid group-containing compounds or are commercially available. The acid anhydride compound can be incorporated into the photothermographic material according to the commonly known method. For example, the compound can be incorporated through solution in polar solvents of alcohols such as methanol or ethanol, ketones such as methyl ethyl ketone or acetone, dimethylsulfoxide or dimethylformamide. Alternatively, the compound can be incorporated in the form 1 μm or less fine particles dispersed in water or organic solvents by sand mill dispersion, jet mill dispersion, ultrasonic dispersion or homogenizer dispersion. Various techniques for fine e particle dispersion have been disclosed, whereby dispersion of fine particles of 0.05 to 10 μm can be incorporated.

In this invention, the acid anhydride compound is preferably incorporated into an image forming layer (or light sensitive layer) or a layer adjacent to the image forming layer. The content of the acid anhydride compound is preferably 10⁻⁵ to 1 mol, more preferably 10⁻⁴ to 0.3 mol, and still more preferably 10⁻⁴ to 0.1 mol per mol of silver.

In formulas (1) and (2), the bivalent represented by T¹, comprised of hydrocarbon group is a straight chain, branched or cyclic alkylene group (preferably having 1 to 20 carbon atoms, more preferably 1 to 16 carbon atoms, and still more preferably 1 to 12 carbon atoms), alkenyl group (preferably having 2 to 20 carbon atoms, more preferably 2 to 16 carbon atoms, and still more preferably 2 to 12 carbon atoms), and alkynyl group (preferably having 2 to 20 carbon atoms, more preferably 2 to 16 carbon atoms, and still more preferably 2 to 12 carbon atoms).

Examples of a bivalent linking group containing at least one of an oxygen atom, sulfur atom and nitrogen atom, represented by J₁ include the following groups, which may be combined:

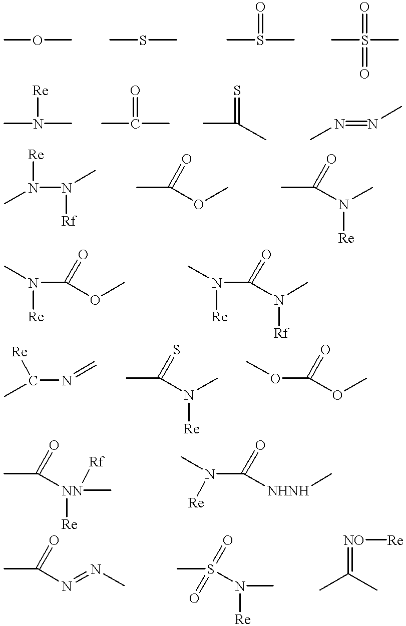

wherein Re and Rf are the same as defined in Ra through Rd. The aromatic hydrocarbon group represented by Ar is a monocyclic or condensed aryl group (preferably having 6 to 30 carbon atoms, and more preferably 6 to 20 carbon atoms). Examples thereof include phenyl and naphthyl, and phenyl is preferred.

The aromatic heterocyclic group represented by Ar is a 5- to 10-membered unsaturated heterocyclic group containing at least one of N, O, and S, which may be monocyclic or condensed with other ring. A heterocyclic ring of the heterocyclic group is preferably a 5- or 6-membered aromatic heterocyclic ring or its benzo-condensed ring, more preferably a nitrogen-containing, 5- or 6-membered aromatic heterocyclic ring or its benzo-condensed ring, and still more preferably one or two nitrogen- containing, 5- or 6-membered aromatic heterocyclic ring or its benzo-condensed ring.

Examples of the aromatic heterocyclic group include groups derived from thiophene, furan, pyrrole, imidazole, pyrazolo, pyridine, pyrazine, pyridazine, triazole, triazine, indole, indazole, purine, thiadiazole, oxadiazole, quinoline, phthalazine, naphthylizine, quinoxaline, quinazolone, cinnoline, pteridine, acrydine, phenathroline, phenazine, tetrazole, thiazole, oxazole, benzimidazole, benzoxazole, benzthiazole, benzothiazoline, benzotriazole, tetrazaindene, and carbazole. Of these, groups derived from imidazole, pyrazolo, pyridine, pyrazine, indole, indazole, thiadiazole, oxadiazole, quinoline, phenazine, tetrazole, thiazole, oxazole, benzimidazole, benzoxazole, benzthiazole, benzothiazoline, benzotriazole, tetrazaindene, and carbazole are preferred; and groups derived from imidazole, pyridine, pyrazine, quinoline, phenazine, tetrazole, thiazole, benzoxazole, benzoimidazole, benzthiazole, benzothiazoline, benzotriazole, and carbazole are more preferred.

The aromatic hydrocarbon group and aromatic heterocyclic group represented by Ar may be substituted. The substituent group is the same as the substituent groups defined in T₃₁. The substituent group may be further substituted, and plural substituting group may be the same or different. Further, the group represented by Ar is preferably an aromatic heterocyclic group.

The aliphatic hydrocarbon group represented by Ra, Rb, Rc, Rd, Re and Rf include, for example, an alkyl group (preferably having 1 to 20 carbon atoms, more preferably 1 to 16 carbon atoms and still more preferably 1 to 12 carbon atoms), an alkenyl group (preferably having 2 to 20 carbon atoms, more preferably 2 to 16 carbon atoms, and still more preferably 2 to 12 carbon atoms), an alkynyl (preferably having 2 to 20 carbon atoms, more preferably 2 to 16 carbon atoms, and still more preferably 2 to 12 carbon atoms) an aryl group (preferably having 6 to 30 carbon atoms, more preferably 6 to 20 carbon atoms, and still more preferably 6 to 12 carbon atoms, e.g., phenyl, naphthyl), and a heterocyclic group (e.g., 2-thiazolyl, 1-piperadynyl, 2-pyridyl, 3-pyridyl,2-thienyl, 2-benzimidazolyl, carbazolyl, etc.). The heterocyclic group may be a monocyclic ring or a ring condensed with other ring.

The acyl group represented by Ra, Rb, Rc, Rd, Re and Rf includes an aliphatic or aromatic one, such as acetyl, benzoyl, formyl, and pivaloyl. The nitrogen containing heterocyclic group formed by combination of Ra and Rb, Rc and Rd, Ra and Rc, or Rb and Rd includes a 3- to 10-membered saturated or unsaturated heterocyclic ring (e.g., ring groups such as piperidine ring, piperazine ring, acridine ring, pyrrolidine ring, pyrrol ring and morpholine ring).

Examples of acid anions used as the ion necessary to neutralize an intramolecular charge, represented by M₁ include a halide ion (e.g., chloride ion, bromide ion, iodide ion, etc.), p-toluenesulfonate ion, perchlorate ion, tetrafluorobarate ion, sulfate ion, methylsulfate ion, ethylsulfate ion, methansufonic acid ion and trifluoromethanesulfonic acid ion.

Exemplary compounds represented by formula (1) or (2) are shown below but are by no means limited to these.

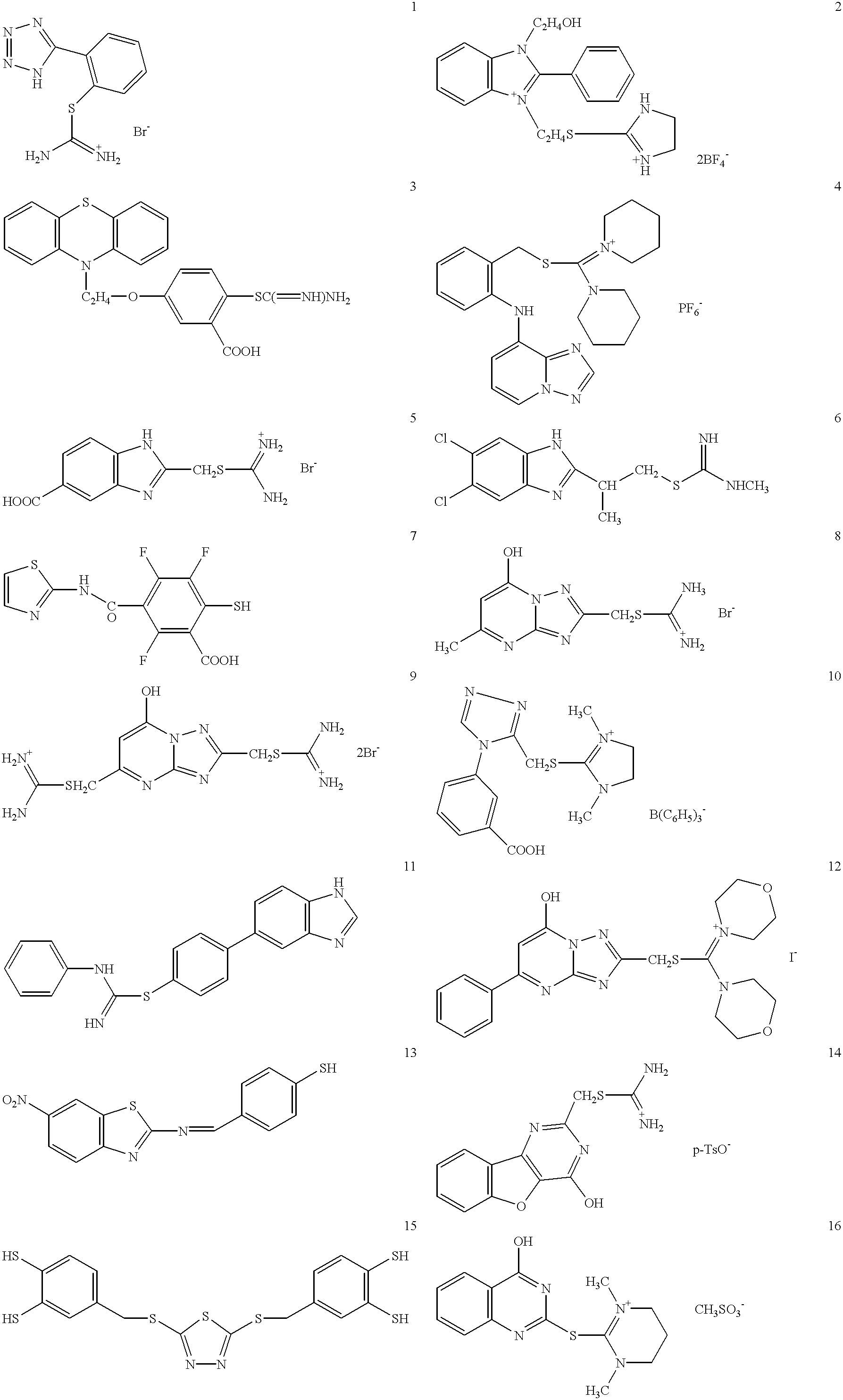

The compounds represented by formulas (1) and (2) are commercially available and can also be readily synthesized according to the methods known in the art, for example, the methods described in “Shin-Jikken Kagaku Koza” (New Series of Experimental Chemistry) vol. 14 (III), page 1739-1741 (edited by Chemical Society of Japan, 1978).

In photothermographic materials according to this invention, the compound represented by formulas (1) and (2) may be incorporated into a light sensitive layer or a light-insensitive layer, and preferably a light sensitive layer as an image forming layer. The addition amount of the compound represented by formulas (1) and (2), depending of the intended purpose, is preferably 10⁻⁴ to 1 mol/mol Ag, more preferably 10⁻³ to 0.3 mol/mol Ag, and still more preferably 10⁻³ to 0.1 mol/mol Ag.

The compound of formulas (1) and (2) each can be used alone or in combination. The compound of formulas (1) and (2) may be incorporated by dissolving in water or appropriate organic solvents such as alcohols (e/g/, methanol, ethanol, propanol, fluoroalcohol), ketones (e.g., acetone, methyl ethyl ketone), dimethylformamide, dimethylsulfoxide, and methyl cellosolve. Alternatively, the compound can be incorporated by the well known emulsion-dispersing method, in which the compound is dissolved in oils such as dibutyl phthalate, tricresyl phosphate and glyceryl triacetate and diethyl phthalate and auxiliary solvents such as ethyl acetate and cyclohexanone and then an emulsified dispersion is mechanically prepared. Further, the method known as a solid dispersion method is also employed, in which solid powdery particles are dispersed in water by means of a ball mill, colloid mill, sand grinder mill, Manton-Gaulin homogenizer, microfluidizer or ultrasonic homogenizer. Surfactants may be used in dispersing fine solid particles.

The photothermographic material comprises on a support at least an image forming layer. The image forming layer may be singly provided on the support but at least a non-image-forming layer is preferably provided on the image forming layer. Thus, to control the amount or wavelength distribution of light transmitting the image forming layer, there may be provided a filter dye layer on the image forming layer side, or an anti-halation dye layer on the image forming layer side and/or the opposite side. The image forming layer may be contained with a dye or a pigment. Any dye may be employed as long as it has an intended absorption within the desired wavelength region, including compounds described in JP-A No. 59-6481 and 59-182436; U.S. Pat. No. 4,271,263 and 4,594,312; European patent No. 533,008 and 652,473; JP-A 2-216,140, 4-348339, 7-91432 and 7-301890.

The non-image-forming layer preferably contain a binder or a matting agent and further a lubricant such as polysiloxane compounds, wax, or liquid paraffin. The image forming layer may be comprised plural layers, which may be arranged in the order of high-speed layer/low-speed later or low-speed layer/high-speed layer to control contrast.

The thermally developable photosensitive material (hereinafter, also referred to as photothermographic material), which forms images upon thermal development, comprises a reducible silver source (such as an organic silver salt), photosensitive silver halide, reducing agent and optionally an image toning agent to modify silver image color, which are dispersed in an (organic) binder matrix. The photothermographic material is stable at ordinary temperatures, which is developed, after exposure, upon heating at a high temperature (e.g., 80 to 140° C.). On heating, silver is formed through oxidation-reduction reaction between the organic silver salt (which acts as an oxidant) and the reducing agent. The oxidation-reduction reaction is catalyzed by silver latent images formed upon exposure to light. Silver formed by reaction of the organic silver salt in exposed areas provides a black image in contrast to non-exposed areas, forming images. This reaction process proceeds without supplying processing solution such as water from the exterior.

Reducing agents are incorporated into the photothermographic material of the present invention. Examples of suitable reducing agents are described in U.S. Pat. Nos. 3,770,448, 3,773,512, and 3,593,863, and Research Disclosure Items 17029 and 29963, and include the following: aminohydroxycycloalkenone compounds (for example, 2-hydroxypiperidino-2-cyclohexane); esters of amino reductones as the precursor of reducing agents (for example, piperidinohexose reducton monoacetate); N-hydroxyurea derivatives (for example, N-p-methylphenyl-N-hydroxyurea); hydrazones of aldehydes or ketones (for example, anthracenealdehyde phenylhydrazone; phosphamidophenols; phosphamidoanilines; polyhydroxybenzenes (for example, hydroquinone, t-butylhydroquinone, isopropylhydroquinone, and (2,5-dihydroxy-phenyl)methylsulfone); sulfydroxamic acids (for example, benzenesulfhydroxamic acid); sulfonamidoanilines (for example, 4-(N-methanesulfonamide)aniline); 2-tetrazolylthiohydroquinones (for example, 2-methyl-5-(1-phenyl-5-tetrazolylthio)hydroquinone); tetrahydroquionoxalines (for example, 1,2,3,4-tetrahydroquinoxaline); amidoxines; azines (for example, combinations of aliphatic carboxylic acid arylhydrazides with ascorbic acid); combinations of polyhydroxybenzenes and hydroxylamines, reductones and/or hydrazine; hydroxamic acids; combinations of azines with sulfonamidophenols; α-cyanophenylacetic acid derivatives; combinations of bis-β-naphthol with 1,3-dihydroxybenzene derivatives; 5-pyrazolones, sulfonamidophenol reducing agents, 2-phenylindane-1,3-dione, etc.; chroman; 1,4-dihydropyridines (for example, 2,6-dimethoxy-3,5-dicarboethoxy-1,4-dihydropyridine); bisphenols (for example, bis(2-hydroxy-3-t-butyl-5-methylphenyl)methane, bis(6-hydroxy-m-tri)mesitol, 2,2-bis(4-hydroxy-3-methylphenyl)propane, 4,5-ethylidene-bis(2-t-butyl-6-methyl)phenol, UV-sensitive ascorbic acid derivatives and 3-pyrazolidones. Of these, particularly preferred reducing agents are hindered phenols.

As preferred hindered phenols, listed are compounds represented by the general formula (A) described below:

formula (A)

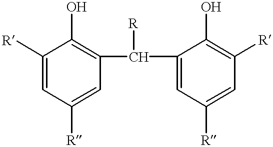

wherein R represents a hydrogen atom or an alkyl group having from 1 to 10 carbon atoms (for example, isopropyl, —C₄H₉, 2,4,4-trimethylpentyl), and R′ and R″ each represents an alkyl group having from 1 to 5 carbon atoms (for example, methyl, ethyl, t-butyl).

Exemplary examples of the compounds represented by the formula (A) are shown below.

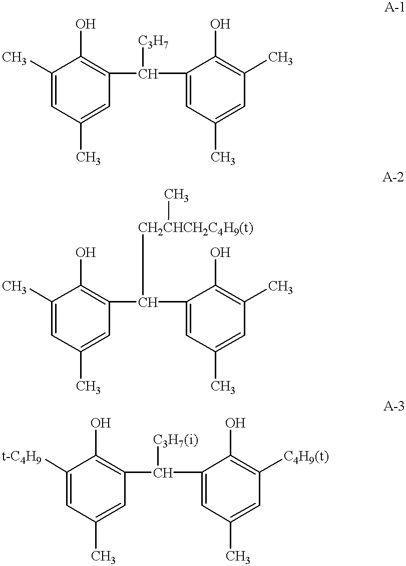

The used amount of reducing agents represented by the above-mentioned general formula (A) is preferably between 1×10⁻² and 10 moles, and is more preferably between 1×10⁻² and 1.5 moles per mole of silver.

The photothermographic material preferably contains, in addition to the foregoing components, an additive, which is called an image toning agent, color tone providing agent or activator toner (hereinafter, called an image toning agent). The image toning agent concers oxidation-reduction reaction of an organic silver salt with a reducing agent, having a function of increasing color of the formed silver image or making it black. Image toning agents are preferably incorporated into the photothermographic material used in the present invention. Examples of preferred image toning agents are disclosed in Research Disclosure Item 17029, and include the following:

imides (for example, phthalimide), cyclic imides, pyrazoline-5-one, and quinazolinone (for example, succinimide, 3-phenyl-2-pyrazoline-5-on, 1-phenylurazole, quinazoline and 2,4-thiazolidione); naphthalimides (for example, N-hydroxy-1,8-naphthalimide); cobalt complexes (for example, cobalt hexaminetrifluoroacetate), mercaptans (for example, 3-mercapto-1,2,4-triazole); N-(aminomethyl)aryldicarboxyimides [for example, N-(dimethylaminomethyl)phthalimide]; blocked pyrazoles, isothiuronium derivatives and combinations of certain types of light-bleaching agents (for example, combination of N,N′-hexamethylene(1-carbamoyl-3,5-dimethylpyrazole), 1,8-(3,6-dioxaoctane)bis-(isothiuroniumtrifluoroacetate), and 2-(tribromomethyl-sulfonyl)benzothiazole; merocyanine dyes (for example, 3-ethyl-5-((3-etyl-2-benzothiazolinylidene-(benzothiazolinylidene))-1-methylethylidene-2-thio-2,4-oxazolidinedione); phthalazinone, phthalazinone derivatives or metal salts thereof (for example, 4-(1-naphthyl)phthalazinone, 6-chlorophthalazinone, 5,7-dimethylphthalazinone, and 2,3-dihydro-1,4-phthalazinedione); combinations of phthalazinone and sulfinic acid derivatives (for example, 6-chlorophthalazinone and benzenesulfinic acid sodium, or 8-methylphthalazinone and p-trisulfonic acid sodium); combinations of phthalazine and phthalic acid; combinations of phthalazine (including phthalazine addition products) with at least one compound selected from maleic acid anhydride, and phthalic acid, 2,3-naphthalenedicarboxylic acid or o-phenylenic acid derivatives and anhydrides thereof (for example, phthalic acid, 4-methylphthalic acid, 4-nitrophthalic acid, and tetrachlorophthalic acid anhydride); quinazolinediones, benzoxazine, naphthoxazine derivatives, benzoxazine-2,4-diones (for example, 1,3-benzoxazine-2,4-dione); pyrimidines and asymmetry-triazines (for example, 2,4-dihydroxypyrimidine), and tetraazapentalene derivatives (for example, 3,6-dimercapto-1,4-diphenyl-1H,4H-2,3a,5,6a-tatraazapentalene). Preferred image color control agents include phthalazone or phthalazine.

In photothermographic materials used in this invention, spectral sensitizing dyes are employed, as described in JP-A No. 63-159841, 60-140335, 63-231437, 63-259651, 63-304242, 63-15245; U.S. Pat. Nos. 4,639,414, 4,740,455, 4,741,966, 4,751,175, and 4,835,096. Useful sensitizing dye in this invention are also described in RD17643, IV-A (page 23, December, 1978) and ibid 1831X (page 437, August, 1978). Specifically, sensitizing dyes exhibiting sensitivity suitable for spectral characteristics of various scanner light sources can be advantageously selected, as described in JP-A No. 9-34078, 9-54409 and 9-80679.

In cases when being super-sensitized, and specifically when a reducing agent is not deactivated, photosensitivity is enhanced, print-out is easily promoted after development. In such a case, the present invention is effective. In cases when being infrared-sensitized, an infrared sensitizing dye has an oxidation-reduction potential at which a silver halide or an organic silver salt is slightly reducible, easily producing a silver cluster forming fog silver in the presence of the reducing agent, even when placed in a dark room. The produced silver cluster also induces fogging as a catalyst nucleus, deteriorating storage stability in the dark room or promoting print-out when placed in a daylight room after development. Further, sensitivity of the infrared sensitive material extends to the thermal radiation region outside the visible region so that the present invention is effective for inhibiting print-out silver produced by thermal radiation. Such a effect is marked in infrared-sensitized photosensitive materials which is sensitized with a supersensitizer. Useful sensitizing dyes, dye combinations exhibiting super-sensitization and materials exhibiting supersensitization are described in RD17643 (published in December, 1978), IV-J at page 23, JP-B 9-25500 and 43-4933 (herein, the term, JP-B means published Japanese Patent) and JP-A 59-19032, 59-192242 and 5-341432.

In the invention, an aromatic heterocyclic mercapto compound represented by the following formula (4) is preferred as a supersensitizer:

formula (4)

Ar—SM

wherein M is a hydrogen atom or an alkali metal atom; Ar is an aromatic ring or condensed aromatic ring containing a nitrogen atom, oxygen atom, sulfur atom, selenium atom or tellurium atom. Such aromatic heterocyclic rings are preferably benzimidazole, naphthoimidazole, benzothiazole, naphthothiazole, benzoxazole, naphthooxazole, benzoselenazole, benzotellurazole, imidazole, oxazole, pyrazole, triazole, triazines, pyrimidine, pyridazine, pyrazine, pyridine, purine, and quinoline. Other aromatic heterocyclic rings may also be included.

A disulfide compound which is capable of forming a mercapto compound when incorporated into a dispersion of an organic silver salt and/or a silver halide grain emulsion is also included in the invention. In particular, a preferred example thereof is a disulfide compound represented by the following formula:

Formula (5)

Ar—S—S—Ar

wherein Ar is the same as defined in formula (4). The aromatic heterocyclic rings described above may be substituted with a halogen atom (e.g., Cl, Br, I), a hydroxy group, an amino group, a carboxy group, an alkyl group (having one or more carbon atoms, and preferably 1 to 4 carbon atoms) or an alkoxy group (having one or more carbon atoms, and preferably 1 to 4 carbon atoms).

Exemplary examples of mercapto-substituted aromatic heterocyclic compound are shown below but are not limited to these.

| | |
|---|---|
| M-1: | 2-mercaptobenzimidazole |
| M-2: | 2-mercaptobenzoxazole |
| M-3: | 2-mercaptobenzthiazole |
| M-4: | 5-methyl-2-mercaptobenzimidazole |
| M-5: | 6-ethoxy-2-mercaptobenzthiazole |
| M-6: | 2,2′-dithiobis(benzthiazole) |
| M-7: | 3-mercapto-1,2,4-triazole |
| M-8: | 4,5-diphenyl-2-imidazole |
| M-9: | 2-mercaptoimidazole |
| M-10: | 1-ethyl-2-mercaptobenzimidazole |
| M-11: | 2-mercaptoquinoline |
| M-12: | 8-mercaptopurine |
| M-13: | 2-mercapto-4(3H)-quinazoline |
| M-14: | 7-trifluoromethyl-4-quinolinethiol |
| M-15: | 2,3,5,6-tetrachloro-4-pyridinethiol |
| M-16: | 4-amino-6-hydroxy-2-mercaptopyridine monohydrate |
| M-17: | 2-amino-5-mercapto-1,3,4-thiazole |
| M-18: | 3-amino-5-mercapto-1,2,4-triazole |
| M-19: | 4-hydroxy-2-mercaptopyridine |
| M-20: | 2-mercaptopyridine |
| M-21: | 4,6-diamino-2-mercaptopyridine |
| M-22: | 2-mercapto-4-methylpyrimidine hydrochloride |
| M-23: | 3-mercapto-5-phenyl-1,2,4-riazole |
| M-24: | 2-mercapto-4-phenyloxazole |

The supersensitizer compound usable in the invention is incorporated into an emulsion layer containing the organic silver salt and silver halide grains, preferably in an amount of 0.001 to 1.0 mol, and more preferably 0.01 to 0.5 mo per mol of silver.

Antifoggants may be incorporated into the photothermographic material to which the present invention is applied. The substance which is known as the most effective antifoggant is a mercury ion. The incorporation of mercury compounds as the antifoggant into photosensitive materials is disclosed, for example, in U.S. Pat. No. 3,589,903. However, mercury compounds are not environmentally preferred. As mercury-free antifoggants, preferred are those antifoggants as disclosed in U.S. Pat. Nos. 4,546,075 and 4,452,885, and JP-A No. 59-57234.

To improve variation in density after storage, in this invention, oxidizing agents are employed to reduce fogging after development. As such an oxidizing agent employed are compounds described in JP-A No. 50-119642, 50-120328, 51-121332, 54-58022, 56-70543, 56-99335, 59-90842, 61-129642, 62-129845, 6-208191, 7-5621, 7-2781, 8-15809; U.S. Pat. Nos. 5,340,712, 5,369,000, 5,464,737, 3,874,946, 4,756,999, 5,340,712; European Patent No. 605,981A1, 622,666A1, 631,176A1; JP-B No. 54-165; JP-A No. 7-2781; U.S. Pat. No. 4,180,665 and 4,442,202. Specifically, a poly-halogen compound represented by the following formula (I) is preferred:

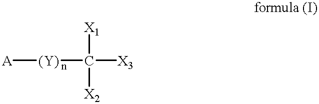

wherein A represents an aliphatic group, an aromatic group, or a heterocyclic group; X₁, X₂ and X₃ each represent a hydrogen atom or an electron-withdrawing group, which may be the same with or different from each other; Y represents a bivalent linkage group; and n is 0 or 1.

The electron-withdrawing group represented by X₁, X₂ and X₃ is preferably a group exhibiting a σp value of not less than 0.01 and more preferably not less than 0.1. Hammett substituent constant (σp) is detailed in Jornal of Medicinal Chemistry, 1973, Vol. 16, No. 11, 1207 to 1216. Examples of the electron-withdrawing group include a halogen atom [e.g., fluorine atom (σp of 0.23), iodine atom (σp of 0.23), bromine atom (σp of 0.18), a trihalomethyl group [e.g., tribromomethyl (σp of 0.29), trichloromethyl (σp of 0.33), trifluoeomethyl (σp of 0.54)], cyano group (σp of 0.66), nitro group (σp of 0.78), aliphatic, aryl or heterocyclic acyl group [e.g., acetyl (σp of 0.50), benzoyl (σp of 0.43)], an alkynyl group [e.g., C₃H₃ (σp of 0.09)], an aliphatic, aryl or heterocyclic oxycarbonyl group [e.g., methoxycarbonyl (σp of 0.45), phenoxycarbonyl (σp of 0.45)], a carbamoyl group (σp of 0.36), and a sulfamoyl group (σp of 0.57).

X₁, X₂ and X₃ are each preferably an electron-withdrawing group, and more preferably a halogen atom [e.g., fluorine atom (σp of 0.23), iodine atom (σp of 0.23), bromine atom (σp of 0.18), a trihalomethyl group [e.g., tribromomethyl (σp of 0.29), trichloromethyl (σp of 0.33), trifluoeomethyl (σp of 0.54)], cyano group (σp of 0.66), nitro group (σp of 0.78), aliphatic, aryl or heterocyclic acyl group [e.g., acetyl (σp of 0.50), benzoyl (σp of 0.43)], an alkynyl group [e.g., C₃H₃ (σp of 0.09)], an aliphatic, aryl or heterocyclic oxycarbonyl group [e.g., methoxycarbonyl (σp of 0.45), phenoxycarbonyl (σp of 0.45)], a carbamoyl group (σp of 0.36), and a sulfamoyl group (σp of 0.57); and still more preferably a halogen atom. Of halogen atoms, chlorine atom, bromine atom and iodine atom are preferred and chlorine atom and bromine atom are more preferred, and bromine atom id still more preferred.

Y is a bivalent linkage group and examples thereof include —SO₂—, —SO—, —CO—, —N(R₁₀₁)—SO₂—, —N(R₁₀₁)—CO—, —N(R₁₀₁)—COO—, —COCO—, —COO—, —OCO—, —OCOO—, —SCO—, —SCOO—, —C(Z₁₁) (Z₁₂)—, alkylene, arylenes bivalent heterocyclic group and a bivalent linkage groups formed by the combination of these groups. R₁₀₁ is a hydrogen atom or an alkyl group, and preferably a hydrogen atom. Z₁₁ and Z₁₂ is a hydrogen atom or an electron-withdrawing group, provided that both of them are not hydrogen atoms at the same time and the electron-withdrawing group preferably is a group exhibiting a Hammett substituent constant (σp) of not less than 0.01, and more preferably not less than 0.1. Preferred electron-withdrawing groups of Z₁₁ and Z₁₂ are the same as those of X₁, X₂ and X₃.

Z₁₁ and Z₁₂ are preferably a halogen atom, cyano, or nitro. The halogen atom is preferably a chlorine, bromine and iodine atom, more preferably a chlorine or bromine atom, and still more preferably a bromine atom. Y is preferably —SO₂—, —SO— or —CO—, and more preferably —SO₂—; and n is preferably 1.

The aliphatic group represented by A is a straight-chain, branched or cyclic alkyl group (preferably having 1 to 30 carbon atoms, more preferably 1 to 20 carbon atoms, and still more preferably 1 to 12 carbon atoms, such as methyl, ethyl, iso-propyl, tert-butyl, n-octyl, n-decyl, cyclopropyl, cyclopentyl and cyclohexyl), alkenyl group (preferably having 2 to 30 carbon atoms, more preferably 2 to 20 carbon atoms, and still more preferably 2 to 12 carbon atoms, such as vinyl, allyl, 2-butenyl, 3-pentenyl), alkynyl group (preferably having 2 to 30 carbon atoms, more preferably 2 to 20 carbon atoms, and still more preferably 2 to 12 carbon atoms, such as propargyl, 3-pentynyl), each of which may be substituted. Examples of the substituent group include a carboxy group, an acyl group, an acylamino group, a sulfonylamino group, a carbamoyl group, an oxycarbonylamino group, and an ureido group. The aliphatic group is preferably an alkyl group, and more preferably a chained alkyl group. The aromatic group represented by A is preferably an aryl group; the aryl group is preferably mono-cyclic or di-cyclic aryl group having 6 to 30 carbon atoms (e.g., phenyl, naphthyl), more preferably a phenyl group having 6 to 20 carbon atoms, and still more preferably a phenyl group having 6 to 12 carbon atoms. The aryl group may be substituted and examples of the substituent group include a carboxy group, an acyl group, an acylamino group, a sulfonylamino group, a carbamoyl group, an oxycarbonylamino group, and an ureido group. The heterocyclic group represented by A is a 3- to 10-membered, saturated or unsaturated heterocyclic group containing a N, O, or S atom, which may be monocyclic or a ring condensed with another ring. Examples of the heterocyclic group include pyrrolidine, piperidine, piperadine, morpholine, thiophene, furan, pyrrole, imidazole, pyrazolo, pyridine, pirazine, pyridazine, triazole, triazine, indole, indazole, purine, thiadiazole, oxadiazole, quinoline, phthalazine, naphthylidine, quinoquixaline, quinazolone, cinnoline, puteridine, acridine, phenazine, tetrazole, thiazole, oxazole, benzimidazole, benzoxazole, benzthiazole, and indolenine. Of these, thiophene, furan, pyrrole, imidazole, pyrazolo, pyridine, pyrazine, pyridazine, triazole, trazine, indole, indazole, quinoline, thiadiazole, oxadiazole, phthalazine, naphthylidine, quinoxaline, quinazolone, cinnolinepteridine, tetrazole, thiazole, oxazole, benzimidazole, benzoxazole, benzthiazole, and indolenine are preferred; pyridine, triazine, quinoline, thiadizole, benzthiazole, and oxadiazole are more preferred; and pyridine, quinoline, thiadiazole and oxadiazole are still more preferred.

Of the foregoing polyhalogen compounds, a compound represented by the following formula (I-a) are more preferred:

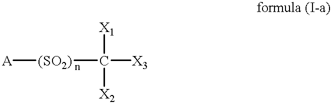

wherein A, X₁, X₂, X3 are the same as defined in formula (I), and the preferred range is also the same as defined in formula (I).

Exemplary examples of the polyhalogen compounds are shown below bur are by no means limited to these.

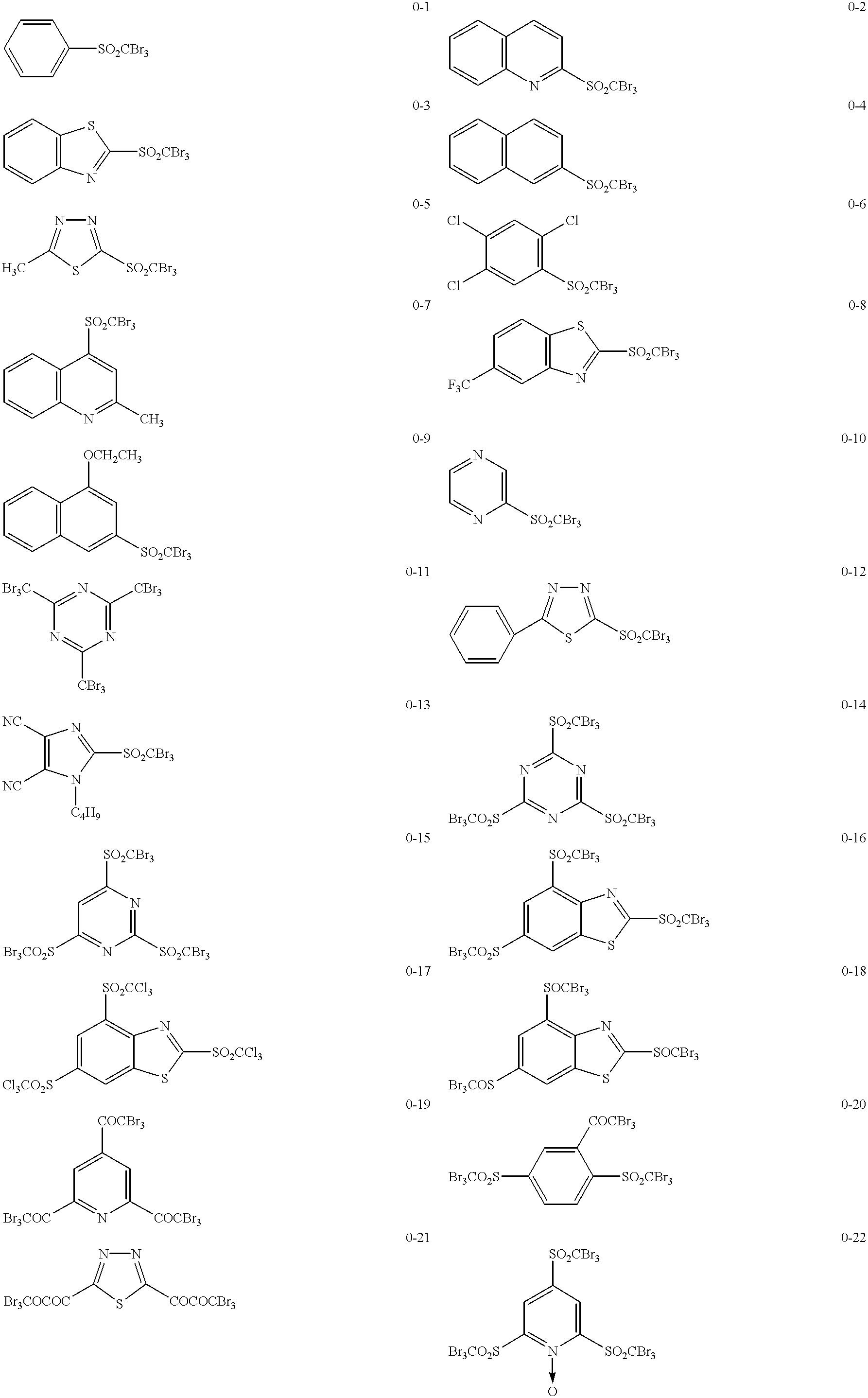

In this invention the foregoing oxidizing agent is incorporated preferably in an amount of 10 mg/m² to 3 g/m², and more preferably 50 mg/m² to 1 g/m². The oxidizing agent may be incorporated in any form, such as a solution, powder, or a solid particle dispersion, and is preferably incorporated into the image forming layer in the form of a solid particle dispersion. A dispersing aid may be used in its dispersion. It may be incorporated in the form a solution, together with other additives such as sensitizing dye, reducing agent, or image toning agent.

Besides the foregoing oxidizing agent, suitable antifoggants are employed, including compounds described in U.S. Pat. Nos. 3,874,946, 4,756,999; compounds described in JP-A No. 9-288328, column [0030] to [0036], compounds described in JP-A No. 9-90550, column [0062] to [0063], and compounds described in U.S. Pat. No. 5,028,523, European Patent No. 600,587, 631,176 and 605,981.

Binders suitable for the thermally developable photosensitive material to which the present invention is applied are transparent or translucent, and generally colorless. Binders are natural polymers, synthetic resins, and polymers and copolymers, other film forming media; for example, gelatin, gum arabic, poly(vinyl alcohol), hydroxyethyl cellulose, cellulose acetate, cellulose acetatebutylate, poly(vinyl pyrrolidone), casein, starch, poly(acrylic acid), poly(methyl methacrylic acid), poly(vinyl chloride), poly(methacrylic acid), copoly(styrene-maleic acid anhydride), copoly(styrene-acrylonitrile, copoly(styrene-butadiene, poly(vinyl acetal) series [e.g., poly(vinyl formal) and poly(vinyl butyral), polyester series, polyurethane series, phenoxy resins, poly(vinylidene chloride), polyepoxide series, polycarbonate series, poly(vinyl acetate) series, cellulose esters, poly(amide) series. Of these binders are preferred aqueous-insoluble polymers such as cellulose acetate, cellulose acetate-butylate and poly(vinyl butyral); and poly(vinyl formal) and poly(vinyl butyral) are specifically preferred as a polymer used in the thermally developable photosensitive layer; and cellulose acetate and cellulose acetate-butylate are preferably used in a protective layer and backing layer.

Another preferred binder in this invention is a polymeric latex. Such a polymeric latex is preferably contained in the image forming layer. The content of the polymeric latex is preferably 50% by weight or more, based on the total binder. Herein, the polymeric latex is a water-insoluble polymeric material which is dispersed in an aqueous dispersing medium in the form of fine solid particles. The dispersion form thereof may be any one of a form in which a polymer is emulsified in a dispersing medium, a form of being emulsion-polymerized, being dispersed in the form of a micell and a form in which a polymer has a hydrophilic partial structure and its molecular chain is in the form of a molecular dispersion. The polymeric latexes are described in “Synthetic Resin Emulsion” (edited by T. Okuda and h. Inagaki, published by KOBUNSHI-KANKOKAI, 1978), “Application of Synthetic Latex” (edited by Sugimura et al., published by KOBUNSHI-KANKOKAI, 1993), and “Chemistry of Synthetic Latex” (S. Muroi, published by KOBUNSHI-KANKOKAI, 1970).

The mean particle size of dispersing particles is 1 to 50,000 nm, and preferably 5 to 1,000 nm. The particle size distribution thereof is not specifically limited and may be polydisperse or monodisperse. The polymeric latexes used in the invention may be those having a uniform structure as well as core/shell type latexes. In this case, it is sometimes preferred that the glass transition temperature is different between the core and shell. The minimum forming (or tarnishing) temperature (MFT) of the polymeric latexes is preferably 30 to 90° C., and more preferably 0 to 70° C. A tarnishing aid is also called a plasticizer, which is an organic compound (conventionally, an organic solvent) capable of lowering the MFT of a polymeric latex and described in “Chemistry of Synthetic Latex” (S. Muroi, published by KOBUNSHI-KANKOKAI, 1970).

Polymers used for polymeric latexes include acryl resin, vinyl acetate resin, polyester resin, polyurethane resin, rubber type resin, vinyl chloride resin, vinylidene chloride resin, polyolefin resin and their copolymers. Polymers may be a straight-chained polymer or branched polymer, or a cross-linked polymer, including homopolymers and copolymers. The copolymer may be a random copolymer or a block copolymer. The number-averaged molecular weight of the copolymer is preferably 5,000 to 1000,000, and more preferably 10,000 to 100,000. In cases where the molecular weight is excessively small, mechanical strength of an image forming layer such as a light-sensitive layer is insufficient, excessively large molecular weight results in deterioration in film forming property. Polymers used for polymeric latexes preferably has an equilibrium moisture content of not more than 2 wt %, and more preferably 1 wt % or less at 25° C. and 60% RH. The lower limit of the equilibrium moisture content is not specifically limited, but preferably 0.01 wt %, and more preferably 0.03 wt %. Definition and measurement of the equilibrium moisture content is detailed in “Polymer Material Testing Method” in Polymer Engineering Series vol.14 (edited by KOBUNSHI-GAKKAI, published by CHJINSHOKAN).

Exemplary examples of polymeric latexes used as binder include a latex of methylmethacrylate/ethylmethacrylate/methacrylic acid copolymer, a latex of methylmethacrylate/2-ethylhexylacrylate/styrene/acrylic acid copolymer, a latex of styrene/butadiene/acrylic acid copolymer, a latex of styrene/butadiene/divinylbenzene/methacrylic acid copolymer, a latex of methylmethacrylate/vinyl chloride/acrylic acid copolymer, and a latex of vinylidene chloride/ethylacrylate/acrylonitrile/methacrylic acid copolymer. Such polymers are commercially available, and examples of commercially available acryl resin include Sevian A-4635, 46583, and 4601 (available from DAISEL CHEMICAL Ind. Ltd.) Nipol Lx811, 814, 821, 820, and 857 (available from NIHON ZEON Co. Ltd. Examples of polyester rein include FINETEX ES650, 611, 675, 850 (available from DAINIPPON INK CHEMICAL Co. Ltd.), and WD-size WMS (available from Eastman Kodak Corp.). Examples of polyurethane resin include HYDRAN AP10, 20, 30, 40 (available from DAINIPPON INK CHEMICAL Co. Ltd.). Examples of rubber resin include LACSTAR 7310K, 3307, 4700H, 7132C (available from DAINIPPON INK CHEMICAL Co. Ltd.); and Nipol Lx416, 410, 438C and 2507 (available from NIHON ZEON Co. Ltd.). Examples of vinylidene chloride resin include L502, L513 (available from ASAHI CHEMICAL IND. Co. Ltd.). Examples of olefin resin include CHEMIPAL s120, SA100 (available from MITSUI PETROLEUM CHEMICAL IND. Co. Ltd.). These polymers can be used alone or may be blended.

Polymer species of the polymeric latex are preferably those containing 0.1 to 10% by weight of a carboxylic acid component, such as acrylate or methacrylate. In cases where a polymeric latex is incorporated in the image forming layer, the polymeric latex preferably accounts for at least 50% by weight, and more preferably at least 70% by weight, based on the binder contained in the image forming layer. In that case, not more than 50% by weight of the whole binder of the image forming layer may be accounted for by a hydrophilic polymer such as gelatin polyvinyl alcohol, methyl cellulose, hydroxypropyl cellulose, carboxymethyl cellulose, or hydroxypropykmethyl cellulose. The amount of these polymers is preferably not more than 30% by weight of the whole binder.

In case when the polymer latex is used in the image forming layer, it is preferred that an aqueous-type coating solution is coated and dried to form the image forming layer. Herein, the expression “aqueous-type” means that at least 50% (preferably at least 65%) by weight of a solvent (dispersing medium) used in the coating solution is water. The solvent(s) contained in the coating solution other than water include, for example, water-miscible organic solvents, such as methanol, ethanol, isopropanol, methyl cellosolve, ethyl cellosolve, dimethyl formamide and ethyl acetate. Examples of the solvent composition include water/methanol (90/10), water/methanol (70/30), water/ethanol (90/10), water/isopropanol (90/10), water/dimethyl formamide (95/5), water/methanol/dimethyl formamide (80/15/5), and water/methanol/dimethyl formamide (90/5/5), wherein the number means weight percentage.

There may be incorporated to the image forming layer a cross-linking agent for cross-linking or a surfactant to improve coating property. In cases when the image forming layer contains a polymeric latex, the coating solution of the image forming layer is preferably a thixotropy fluid. Herein the thixotropy indicates a property in which the viscosity is lowered with increasing the shear rate. The viscosity can be measured by any instrument, and preferably using FRS Fluid Spectrometer (available from Rheometrics Far East Corp.), at a temperature of 25° C. In a fluid containing an organic silver salt or a coating solution of the image forming layer used in this invention, the viscosity is preferably 400 mpa·s 100,000 mPa·s, and more preferably 500 mPa·s to 20,000 mPa·s at a shear rate of 0.1/sec. Further, the viscosity is preferably 1 mPa·s 200 mPa·s, and more preferably 5 mPa·s to 80 mPa·s at a shear rate of 1,000/sec. There are known various systems exhibiting thixotropy, as described in “Series Rheology” edited by KOBUNSHI-KANKOKAI; and “Polymer Latex” (Muroi & Morino, published by KOBUNSHI-KANKOKAI). To allow the liquid to display thixotropy, it is necessary to contain a large amount of fine solid particles. Further, incorporation of a viscosity-increasing linear polymer, the fine solid particles exhibiting anisotropy and having a large aspect ratio, viscosity increasing with alkali or the use of a surfactant is also effective to enhance the thixotropy.

The total amount of the binder used in the image forming layer is 0.2 to 30 g/m2, and preferably 1 to 15 g/m². There can be provided a non-image forming layer on the outer side of the image forming layer to protect the surface of the photothermographic material or prevent it from abrasion. Binders used in the light-insensitive layer may be the same with or different from those used in the image forming layer. The binder amount in the image forming layer is preferably 0.5 to 30 g/m², and more preferably 1 to 15 g/m² to enhance thermal developing speed. In the case of less than 0.5 g/m2, the density of unexposed areas sometimes markedly increases to a level unacceptable to practical use.

It is preferred to incorporate a matting agent to the image forming layer-side. Thus, it is preferred to allow a matting agent to exist on the surface of the photothermographic material to prevent images formed after thermal processing from abrasion. The amount of the matting agent is preferably 0.5 to 30% by weight, based on the whole binder of the image forming layer-side. In cases where at least a non-image forming layer is provided on the side opposite to the image forming layer, the non-image forming layer preferably contains a matting agent. The matting agent may be either regular form or irregular form, and preferably is a regular form and a spherical form is more preferred.

In the photothermographic material used in this invention, there may be provided, on a support, an image forming layer alone, but at least a non-image forming layer is preferably provided on the image forming layer. To control the amount or wavelength distribution of light passing through the image forming layer, there may be a filter dye layer on the image forming layer-side or an ati-halation dye layer, so-called backing layer on the opposite side. A dye or pigment may be incorporated to the image forming layer. The non-image forming layer may contain the binder or matting agent described above, or lubricants such as polysiloxane compounds or liquid paraffin.

Various types of surfactants can be employed as a coating aid in the photothermographic material used in this invention. Specifically, fluorinated surfactants are preferably employed to improve an antistatic property or to prevent dot-like coating troubles.

An anti-halation layer is provided farther from the image forming layer with respect to a light source. The anti-halation layer preferably exhibits the maximum absorption of 0.1 to 2.0 within the intended wavelength region, and more preferably 0.2 to 1.5 of the absorption within the exposure wavelength region; the absorption after being processed is preferably not less than 0.01 and less than 0.2, and more preferably not less than 0.001 and less than 0.15, as a optical density of the layer. In cases where used in printing plate making, the layer exhibits preferably an optical density of not less than 0.001 and less than 0.2, and more preferably not less than 0.001 and less than 0.15 in the absorption at a wavelength of 400 nm. Anti-halation dyes usable in this invention are any compound having desired absorption within the intended wavelength region and exhibiting sufficiently reduced absorption after being processed, thereby forming a desired absorption spectrum form.

Examples of the dyes include compounds described in JP-A 59-56458, 2-216140, 7-13295, 7-11432; U.S. Pat. No. 5,380,635; JP-A 2-6853 at page 13, lower left column line 1 to page 14, lower left column line 9, JP-A 3-24539 at page 14, lower left column to page 16, lower right column. Dyes capable of being decolorized on processing include, for example, compounds described in JP-A 52-139136, 53-132334, 56-501480, 57-16060, 57-68831, 57-101835, 59-182436, 7-36145, 7-199409; JP-B (hereinafter, the term, JP-B means published Japanese Patent) 48-33692, 5-16648, 2-41734; and U.S. Pat. Nos. 4,088,497, 4,283,487, 4,548,896, and 5,187,049.

The photothermographic material used in this invention has at least an image forming layer (or a light sensitive layer) on one side of the support and may further have another component layer. Specifically, the photothermographic material used in this invention preferably is a single-sided recording material comprising on one side of the support having at least an image forming layer and a back layer on the other side. Binders suited to the back layer are transparent or translucent and, in general, colorless, including natural polymers, synthetic resin and polymers, and their copolymers. Examples thereof include gelatin, gum arabic, poly(vinyl alcohol), hydroxyethyl cellulose, cellulose acetate, cellulose butylate, poly(vinyl pyrrolidine), casein, starch, poly(acrylic acid), poly(methyl methacrylic acid), poly(vinyl chloride), poly(methacrylic acid), copoly(styrene-anhydrous maleic acid), copoly(styrene-acrylonitrile), copoly(styrene-butadiene), poly(vinyl acetal)s such as poly(vinyl formal), poly(vinyl butyral), polyesters, polyurethanes, phenoxy resin, poly (vinilidene chloride), polyexpoxides, polycarbonates, poly(vinyl acetate), cellulose esters, and polyamides. Binders may be cover-coated using water, an organic solvent or an emulsion.

The back layer preferably exhibits the maximum absorption of 0.3 to 2.0 within the intended wavelength region, and more preferably 0.5 to 2 of the absorption within the exposure wavelength region; the absorption after being processed is preferably not less than 0.01 and less than 0.5, and more preferably not less than 0.001 and less than 0.3, as a optical density of the layer. In cases where used in printing plate making, the layer exhibits preferably an optical density of not less than 0.001 and less than 0.2, and more preferably not less than 0.001 and less than 0.15 in the absorption at a wavelength of 400 nm. Examples of anti-halation dyes used in the back layer are the same as cited in the anti-halation layer afore-mentioned.

Various additives may be incorporated to any one of the image forming layer, non-image forming layer and other layers. There may be employed a surfactant, antioxidant, stabilizer, plasticizer, UV absorbent, and coating aid in the photothermographic material. As these additives and other adjuvants are usable compounds described in Research Disclosure (also denoted as RD) 17029 (June, 1978, pages 9-15).

Supports usable in this invention are preferably plastic films to prevent deformation after being processed, including, e.g., polyethylene terephthalate (PET), polycarbonate, polyimide, nylon, cellulose acetate, and polyethylene naphthalate. The thickness of a support is ca. 50 to 300 μm, and preferably 70 to 180 μm. There may be used a thermally treated plastic resin support. The thermal treatment of the support is to heat at a temperature of at least 30° C., preferably at least 35° C., more preferably at least 40° C. higher than the glass transition point of the support, after casting of the film and until coating of the image forming layer. Casting and subbing of the support can be made by commonly known methods and preferably according to the method described in JP-A 8-50094 at paragraphs [0030] to [0070].

Photothermographic materials may be developed by any method, and the imagewise-exposed photothermographic material is usually heated to develop. The heat-developing time is preferably 105 to 145° C., and more preferably 107 to 140° C. The heat-developing time is preferably 1 to 180 sec., more preferably 7 to 50 sec., and still more preferably 8 to 25 sec. The photothermographic materials are thermally processed preferably using a thermal processor. The photothermographic material is easily affected by the temperature variation of the heat-developing section of the processor, resulting in uneven development. There are employed a heated drum type automatic processor described in JP-A 9-297384, 9-297385 and 9-297386, and a planar-transport type automatic thermal processor described in WO 98/27458. Photothermographic materials which are specifically used in the field of printing plate making are preferably processed by the planer-transport type thermal processor to enhance dimensional stability. A thermal processor is preferably used, in which a pre-heating section is provided prior to the heat-developing section and the preheating temperature is 80 to 120° C. The pre-heating promotes development and reduces unevenness in density, and also being effective in scanning unevenness. A thermal processor described in JP-A 11-133572 is also preferably used, in which a photothermographic material is transported while one side of the photothermographic material is brought into contact with a fixed hating body and the other side is pressed to a heating body by plural rollers.

Photothermographic materials used in this invention may be exposed by any means and lasers are preferably employed as a light source. Preferred lasers usable in this invention include, for example, gas laser, YAG laser, dye laser and semiconductor laser. Specifically, longitudinal multiple exposure or an oblique exposure method is preferred to prevent interference fringes and unevenness of halftone dot exposure.

The longitudinal multiple exposure is made using a laser scanning exposure apparatus emitting longitudinally multiple scanning laser light beams, whereby deterioration in image quality such as occurrence of interference fringe-like unevenness is reduced, as compared to a scanning laser beam of the longitudinally single mode. As described in JP-A 59-10964, longitudinal multiplication can be achieved by a technique of employing backing light with composing waves or a technique of high frequency overlapping. The expression “longitudinally multiple” means that the exposure wavelength is not a single wavelength. The exposure wavelength distribution is usually not less than 5 nm and not more than 10 nm. The upper limit of the exposure wavelength distribution is not specifically limited but is usually about 60 nm. The oblique exposure is that exposure is made using a laser exposure apparatus, in which a scanning laser light is not exposed at an angle substantially vertical to the exposed surface of the photothermographic material, as described in JP-A 5-113548. The expression “laser light is not exposed at an angle substantially vertical to the exposed surface” means that laser light is exposed preferably at an angle of 55 to 88°, more preferably 60 to 86°, still more preferably 65 to 84°, and optimally 70 to 82°. When the photosensitive material is scanned with laser light, the beam spot diameter on the surface of the photosensitive material is preferably not more than 200 μm, and more preferably not more than 100 μm. Thus, a smaller spot diameter preferably reduces the angle displacing from verticality of the laser incident angle.

An automatic thermal processor used for thermal development of photothermographic materials used in this invention is preferably provided with a planar heating member and a transport roller, between which a photothermographic material is allowed to pass through, while being brought into contact with the planar heating member to be thermally developed therein. The preferred range of the developing temperature and time was afore-mentioned. The transport speed of the photothermographic material is preferably 22 to 40 mm/sec., and more preferably 22 to 26 mm/sec.

The planar heating member preferably has a gigged material. The gigged material refers to a napped fabric such as velvet, and any material which exhibits a glass transition point higher than the developing temperature is usable. The nap length is preferably 0.5 to 5 mm. Exemplary examples thereof include velvet, glass cloth, carbon cloth and aramid cloth.

### EXAMPLES

Embodiments of the present invention will be further described based on examples, but the invention is not limited to these.

### Example 1

### Preparation of Photothermographic Material

### Preparation of a Subbed Photographic Support

Both surfaces of a biaxially stretched thermally fixed 125 μm polyethylene terephthalate (hereinafter, also denoted as PET) film, available on the market, were subjected to corona discharging at 8 w/m²·min. Onto the surface of one side, the subbing coating composition a-1 descried below was applied so as to form a dried layer thickness of 0.8 μm, which was then dried. The resulting coating was designated Subbing Layer A-1. Onto the opposite surface, the subbing coating composition b-i described below was applied to form a dried layer thickness of 0.8 μm. The resulting coating was designated Subbing Layer B-1.

| Subbing Coating Composition a-1 | | |
|---|---|---|
| Latex solution (solid 30%) of | 270 | g |
| a copolymer consisting of butyl acrylate | | |
| (30 weight %), t-butyl acrylate (20 weight %) | | |
| styrene (25 weight %) and 2-hydroxy | | |
| ethyl acrylate (25 weight %) | | |
| (C-1) | 0.6 | g |
| Hexamethylene-1,6-bis(ethyleneurea) | 0.8 | g |
| Polystyrene fine particles (av. size, 3 μm) | 0.05 | g |
| Colloidal silica (av. particle size, 90 μm) | 0.1 | g |
| Water to make | 1 | liter |
| Subbing Coating Composition b-1 | | |
| SnO₂/Sb (9/1 by weight, av. Size 0.18 μm) | 200 | mg/m² |
| Latex liquid (solid portion of 30%) | 270 | g |
| of a copolymer consisting of | | |
| butyl acrylate (30 weight %) | | |
| styrene (20 weight %) | | |
| glycidyl acrylate (40 weight %) | | |
| (C-1) | 0.6 | g |
| Hexamethylene-1,6-bis(ethyleneurea) | 0.8 | g |
| Water to make | 1 | liter |

Subsequently, the surfaces of Subbing Layers A-1 and B-1 were subjected to corona discharging with 8 w/m²·minute. Onto the Subbing Layer A-1, the upper subbing layer coating composition a-2 described below was applied so as to form a dried layer thickness of 0.1 μm, which was designated Subbing Layer A-2, while onto the Subbing Layer B-1, the upper subbing layer coating composition b-2 was applied so at to form a dried layer thickness of 0.8 μm, having a static preventing function, which was designated Subbing Upper Layer B-2.

Upper Subbing Layer Coating Composition a-2

| | | |
|---|---|---|
| Gelatin in an amount (weight) to make | 0.4 | g/m² |
| (C-1) | 0.2 | g |
| (C-2) | 0.2 | g |
| (C-3) | 0.1 | g |
| Silica particles (av. size 3 μm) | 0.1 | g |
| Water to make | 1 | liter |

Upper Subbing Layer Coating Composition b-2

| | | |
|---|---|---|
| (C-4) | 60 | g |
| Latex solution (solid 20% comprising) | 80 | g |
| (C-5) as a substituent | | |
| Ammonium sulfate | 0.5 | g |
| (C-6) | 12 | g |
| Polyethylene glycol (average | 6 | g |
| molecular weight of 600) | | |
| Water to make | 1 | liter |

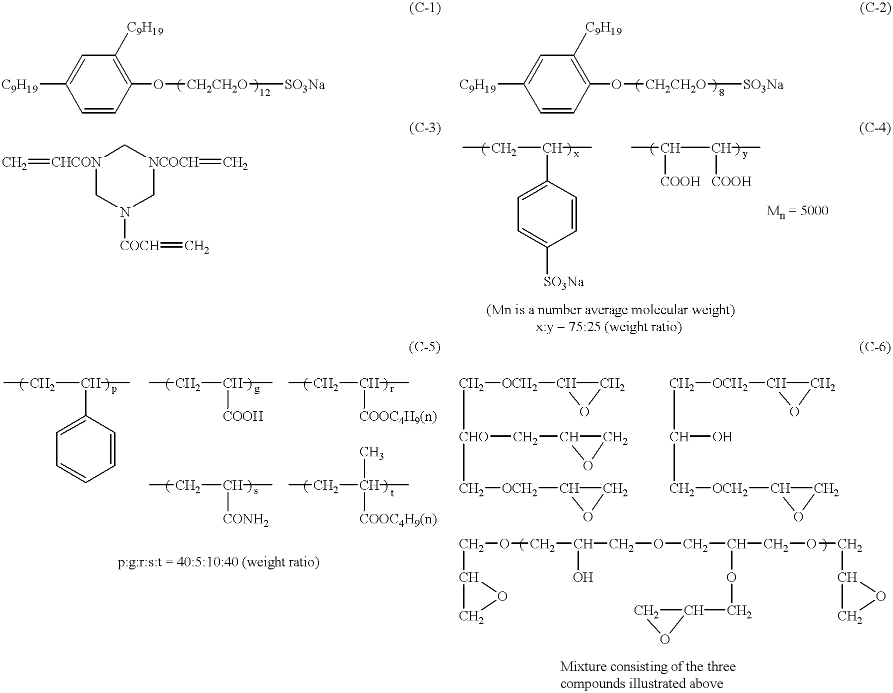

### Mixture Consisting of the Three Compounds Illustrated Above

Thermal Treatment of Support

In the subbing and drying process of the subbed support, the support was heated at 140° C. and then gradually cooled. The support was winded at a tension of 2 kg/cm².

Preparation of Silver Halide Emulsion A

In 900 ml of deionized water were dissolved 7.5 g of gelatin and 10 mg of potassium bromide. After adjusting the temperature and the pH to 35° C. and 3.0, respectively, 370 ml of an aqueous solution containing 74 g silver nitrate and an equimolar aqueous solution containing potassium bromide, potassium iodide, 1×10⁻⁶ mol/mol Ag of [Ir(NO)Cl₅] and 1×10⁻⁶ mol/mol Ag of rhodium chloride were added over a period of 10 minutes by the controlled double-jet method, while the pAg was maintained at 7.7. Thereafter, 4-hydroxy-6-methyl-1,3,3a,7-tetraazaindene was added and the pH was adjusted to 5 using NaOH. There was obtained cubic silver iodobromide grains having an average grain size of 0.06 μm, a variation coefficient of the projection area equivalent diameter of 45%, and the proportion of the {100} face of 87%. The resulting emulsion was flocculated to remove soluble salts, employing a flocculating agent and after desalting, 0.1 g of phenoxyethanol was added and the pH and pAg were adjusted to 5.9 and 7.5, respectively. The emulsion was chemically sensitized with chloroauric acid, inorganic sulfur, thiourea dioxide and 2,3,4,56-pentafluorophenyldiphenylphosphine selenide to obtain silver halide emulsion A.

Preparation of Sodium Behenate Solution

In 945 ml water were dissolved 32.4 g of behenic acid, 9.9 g of arachidic acid and 5.6 g of stearic acid at 90° C. Then, after adding 98 ml of 1.5M aqueous sodium hydroxide solution with stirring and further adding 0.93 ml of concentrated nitric acid, the solution was cooled to a temperature of 55° C. and stirred for 30 min. to obtain an aqueous sodium behenate solution.

Preparation of Pre-formed Emulsion of Silver Behenate and Silver Halide Emulsion

To the aqueous sodium behenate solution described above was added 15.1 g of silver halide emulsion A. After adjusting the pH to 8.1 with aqueous sodium hydroxide, 147 ml of aqueous 1M silver nitrate solution was added thereto in 7 min and after stirring for 20 min., soluble salts were removed by ultrafiltration. Thus obtained silver behenate was comprised of monodisperse needle-like particles having an average long edge length of 0.8 μm. After forming flock of the dispersion, water was removed therefrom and then, washing and removal of water were repeated six times and finally, drying was conducted.

Preparation of Light-sensitive Emulsion containing Organic Silver Salt A

To a half of the thus prepared pre-formed emulsion were gradually added 544 g of methyl ethyl ketone solution of 17 wt % polyvinyl butyral (average molecular weight of 3,000) and 107 g of toluene. Further, the mixture was dispersed at 4,000 psi. After dispersion, organic silver salt particles were observed with an electron microscope. The silver salt was comprised of non-monodisperse particles having an average particle size was 0.7 μm and a dispersion degree of 60%. From electron microscopic observation of the organic silver salt after completion of coating and drying, it was confirmed that the silver salt was comprised of the same particles. To 240 g of this emulsion, 4.7 ml of a 0.01% calcium bromide methanol solution was added to obtain light sensitive emulsion A. As a result of electron microscopic observation of silver halide grains, no silver halide grain of not more than 0.01 μm was observed.

Preparation of Silver Halide Emulsion B

In 900 ml of deionized water were dissolved 7.5 g of gelatin and 10 mg of potassium bromide. After adjusting the temperature and the pH to 35° C. and 3.0, respectively, 370 ml of an aqueous solution containing 74 g silver nitrate and an equimolar aqueous solution containing potassium bromide, potassium iodide, 1×10⁻⁶ mol/mol Ag of [Ir(NO)Cl₅] and 1×10⁻⁶ mol/mol Ag of rhodium chloride were added over a period of 10 minutes by the controlled double-jet method, while the pAg was maintained at 7.7. Thereafter, 4-hydroxy-6-methyl-1,3,3a,7-tetraazaindene was added and the pH was adjusted to 5 using NaOH. There was obtained cubic silver iodobromide grains having an average grain size of 0.06 μm, a variation coefficient of the projection area equivalent diameter of 12%, and the proportion of the {100} face of 49%. The resulting emulsion was flocculated to remove soluble salts, employing a flocculating agent and after desalting, 0.1 g of phenoxyethanol was added and the pH and pAg were adjusted to 5.9 and 7.5, respectively. The emulsion was chemically sensitized with chloroauric acid, inorganic sulfur, thiourea dioxide and 2,3,4,5,6-pentafluorophenyldiphenylphosphine selenide to obtain silver halide emulsion B.

Preparation of Sodium Behenate Solution

In 945 ml water were dissolved 32.4 g of behenic acid, 9.9 g of arachidic acid and 5.6 g of stearic acid at 90° C. Then, after adding 98 ml of 1.5M aqueous sodium hydroxide solution with stirring and further adding 0.93 ml of concentrated nitric acid, the solution was cooled to a temperature of 55° C. and stirred for 30 min. to obtain an aqueous sodium behenate solution.

Preparation of Pre-formed Emulsion B of Silver Behenate and Silver Halide Emulsion B

To the aqueous sodium behenate solution obtained above was added 15.1 g of silver halide emulsion B. After adjusting the pH to 8.1 with aqueous sodium hydroxide, 147 ml of aqueous 1M silver nitrate solution was added thereto in 7 min and after stirring for 20 min., soluble salts were removed by ultrafiltration. Thus obtained silver behenate was comprised of monodisperse needle-like particles having an average long edge length of 0.8 μm. After forming flock of the dispersion, water was removed therefrom, then, washing and removal of water were repeated six times and finally, drying was conducted.

Preparation of Light-sensitive Emulsion containing Organic Silver Salt B

To a half of the thus prepared pre-formed emulsion were gradually added 544 g of methyl ethyl ketone solution of 17 wt % polyvinyl butyral (average molecular weight of 3,000) and 107 g of toluene. Further, the mixture was dispersed at 4,000 psi. After completing dispersion, the resulting organic silver salt particles were observed through electronmicrograph. As a result of measuring 300 particles with respect to particle diameter and thickness, 205 particles exhibited an aspect ratio (AR) of 3 or more and the organic silver salt was comprised of monodisperse tabular particles having a dispersion degree of 25% and an average diameter of 0.7 μm. From electron microscopic observation of the organic silver salt after completion of coating and drying, it was confirmed that the silver salt was comprised of the same particles. To 240 g of this emulsion, 3 ml of a 6% pyridinium bromide perbromide methanol solution was added to obtain light sensitive emulsion B. As a result of electron microscopic observation of silver halide grains, silver halide grain of not more than 0.01 μm was observed. Further, electron micrographs of silver halide grains were observed. As a result of measurement of 500 organic silver salt grains with respect to grain diameter, grains of 0.01 μm or less was 45% of the total number of silver halide grains.

Back Layer Coating

On the B-2 layer-side of the support which was subjected to an antistatic treatment, the following composition was coated using an extrusion coater so as to have a wet thickness of 30 μm and dried at 60° C. for 15 min.

| | | |
|---|---|---|
| Cellulose acetate-butylate | 15 | ml/m² |
| (10% methyl ethyl ketone solution) | | |
| Dye-A | 7 | mg/m² |
| Dye-B | 7 | mg/m² |

| | |
|---|---|
| | Dye-A |
| 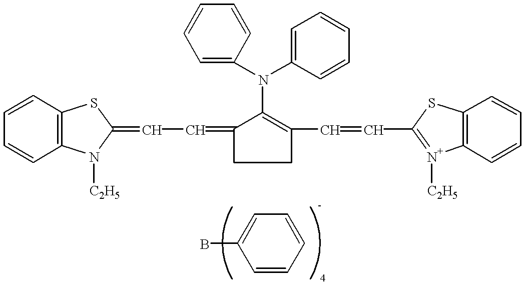 | |
| | Dye-B |
| 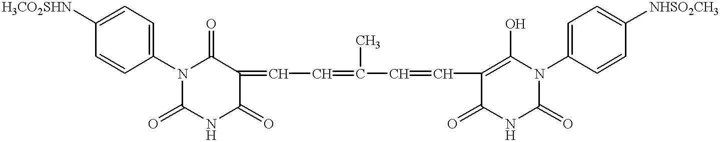 | |

| | | |
|---|---|---|
| Back-protective Layer Coating Solution | | |
| Cellulose acetate-butylate | 5 | ml/m² |
| (10% methyl ethyl ketone solution) | | |
| Matting agent: monodisperse silica | 15 | mg/m² |
| (having a monodisperse degree of 15% | | |
| and average size of 8 μm) | | |
| Fluorinated surfactant C₁₂F₂₅ (CH₂CH₂O)₁₀C₁₂H₂₅ | 10 | mg/m² |

Coating of the Image-forming Layer Side

Coating solutions of an image forming layer and a protective layer described below were each filtered using a filter of a semi-absolute filtration precision of 20 μm. On the sub-layer A-2 side of the support, the image forming layer having the following composition was coated by an extrusion coater at a coating speed of 70 m/min. so that the silver coverage was 1.5 g/m². Sample 101 was dried at 65° C. for 1 min. and Sample 102 was dried at 55° C. for 15 min. On Sample 101 was further coated a protective layer coating solution 1, and on Sample 102 was coated a protective layer coating solution 2.

| Image forming layer coating solution A | | |
|---|---|---|
| Light-sensitive emulsion A | 240 | g |
| Sensitizing dye (0.1% methanol solution) | 1.7 | ml |
| 2-(4-Chlorobenzoyl)-benzoic acid | 9.2 | ml |
| (12% methanol solution) | | |
| 2-Mercaptobenzimidazole | 11 | ml |
| (1% methanol solution) | | |
| O-25 | 0.4 | g |
| A-2 (20% methanol solution) | 29.5 | ml |
| Phthalazinone | 0.2 | g |
| 4-Methylphthalic acid | 0.25 | g |
| Tetrachlorophthalic acid | 0.2 | g |
| Hexamethylenediisocyanate | 1.2 | ml |
| (10% methanol solution) | | |
| Image forming layer coating solution B | | |
| Light-sensitive emulsion B | 240 | g |
| Sensitizing dye (0.1% methanol solution) | 1.7 | ml |
| 2-(4-Chlorobenzoyl)-benzoic acid | 9.2 | ml |
| (12% methanol solution) | | |
| 2 -Mercaptobenzimidazole | 11 | ml |
| (1% methanol solution) | | |
| Vinyl compound 1-5 | 0.5 | g |
| Hydrazine derivative H-1-4 | 0.5 | g |
| Quaternary onium compound P-17 | 0.1 | g |
| Compound 12 of formulas (1) and (2) | 0.5 | g |
| Acid anhydride 3-4 | 0.5 | g |
| O-25 | 0.4 | g |
| A-1 (20% methanol solution) | 29.5 | ml |
| Phthalazinone | 0.2 | g |
| 4-Methylphthalic acid | 0.25 | g |
| Tetrachlorophthalic acid | 0.2 | g |
| Hexamethylenediisocyanate | 1.2 | ml |
| (10% methanol solution) | | |
| Surface protective layer coating solution 1 | | |
| Acetone | 5 | ml/m² |
| Methyl ethyl ketone | 21 | ml/m² |
| Cellulose acetate | 2.3 | g/m² |
| Methanol | 7 | ml/m² |
| Phthalazine | 250 | mg/m² |
| Matting agent, monodisperse silica | 10 | mg/m² |
| having a mean size of 4 μm | | |
| Vinylsulfon compound VS-1 | 35 | mg/m² |
| Surfactant C₁₂F₂₅ (CH₂CH₂O)₁₀C₁₂F₂₅ | 10 | mg/m² |
| Surface protective layer coating solution 2 | | |
| Acetone | 5 | ml/m² |
| Methyl ethyl ketone | 21 | ml/m² |
| Cellulose acetate | 2.3 | g/m² |
| Methanol | 7 | ml/m² |
| Phthalazine | 250 | mg/m² |
| Colloidal silica | 50 | mg/m² |
| Matting agent, monodisperse silica | 10 | mg/m² |
| having a mean size of 3.5 μm | | |
| Vinylsulfon compound VS-1 | 35 | mg/m² |
| Surfactant C₁₂F₂₅ (CH₂CH₂O)₁₀C₁₂F₂₅ | 10 | mg/m² |
| C₈F₁₇—C₆H₄—SO₃Na | 10 | mg/m² |

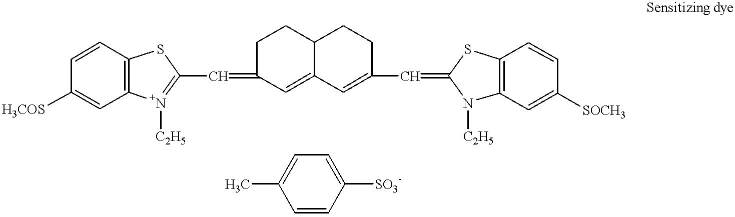

Vinylsulfone compound VS-1
CH₂═CHSO₂CH₂CH₂OCH₂CH₂SO₂CH═CH₂

Sample 101 and 102 were thus obtained, as shown in Table 1. The amount of solvent methyl ethyl ketone (also denoted as MEK) remaining in each sample was 70 mg/m². The Vickers hardness of the surface of the image forming layer-side of Sample 102 was 100; on the other hand, the Vickers hardness of the surface of the image forming layer-side of Sample 101 was 32.

The equilibrium moisture content was determined according to the following procedure. After allowed to stand in an atmosphere of 25° C. and 60% RH for 24 hrs., each sample film was cut to a size of 46.3 cm². After weighing, it was shredded to ca. 5 mm pieces and put into a vial; and after sealing with septum and aluminum cap, it was set into Head Space Sampler HP7694 (available from Hewlett Packard Corp.). After heating the Head Space Sampler at 120° C. for 20 min., the evaporated moisture was determined according to the Karl Fischer's method. The equilibrium moisture contents of Samples 101 and 102 were 6% and 0.7%, respectively.

Samples each were exposed from the image forming layer-side through an optical wedge to laser using an exposure apparatus having a light source in which a 780 nm semiconductor laser was made to longitudinally multiple modes using the high frequency superimposing method.

Determination of Sensitivity

Exposed samples were each subjected to thermal development in an oven for 20 or 25 sec. at 120° C. The thus developed samples were subjected to densitometry to determine sensitivity. The sensitivity was represented by the reciprocal of exposure giving a density of 2.5. The sensitivity obtained at 120° C. and 25 sec. was denoted as S₀, and the sensitivity obtained at 120° C. and 20 sec. was denoted as S₁₁ to calculate a value of log (S₀/S₁₁) according to the requirement (1).

Determination of Gamma value

Exposed samples were each subjected to thermal development in an oven for 20 or 25 sec. at 120° C. The thus developed samples were subjected to densitometry to determine a gamma value (γ) . The gamma value was represented by a slope of a straight line connecting densities of 0.1 and 2.5 on a characteristic curve. The gamma value obtained at 120° C. and 25 sec. was denoted as γ₀, and the gamma value obtained at 120° C. and 20 sec. was denoted as γ₁₁ to calculate a value of γ₁₁/γ₀ according to the requirement (2).

Determination of Maximum Density

Exposed samples were each subjected to thermal development in an oven for 20 or 25 sec. at 120° C. The thus developed samples were subjected to densitometry to determine the maximum density (Dmax). The maximum density obtained at 120° C. and 25 sec. was denoted as Dmax₀, and the maximum density obtained at 120° C. and 20 sec. was denoted as Dmax₁₁ to calculate a value of Dmax₁₁/Dmax₀ according to the requirement (3).

Test of Raw Stock Stability

Samples each were divided to two groups, one of them was allowed to stand under the condition at 23° C. and 50% RH for a period of 3 days, and the other one was allowed to stand in an incubator at a high temperature of 55° C. and a high humidity of 80% RH for a period of 3 days. Thereafter, the image forming layer-side of each of the thus aged samples was exposed through an optical wedge to laser using an exposure apparatus having a light source in which a 780 nm semiconductor laser was made to longitudinally multiple modes using the high frequency superimposing method.

Exposed samples were each thermally developed at 121° C. for 20 sec. using thermal processor for dry film used in printing plate-making, Dry View Processor 2771 available from Kodak Polychrome Graphics Corp. This processor was a plane-transport type thermal processor having a pre-heating section at 110° C., in which the total time of from the time the top of a sample entered the processor to the time it came out was 48 sec. The thus processed samples were each subjected to densitometry to determine sensitivity. The sensitivity was represented by a logarithm of a reciprocal of exposure giving a density of 2.5. The sensitivity of a sample aged at 23° C. and 50% RH for 3 days was denoted as S₁₀₁ the sensitivity of a sample aged in the incubator at a high temperature of 55° C. and a high humidity of 80% RH was denoted as S₁₀₁ to determine a value of log (S₀₀/S₁₀₁). Storage stability is the best at this value of zero and a value farther from zero resulted in deteriorated storage stability.

Storage Stability after Processing

Processed samples were each divided to two groups and one of them was aged in an incubator at 40° C. and 60% RH for 5 days, while being exposed to light. The density variation after being aged with respect to the density of 3.5 before being aged was measured by a densitometer.

Evaluation of Black Spot

Unexposed areas of each of thermally developed samples were visually observed using a 100 power magnifier and evaluated with respect to black spots, based on the ranking of 1 to 5. No black spot observed was ranked as “5” and as the number of black spots increases, evaluation was made as rank 4, 3, 2 and 1. Ranks of 3 or less is unacceptable levels in practical use.

Evaluation results are shown in Table 1.

TABLE 1

| | | | | | | | | Storage | | |
|---|---|---|---|---|---|---|---|---|---|---|
| | Image | | Log | | | | Raw | Stability | | |
| Sample | Forming | Protective | (S₀/ | γ₁₁/ | γ₂₁/ | Dmax₁₁/ | Stock | After | Black | |
| No. | Layer | Layer | S₁₁) | γ₀ | γ₀ | Dmax₀ | Stability | Processing | Spot | Remark |
| 101 | A | 1 | 1.5 | 0.6 | 0.6 | 0.7 | 0.8 | 0.9 | 2 | Comp. |
| 102 | B | 2 | 0.5 | 0.9 | 0.9 | 0.95 | 0.05 | 0.1 | 5 | Inv. |

As can be seen from Table 1, the inventive sample was proved to be superior to the comparative sample.

### Example 2

Preparation of Silver Halide Emulsion C

In 700 ml of water were dissolved 22 g of phthalated gelatin and 30 mg of potassium bromide. After adjusting the temperature and the pH to 40° C. and 5.0, respectively, 159 ml of an aqueous solution containing 18.6 g silver nitrate and 159 ml of an aqueous equimolar potassium bromide solution were added by the controlled double jet addition in 10 min. Then, an aqueous silver nitrate solution and an aqueous solution containing 8×10⁻⁶ mol/l of K₃[IrCl₆] and 1 mol/l of potassium bromide were added by the double jet addition in 15 min. Thereafter, the pH and pAg were adjusted to 5.9 and 8.0, respectively. There were obtained non-monodisperse, cubic silver halide grains having an average grain size of 0.08 μm, a variation coefficient of the projection area equivalent diameter of 45%, and the proportion of the {100} face of 40%.

The thus obtained silver halide grain emulsion was heated to 60° C. and ripened with 8.5×10⁻⁵ mol of sodium thiosulfate, 1×10⁻⁵ mol of 2,3,4,5,6-pentafluorophenyldiphenyl-phosphine selenide, 1×10⁻⁶ mol of tellurium compound-1 and 3.3×10⁻⁶ mol of chloroauric acid and 2.3×10⁻⁴ mol thiocyanic acid, each per mol of silver. Thereafter, the temperature was lowered to 50° C., then, 8×10⁻⁴ mol/mol Ag of sensitizing dye C was added thereto with stirring. Subsequently was added thereto potassium iodide of 3.5×10⁻² mol, based on silver and after stirring for 30 min., the emulsion was cooled to 30° C. to obtain silver halide grain emulsion C.

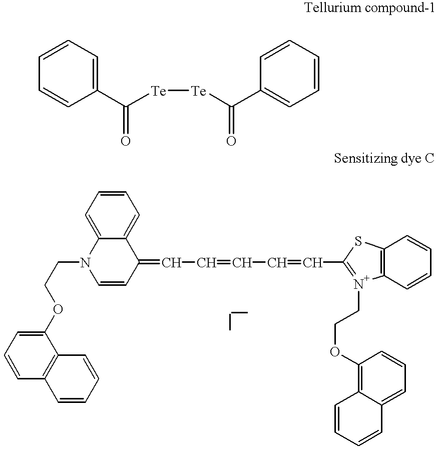

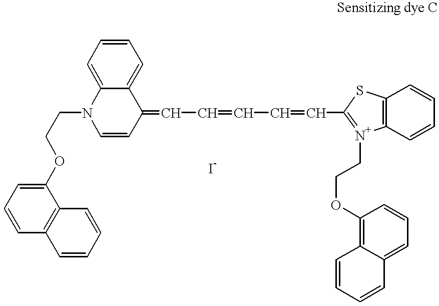

Preparation of Microcrystalline Organic Silver Salt Dispersion C

Behenic acid of 40 g, stearic acid of 7.3 g were Stirred with 500 ml water at 90° C. for 15 min. and 187 ml of an aqueous 1N sodium hydroxide solution was added thereto in 15 min., then, 61 ml of an aqueous 1N silver nitrate solution was further added, and the temperature was lowered to 50° C. Subsequently, 124 ml of an aqueous 1N silver nitrate solution was added thereto and further stirred for 5 min. The solid product was filtered using a suction funnel and then subjected to water washing until the conductivity of the filtrate reached 30 μS/cm. The thus obtained solid was treated in a wet cake form, without being dried. To the wet cake equivalent to 34.8 g of dried solid, 120 g of polyvinyl alcohol and 150 ml water were added with stirring to form slurry. The slurry was added into a vessel together with 840 g of zirconia beads having an average diameter of 0.5 mm and dispersed for 5 hrs. by a dispersing machine (¼ Sand Grinder Mill, available from IMEX Co. Ltd.) in 30 min. to obtain an microcrystalline organic silver salt dispersion, which was comprised of non-monodisperse organic silver salt microcrystals exhibiting a volume-averaged size of 1.6 μm and a dispersion degree of 55%. The particle size was measured using Master Saizer X, available from Malvern Instrument Co., Ltd.

Preparation of Silver Halide Emulsion D

In 700 ml of water were dissolved 22 g of phthalated gelatin and 30 mg of potassium bromide. After adjusting the temperature and the pH to 40° C. and 5.0, respectively, 159 ml of an aqueous solution containing 18.6 g silver nitrate and 159 ml of an aqueous equimolar potassium bromide solution were added by the controlled double jet addition in 10 min, while the pAg was maintained at 7.7. Then, an aqueous silver nitrate solution and an aqueous solution containing 8×10⁻⁶ mol/l of K₃[IrCl₆] and 1 mol/l of potassium bromide were added by the double jet addition in 30 min, while the pAg was maintained at 7.7. Thereafter, the pH and pAg were adjusted to 5.9 and 8.0, respectively. There were obtained monodisperse, cubic silver halide grains having an average grain size of 0.07 μm, a dispersion degree of 15%, and the proportion of the {100} face of 85%. The thus obtained silver halide grain emulsion was heated to 60° C. and ripened in 120 min. by adding 8.5×10⁻⁵ mol of sodium thiosulfate, 1.1×10⁻⁵ mol of 2,3,4,5,6-pentafluorophenyldiphenyl-phosphine selenide, 1×10⁻⁶ mol of tellurium compound-1 and 3.3×10⁻⁶ mol of chloroauric acid and 2.3×10⁻⁴ mol thiocyanic acid, each per mol of silver. Thereafter, the temperature was lowered to 50° C., then, 8×10⁻⁴ mol/mol Ag of sensitizing dye C was added thereto with stirring. Subsequently was added thereto potassium iodide of 3.5×10⁻² mol, based on silver and after stirring for 30 min., the emulsion was cooled to 30° C. to obtain silver halide grain emulsion D.

Preparation of Microcrystalline Organic Silver Salt

Dispersion D

Behenic acid of 40 g, stearic acid of 7.3 g were stirred with 500 ml water at 90° C. for 15 min. and 187 ml of an aqueous 1N sodium hydroxide solution was added thereto in 15 min., then, 61 ml of an aqueous 1N silver nitrate solution was further added, and the temperature was lowered to 50° C. Subsequently, 124 ml of an aqueous 1N silver nitrate solution was added thereto and further stirred for 30 min. The solid product was filtered using a suction funnel and then subjected to water washing until the conductivity of the filtrate reached 30 μS/cm. The thus obtained solid was treated in a wet cake form, without being dried. To the wet cake equivalent to 34.8 g of dried solid, 120 g of polyvinyl alcohol and 150 ml water were added with stirring to form slurry. The slurry was added into a vessel together with 840 g of zirconia beads having an average diameter of 0.5 mm and dispersed for 5 hrs. by a dispersing machine (¼ Sand Grinder Mill, available from IMEX Co. Ltd.) in 30 min. to obtain an organic silver salt microcrystal dispersion D, which was comprised of non-monodisperse organic silver salt microcrystals exhibiting a volume-averaged size of 1.2 μm and a dispersion degree of 20%. The particle size was measured using Master Saizer X, available from Malvern Instrument Co., Ltd. To this dispersion, 3 ml of a 6% phenylbromide perbromide methanol solution was added to obtain light sensitive emulsion A. As a result of electron microscopic observation of silver halide grains, no silver halide grain of not more than 0.01 μm was observed.

Preparation of Fine Solid Particle Dispersion of Materials

A fine solid particle dispersion of tetrachlorophthalic acid, 4-methylphthalic acid, 1,1-bis(2-hydroxy-3,5-dimethylphenyl)-3,5,5-trimethylhexane, phthalazine or tribromomethylsulfonylbenzene was prepared. Thus, to 5.4 g of tetrachlorophthalic acid were added 0.81 g f hydroxypropylcellulose and 94.2 ml water with stirring and was allowed to stand in the form of a slurry for 10 hrs. Thereafter, 100 ml of zircinia beads having an average diameter of 0.5 mm was added together with the slurry to the vessel and dispersed in 5 hrs. the same type dispersing apparatus as used in the preparation of the silver salt microcrystal dispersion to obtain a tetrachlorophthalic acid microcrytal dispersion, in which 70 wt % of the fine solid particles exhibited a size of 1.0 μm or less. With regard to other materials, solid particle dispersions were obtained in a similar manner, provided that the amount of a surfactant and the dispersing time were optimally varied to obtain an intended average particle size.

Image forming layer coating solution C

To the thus prepared organic silver salt microcrystal dispersion were added the following additives to prepare a coating solution (C) for an image forming layer.

| | | |
|---|---|---|
| Organic silver salt microcrystalline dispersion | 1 | mole |
| Silver halide emulsion C | 0.05 | mole |
| Binder: SBR latex (LACSTAR 3307B* available | 430 | g |
| from DAINIPPON INK Co., Ltd) | | |
| Tetrachlorophthalic acid | 5 | g |
| 1,1-Bis(2-hydroxy-3,5-dimethylphenyl)- | 98 | g |
| 3,5,5-trimethylhexane | | |
| Phthalazine | 9.0 | g |
| Tribromomethylphenylsulfone | 12 | g |
| 4-Methylphthalic acid | 7 | g |
| Vinyl compound 8-3 | 8 | g |
| Hydrazine derivative H-6 | 5 | g |

*: LACSTAR 3307B is a latex of styrene-butadiene copolymer, the average dispersed particle size being 0.1 to 0.15 μm and the equilibrium moisture content of the polymer being 0.6% at 25° C. and 60% RH.

Image forming layer coating solution D

To the thus prepared microcrystalline organic silver salt dispersion were added the following additives to prepare a coating solution (D) for an image forming layer.

| | | |
|---|---|---|
| Organic silver salt microcrystalline dispersion | 1 | mole |
| Silver halide emulsion D | 0.05 | mole |
| Binder: SBR latex (LACSTAR 3307B* available | 430 | g |
| from DAINIPPON INK Co., Ltd) | | |
| Tetrachlorophthalic acid | 5 | g |
| 1,1-Bis(2-hydroxy-3,5-dimethylphenyl)- | 98 | g |
| 3,5,5-trimethylhexane | | |
| Phthalazine | 9.0 | g |
| Tribromomethylphenylsulfone | 12 | g |
| 4-Methylphthalic acid | 7 | g |
| Vinyl compound 8-3 | 8 | g |
| Hydrazine derivative H-6 | 5 | g |

Surface protective layer coating solution 3

To inert gelatin, the following components were added to prepare a coating solution (3) for a surface protective layer.

| | | |
|---|---|---|
| Inert gelatin | 10 | g |
| Surfactant A | 0.26 | g |
| Surfactant B | 0.09 | g |
| Fine silica particles (av. size 2.5 μm) | 0.1 | g |
| 1,2-(Bisvinylsulfonamido)ethane | 0.1 | g |
| Water | 65 | g |

Surface protective layer coating solution 4

To inert gelatin, the following components were added to prepare a coating solution (4) for a surface protective layer.

| | | |
|---|---|---|
| Inert gelatin | 10 | g |
| Surfactant A | 0.26 | g |
| Surfactant B | 0.09 | g |
| Fine silica particles (av. size 2.5 μm) | 0.9 | g |
| Colloidal silica | 0.5 | g |
| 1,2-(Bisvinylsulfonamido)ethane | 0.5 | g |
| Water | 64 | g |

Back layer coating solution

To polyvinyl alcohol, the following components were added to prepare a coating solution for a back layer.

| | |
|---|---|
| Polyvinyl alcohol | 30 g |
| Dye C | 5 g |
| Water | 250 g |
| SILDEX H121 (spherical silica having | 1.8 g |
| average size of 12 μm, available from | |
| DOKAI KAGAKU Co., Ltd.) | |

| | |
|---|---|
| | Surfactant A |
| 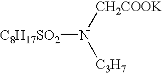 | |
| | Surfactant B |
| 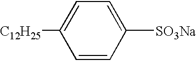 | |
| | Dye-C |
| 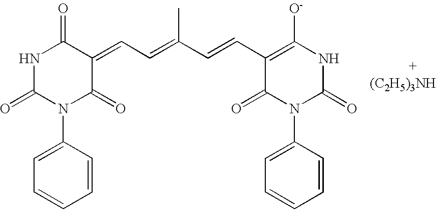 | |

The thus prepared coating solutions of the image forming layer were each filtered using a filter of a semi-absolute filtration precision of 20 μm. The coating solution for the image forming layer was coated on a polyethylene terephthalate support so as to have a silver coverage of 1.6 g/m². Further thereon, the protective layer coating solutions 3 and 4 were coated so as to have a gelatin coating amount of 1.8 g/m². Sample 201 was dried at a temperature of 55° C. for 1 min. and Sample 202 was dried at 65° C. for 20 min. After completion of drying, the coating solution for the back layer was coated on the opposite side of the support to the image forming layer so as to exhibit an optical density of 0.7 at 780 nm. Samples 201 and 202 were thus obtained, as shown in Table 2. The Vickers hardness of the surface of the image forming layer side was 110.

After coating and drying, silver halide grains in each sample were observed by an electron microscope. As a result of electron microscopic observation of 500 silver halide grains, no grains of 0.01 μm or less was observed in Sample 201. Silver halide grains of not more than 0.01 μm was observed in Sample 202 and grains of 0.01 μm or less was 50% of the total number of silver halide grains.

Samples were each evaluated in the same manner as in Example 1 and the results thereof are shown in Table 2. Samples were each subjected to scanning exposure through an optical wedge using an exposure apparatus, in which exposure was made at an angle of 80° between a 780 nm semiconductor laser beam and the photothermographic material surface.

Determination of Sensitivity

Exposed samples were each subjected to thermal development in an oven for 25 sec. at 120° C., or for 25 sec. at 118° C. The thus developed samples were subjected to densitometry to determine sensitivity. The sensitivity was represented by the reciprocal of exposure giving a density of 2.5. The sensitivity obtained at 120° C. and 25 sec. was denoted as S₀, and the sensitivity obtained at 118° C. and 25 sec. was denoted as S₂₁ to calculate a value of log (S₀/S₂₁) according to the requirement (4).

Determination of Gamma Value

Exposed samples were each subjected to thermal development in an oven for 25 sec. at 120° C., or for 25 sec. at 118° C. The thus developed samples were subjected to densitometry to determine a gamma value (γ) . The gamma value was represented by a slope of a straight line connecting densities of 0.1 and 2.5 on a characteristic curve. The gamma value obtained at 120° C. and 25 sec. was denoted as γ₀, and the gamma value obtained at 118° C. and 25 sec. was denoted as γ₂₁ to calculate a value of γ₂₁/γ₀ according to the requirement (5).

Determination of Maximum Density

Exposed samples were each subjected to thermal development in an oven for 25 sec at 120° C., or for 25 sec. at 118° C. The thus developed samples were subjected to densitometry to determine the maximum density (Dmax). The maximum density obtained at 120° C. and 25 sec. was denoted as Dmax₀, and the maximum density obtained at 120° C. and 20 sec. was denoted as Dmax₂₁ to calculate a value of Dmax₁₁/Dmax₀ according to the requirement (6).

TABLE 2

| | | | | | | | Storage | | |
|---|---|---|---|---|---|---|---|---|---|
| | Image | Pro- | | | | Raw | Stability | | |
| Sample | Forming | tective | Log | γ₂₁/ | Dmax₁₁/ | Stock | After | Black | |
| No. | Layer | Layer | (S₀/S₁₁) | γ₀ | Dmax₀ | Stability | Processing | Spot | Remark |
| 201 | C | 3 | 1.8 | 0.5 | 0.6 | 0.75 | 0.8 | 2 | Comp. |
| 202 | D | 4 | 0.6 | 0.9 | 0.95 | 0.05 | 0.1 | 4 | Inv. |

As can be seen from Table 2, inventive Sample 202 exhibited superior results, as compared to comparative Sample 201.

### Example 3

Samples 301 and 302 were prepared in the same manner as in Sample 201 and 202 of Example 2, except that a subbed support and a surface protective layer were varied as below. The thus prepared samples were evaluated in the same manner as in Example 2.

Preparation of PET Support

(1) Support

Using terephthalic acid and ethylene glycol was obtained polyethylene terephthalate (PET) of IV=0.66 (which was measured at 25° C. in phenol/tetrachloroethylene=6/4 by weight). After being dried at 130° C., PET pellets were melted at 300° C., extruded through T-type die and immediately thereafter cooled to prepare unstretched film. Using rolls different in circumferential speed, the film is longitudinally stretched to 3.3 times and then laterally stretched to 4.5 times by means of a tenter, in which the temperature was 110° C. and 130° C., respectively. Thereafter, the stretched film was thermally fixed at 240° C. for 20 sec. and then subjected to relaxation in the lateral direction to 4%. Then, after the portion corresponding to the tenter chuck section was slitted and both edge portions were subjected to a knurling treatment and winded at 4.8 kg/cm². There was thus obtained a 2.4 m width, 800 m long and 125 μm thick PET film.

| | | |
|---|---|---|
| (2) Sublayer (a) | | |
| Polymer latex; styrene/butadiene/hydroxy | 160 | mg/m² |
| ethylmethacrylate/divinylbenzene = | | |
| 67/30/2.5/0.5 (by wt %) | | |
| 2,4-Dichloro-6-hydroxy-s-triazine | 4 | mg/m² |
| Matting agent (polystyrene, av. particle | 3 | mg/m² |
| size of 2.4 μm) | | |
| Sublayer (b) | | |
| Alkali-processed gelatin (Ca⁺⁺ content of | 50 | mg/m² |
| 300 ppm, gelly strength of 230 g) | | |
| Compound C in an amount giving a density of 0.7 at | 780 | nm |
| Compound C | | |
| 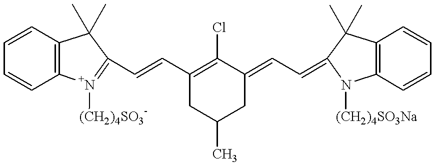 | | |
| (3) Conductive layer | | |
| Julymer ET-410 (available from NIPPON | 38 | mg/m² |
| JUNYAKU CO., Ltd.) | | |
| SnO²/Sb (9/1 by weight, av. | 120 | mg/m² |
| particle size of 0.25 μm) | | |
| Matting agent (polymethyl methacrylate | 7 | mg/m² |
| av. particle size of 5 μm) | | |
| Melamine | 13 | mg/m² |
| (4) Protective layer | | |
| Chemipearl S-120 (available from | 500 | mg/m² |
| Mitsui Petrochemical Industries Ltd.) | | |
| Snowtex-C (available from Nissan | 40 | mg/m² |
| Chemical Industries Ltd.) | | |
| Denacol EX-614B (available from | 30 | mg/m² |
| Nagase Kasei Kogyo Co., Ltd.) | | |

On both sides of the support, sublayer (a) and sublayer (b) were coated in this order and dried at 180° C. for 4 min. On one side thereof, the conductive layer and the protective layer were coated in this order to obtain a PET support provided with backing/subbing layers. The thus prepared PET support was entered into a heat-treatment zone of total length of 200 m and set to a temperature of 200° C. and transported at a tension of 3 kg/cm² and a transport speed of 20 m/min, then, was allowed to pass through a zone at 40° C. for 15 sec. and wound at a tension of 10 kg/cm².

Preparation of Surface Protective Layer Coating Solution 5

To 500 g of a 40% polymer latex (copolymer of methyl methacrylate/styrene/2-ethylhexylacrylate/2-hydroxyethyl methacrylate/methacrylic acid=59/9/26/5/1), 262 g H₂O was added, then, 14 g of benzyl alcohol as a film-making aid, 2.5 g of compound D, 2.5 g of Cellosol 524 (available from CHUKYO YUSHI Co. Ltd.), 12 g of compound E, 1 g of compound F, 2 g of compound G, 7.5 g of compound H and 0.5 g of fine polymethyl methacrylate particles of an average size of 3 μm, as a matting agent were successively added thereto and water was added to make the total amount of 1,000 g. There was thus obtained a coating solution exhibiting a viscosity of 5 cp (at 25° C.) and a pH of 4.5 (at 25° C.).

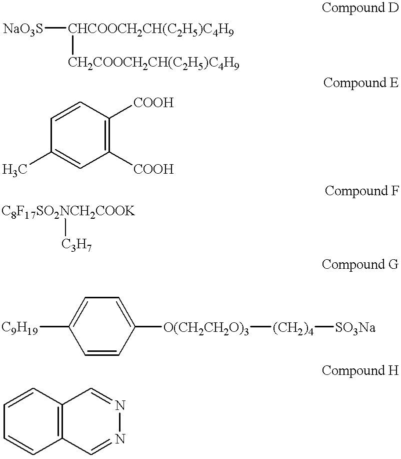

Preparation of Surface Protective Layer Coating Solution 6

To 500 g of a 40% polymer latex (copolymer of methyl methacrylate/styrene/2-ethylhexylacrylate/2-hydroxyethyl methacrylate/methacrylic acid=59/9/26/5/1), 262 g H₂O was added, then, 14 g of benzyl alcohol as a film-making aid, 2.5 g of compound D, 2.5 g of Cellosol 524 (available from CHUKYO YUSHI Co. Ltd.), 12 g of compound E, 1 g of compound F, 2 g of compound G, 7.5 g of compound H, 3.4 g of fine polymethyl methacrylate particles of an average size of 3 μm, as a matting agent and 1 g of colloidal silica were successively added thereto and water was added to make the total amount of 1,000 g. There was thus obtained a coating solution exhibiting a viscosity of 5 cp (at 25° C.) and a pH of 3.4 (at 25° C.)

Preparation of Photothermographic Material

On the subbed/backed PET support, the image forming layer used in Example 2 was coated so as to have a silver coverage of 1.6 g/m². Further thereon, the protective layer coating solutions 5 and 6 were each coated so as to have a coating amount of 2.0 g/m² to obtain Samples 301 and 302, respectively. Samples were evaluated in the same manner as in Example 1. Results thereof are shown in Table 3.

TABLE 3

| | | | | | | | | Storage | | |
|---|---|---|---|---|---|---|---|---|---|---|
| | Image | | Log | | | | Raw | Stability | | |
| Sample | Forming | Protective | (S₀/ | γ₁₁/ | γ₂₁/ | Dmax₁₁/ | Stock | After | Black | |
| No. | Layer | Layer | S₁₁) | γ₀ | γ₀ | Dmax₀ | Stability | Processing | Spot | Remark |
| 301 | C | 5 | 1.7 | 0.6 | 0.5 | 0.65 | 0.65 | 0.7 | 2 | Comp. |
| 302 | D | 6 | 0.5 | 0.9 | 0.9 | 0.95 | 0.04 | 0.1 | 5 | Inv. |

As can be seen from Table 3, Sample 302 exhibited superior results, compared to Sample 301.

### Example 4

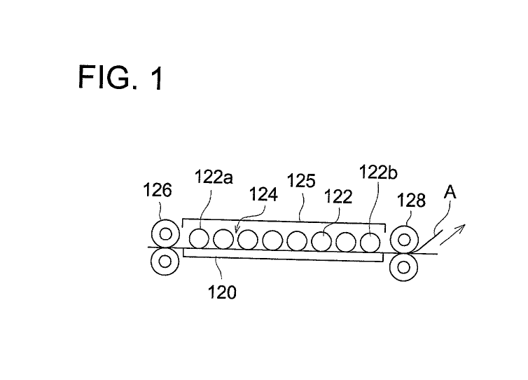

Samples 101 and 102 used in Example 1 were processed similarly to Example 1, provided that an automatic thermal processor shown in FIG. 1 was employed. Results thereof are shown in Table 4.

As shown in FIG. 1, the processor is provided with plate heater 120 comprised of a flocked stainless steel plate as a heating body heated to a temperature necessary to process photothermographic material sheet A, transport means 126 for move (or slide) the sheet A relative to the plate heater 120, while the sheet is brought into contact with the plate heater 120, and pressing rollers 122 as a means for pressing the back side of the sheet A to the surface in contact with the plate heater 120. The plate heater is a planar plate heater. Thus, the plate heater 120 is a planar heating member to maintain the photothermographic material at a developing temperature, in which nichrome wires are internally installed in a planar form. The photothermographic material, after exposed, is introduced to processor 18 via supply roller pair 126 driven by a driving apparatus; then, the sheet A is allowed to pass through between the pressing rollers 122 of silicone rubber and plate heater 120 by driving transport of the supply roller pair 126 to be thermally processed therein, wherein 122a and 122b are the front and rear rollers, respectively, and 125 is a heat insulating cover. The thermally processed photothermographic material sheet A is discharged through paired discharge rollers 128. To prevent abrasion marks, the back-side of the photothermographic material sheet is brought into contact with the plate heater 120. The pressing rollers 122 are brought into contact with the other side thereof and arranged at a given pitch over a whole length of the plate heater 120 in the transporting direction, with spacing of less than the sheet thickness to form a sheet transport route 124 with the pressing rollers 122 and plate heater 120. On the both ends of the sheet transport route 124, a pair of supply rollers 126 and a pair of discharge rollers 128 are arranged as means for transporting the photothermographic material. These are covered with a heat-insulating cover 125.

TABLE 4

| | | | | | | | | Storage | | |
|---|---|---|---|---|---|---|---|---|---|---|
| | Image | | Log | | | | Raw | Stability | | |
| Sample | Forming | Protective | (S₀/ | γ₁₁/ | γ₂₁/ | Dmax₁₁/ | Stock | After | Black | |
| No. | Layer | Layer | S₁₁) | γ₀ | γ₀ | Dmax₀ | Stability | Processing | Spot | Remark |
| 101 | A | 1 | 1.3 | 0.6 | 0.5 | 0.6 | 0.7 | 0.8 | 2 | Comp. |
| 102 | B | 2 | 0.5 | 0.9 | 0.9 | 0.95 | 0.05 | 0.1 | 5 | Inv. |

As can be seen from Table 4, Sample 102 exhibited superior results, compared to Sample 101.

### Example 5

Preparation of a Subbed PET Support

Both surfaces of a biaxially stretched, thermally fixed 125 μm PET film (commercially available from Teijin Co., Ltd.) were subjected to plasma discharging. Onto the surface of one side, the subbing coating composition a-1 descried below was applied so as to form a dried layer thickness of 0.8 μm, which was then dried. The resulting coating was designated Subbing Layer A-1. Onto the opposite surface, the subbing coating composition b-2 described below was applied to form a dried layer thickness of 0.8 μm. The resulting coating was designated Antistatic Subbing Layer B-2.

Plasma Treatment Condition

Using a batch type, atmospheric plasma treatment apparatus (AP-I-H-340, available from E.C. Chemicals Co., Ltd.), plasma treatment 1 and plasma treatment 2 were each conducted at a high frequency output of 4.5 kW, frequency of 5 kHz for a treatment time of 5 sec. in atmosphere of argon, nitrogen and hydrogen (volume ratio 90:5:5).

Subbing Coating Composition a-1

| | | |
|---|---|---|
| Latex solution (solid 30%) of | 270 | g |
| a copolymer consisting of butyl acrylate | | |
| (30 weight %), t-butyl acrylate (20 weight %) | | |
| styrene (25 weight %) and 2-hydroxy | | |
| ethyl acrylate (25 weight %) | | |
| (C-1) | 0.6 | g |
| Hexamethylene-1,6-bis(ethyleneurea) | 0.8 | g |
| Polystyrene fine particles (av. size, 3 μm) | 0.05 | g |
| Colloidal silica (av. particle size, 90 μm) | 0.1 | g |
| Water to make | 1 | liter |

Subbing Coating Composition b-1

| | | |
|---|---|---|
| SnO₂ (doped with 0.1% indium, av. Size 0.18 μm) | 0.26 | g/m² |
| Latex liquid (solid portion of 30%) | 270 | g |
| of a copolymer consisting of | | |
| butyl acrylate (30 weight %) | | |
| styrene (20 weight %) | | |
| glycidyl acrylate (40 weight %) | | |
| Hexamethylene-1,6-bis(ethyleneurea) | 0.8 | g |
| Water to make | 1 | liter |

Thermal Treatment of Support

The thus subbed support was heated qt 140° C. and then gradually cooled, while being transported under a tension of 1×10⁵ Pa.

Back Layer Coating

After being filtered with a filter semi-absolute filtration precision of 20 μm., on the B-2 layer-side of the support which was subjected to an antistatic treatment, Back layer coating solution (4) and backing protective layer coating solution (4) were coated using an extrusion coater so as to have a total wet thickness of 30 μm at a coating speed of 120 m/min. and dried at 60° C. for 4 min.

Back layer coating solution (4)

| | | |
|---|---|---|
| Methyl ethyl ketone | 16.4 | g/m² |
| Polyester rein (Vitel PE2200B, Bostic Co.) | 106 | mg/m² |
| Infrared Dye-C | 37 | mg/m² |
| Stabilizer B-1 (Sumilizer BPA, available | 20 | mg/m² |
| from SUMUTOMO KAGAKU Co., Ltd.) | | |
| Stabilizer B-2 (Tomisorb 77, available | 20 | mg/m² |
| from YOSHITOMI SEIYAKU Co. Ltd.) | | |
| Cellulose acetate-propyrate (CAP504-0.2, | 1.0 | g/m² |
| (available from Eastman Kodak Co.) | | |
| Cellulose acetate-butylate (CAB381-20, available | 1.0 | g/m² |
| from Eastman Kodak Co.) | | |

Backing protective layer coating solution (4)

| | | |
|---|---|---|
| Methyl ethyl ketone | 22 | g/m2 |
| Polyester resin (Vitel PE2200B, Bostic Co.) | 106 | mg/m² |
| Antistatic agent (CH₃)₃SiO—[(CH₃)₂SiO]₂₀— | 22 | g/m² |
| [CH₃SiO{CH₂CH₂O(CH₂CH₂O)₁₀ | | |
| (CH₂CH₂CH₂O)₁₅CH₃}]₃₀—Si(CH₃)₃ | | |
| Fluorinated surfactant F-1 C₈F₁₇SO₃Li | 10 | Mg/m² |
| Cellulose acetate-propyrate (CAP504-0.2, | 1.0 | g/m² |
| (available from Eastman Kodak Co.) | | |
| Cellulose acetate-butylate (CAB381-20, available | 1.0 | g/m² |
| from Eastman Kodak Co.) | | |
| Matting agent (SILOID 74, available from | 17 | mg/m² |
| Fuji Devison Co., av. 7 μm silica) | | |

Preparation of Silver Halide Emulsion E

| | | |
|---|---|---|
| Solution A1 | | |
| Phenyl carbamoyl gelatin | 88.3 | g |
| Compound (A) (10% methanol solution) | 10 | ml |
| Potassium bromide | 0.32 | g |
| Water to make | 5492 | ml |
| Solution B1 | | |
| 0.67 N Aqueous silver nitrate solution | 2635 | ml |
| Solution C1 | | |
| Potassium bromide | 51.55 | g |
| Potassium iodide | 1.47 | g |
| Water to make | 660 | ml |
| Solution D1 | | |
| Potassium bromide | 154.9 | g |
| Potassium iodide | 4.41 | g |
| Iridium chloride (1% solution) | 0.93 | ml |
| Solution E1 | | |
| 0.4 N Aqueous potassium bromide solution to control | | |
| silver electrode potential | | |
| Solution F1 | | |
| 56% Aqueous acetic acid solution | 16.0 | ml |
| Solution G1 | | |
| Anhydrous sodium carbonate | 1.72 | g |
| Water to make | 151 | ml |

Compound (A): HO(CH₂CH₂O)n[CH(CH₃)CH₂O]₁₇—(CH₂CH₂O)mH
m + n = 5 to 7

Using a stirring mixer described in JP-B No. 58-58288 and 58-58289, ¼ of solution BE and a total of solution C1 were simultaneously added to solution A1 for 4 min. 45 sec. to form nucleus grains, while maintaining the temperature at 45° C. and the pAg at 8.09. After 7 min, the remaining solution B1 and solution D1 were simultaneously added for 14 min. 15 sec., while maintaining the temperature at 45° C. and the pAg at 8.09. During addition, the pH of the reaction mixture was 5.6. After stirring for 5 min,., the temperature was lowered to 40° C. and a total of solution F1 was added thereto to cause the silver halide emulsion to coagulate. Leaving the coagulating portion of 2000 ml, the supernatant was removed and 10 lit. of water was added thereto. After being stirred, the silver halide emulsion was again coagulated. Leaving coagulating portion of 1500 ml, the supernatant was removed and 10 lit. of water was added thereto. After being stirred, the silver halide emulsion was again coagulated. Leaving coagulating portion of 1500 ml, the supernatant was removed, solution G1 was added, the temperature was elevated to 60° C. and stirring continued for 120 min. Finally, the pH was adjusted to 5.8 and water was added to make 1161 g per mol of silver. The thus prepared emulsion was comprised of monodisperse cubic silver iodobromide grains having an average size of 0.058 μm, a coefficient of variation of grain size of 12% and the (100) face proportion of 92%.

Further, the emulsion was chemically sensitized with sodium thiosulfate of 2×10⁻⁴ mol per mol of silver halide and then 4-hydroxy-6-methyl-1,3,3a,7-tetrazaindene was added thereto.

Preparation of Powdery Organic Silver Salt E

In 4720 ml water at 80° C. were dissolved 130.8 g of behenic acid, 67.7 g of arachidic acid 43.6 g of stearic acid and 2.3 g of palmitic cid. Further thereto was added 540.2 ml of aqueous 1.5M sodium hydroxide solution with stirring at a high-speed and after adding 6.9 ml of concentrated nitric acid, the mixture was cooled to 55° C. to obtain an aqueous fatty acid sodium salt solution. Then, 465 ml water and 31.7 g of the silver halide emulsion E were while the temperature was maintained at 55° C. and stirred for 5 min. Then, 760.6 ml of aqueous 1M silver nitrate solution was added in 2 min., and stirred for 10 min. to obtain an organic silver salt dispersion. The organic silver salt dispersion was put into a washing vessel and after adding deionized water and stirring, the mixture was allowed to stand, the organic silver salt dispersion was floated and the lower aqueous soluble salts were removed. The reaction mixture was filtered to remove soluble salts and washed with deionized water until the filtrate reached a conductivity of 2 μS/cm. After subjected to centrifugal dehydration, the reaction mixture was dries using a flush jet drier (available from SEISHIN KIGYO Co., Ltd.) at an inlet temperature of 75° C. until reached a moisture content of 0.1% to obtain powdery organic silver salt E. In this case, hot air prepared by heating atmospheric air with an electric heater was employed. The moisture content of the organic silver salt composition was measured by an infrared aquameter.

Preparation of Preliminary Dispersion E

Powdery polyvinyl butyral of 14.57 g (Butvar B-79, available from Monsanto Co.) was dissolved in 1457 g of methyl ethyl ketone (hereinafter, also denoted as MEK) and 500 g of powdery organic silver salt was gradually added with stirring dissolver DISPERMAT CA-40M type (available from VMA-GETZMANN Co.) to obtain preliminary dispersion E.

Preparation of Light Sensitive Emulsified Dispersion E

The preliminary dispersion (E) was supplied by a pump to a media type dispersing machine, DISPERMAT SL-C12EXtype (available from VMA-GETZMANN Co.) filled with zirconia beads 0.5 mm in diameter (Toreselam, available from Toray Co., Ltd.) in an amount of 80% of the internal volume and dispersed at a mil circumferential speed of 13 m/sec. and a retention time in the mill of 10 min. to obtain a light sensitive emulsion E. After completing dispersion, the resultant organic silver salt particles were organic silver salt grains with respect to particle size and thickness revealed that 205 grains exhibited an aspect ratio (AR) of 3 or more and the organic silver salt grains were monodisperse, exhibiting a degree of dispersion of 25% and an average grain diameter of 0.7 μm. After coating, the organic silver salt grains were also observed and identical grains were confirmed.

Preparation of Stabilizer Solution

Stabilizer 1 of 0.9 g and potassium acetate of 0.28 g were dissolved in 10.1 g of methanol to obtain stabilizer solution (1).

Preparation of Infrared Sensitizing Dye solution

Infrared sensitizing dye 1 of 29 mg, 4.5 g of 2-chloro-bebzoic acid, 8.4 g of stabilizer 2 and 280 mg of 5-methyl-2-mercaptobenzimidazole were dissolved in 260 g of MEK to obtain an infrared sensitizing dye solution.

Preparation of Additive Solution a-1

Reducing agent A-4 of 107 g, 4.8 g of 4-methylphthalic acid, 1 g of Compound 21 of formula (2) or (3) and 0.74 g of infrared dye C were dissolved in 260 g of MEK to obtain additive solution a-1.

Preparation of Additive Solution b-1

In 126 g of MEK, 11.6 g of antifoggant 2 and 10 g of acid anhydride 4-11 were dissolved to obtain additive solution b-1.

Preparation of Additive Solution c

In 204 g of MEK, 21 g of an alkoxysilane compound, ph—NH—(CH₂)—Si(OCH₃)₃, was dissolved to obtain additive solution c.

Preparation of Light Sensitive Layer Coating Solution E

The light sensitive emulsion E of 1641 g and 506 g of MEK were mixed and maintained at 21° C. with stirring and 10.75 g of antifoggant 1 (11.2% methanol solution) was added thereto and stirred for 1 hr. Further thereto, 13.6 g of calcium bromide (11.2% methanol solution) was added and stirred for 20 min. As a result of electron microscopic observation of silver halide grains, silver halide grains of less than 0.01 μm were observed. As a result of measurement of 500 organic silver salt grains, 45% by number of the total grains was accounted for by grains of less than 0.01 μm.

Subsequently, 11.3 g of stabilizer solution 1 was added and after being stirred for 10 min., 90.5 g of infrared sensitizing dye solution was added and stirred for 1 hr. Thereafter, the temperature was lowered to 13° C. and stirred for 30 min. Polyvinyl butyral of 349.6 g (Butvar B-79, available from Monsanto Co.) was added and stirred for 30 min., while maintaining the temperature at 13° C. Then, 95 mg of 5-methyl-2-mercaptobenzimidazole and 3.5 g of tetrachlorophthalic acid were added and stirred for 30 min. Thereafter, 1.2 g of 5-nitrpindazole, 0.4 g of 5-nitrobenzimidazole, 0.4 g of 5-nitobenzimidazole, 2.4 g of contrast-increasing agent 72-15 (vinyl compound), 1 g of contrast-increasing agent H-5-5 (hydrazine derivative) and 242 g of MEK were added. Further, 373.5 g of additive solution a-1, 148.6 g of additive solution b-1 and 225 g of additive solution c were successively added with stirring to obtain light sensitive layer coating solution E.

Preparation of Silver Halide Emulsion F

Similarly to silver halide emulsion E, polydidperse cubic silver iodobromide grain emulsion was prepared by the control of the pAg and pH, comprising grains having an average grain size of 0.07 μm, a variation coefficient of grain size of 45% and a (100) face proportion 45%. The thus prepared emulsion grains were chemically sensitized with sodium thiosulfate of 2×10⁻⁴ mol per mol of silver halide and 4-hydroxy06mehyl-1,3,3a,7-tetraindene was added to obtain light sensitive layer coating solution F.

Preparation of Powdery organic Silver Salt F

In 4720 ml water at 80° C. were dissolved 130.8 g of behenic acid, 67.7 g of arachidic acid 43.6 g of stearic acid and 2.3 g of palmitic cid. Further thereto was added 540.2 ml of aqueous 1.5M sodium hydroxide solution with stirring at a high-speed and after adding 6.9 ml of concentrated nitric acid, the mixture was cooled to 55° C. to obtain an aqueous fatty acid sodium salt solution. Then, 465 ml water and 31.7 g of the silver halide emulsion E were while the temperature was maintained at 55° C. and stirred for 5 min. Then, 760.6 ml of aqueous 1M silver nitrate solution was added in 2 min., and stirred for 10 min. to obtain an organic silver salt dispersion. The organic silver salt dispersion was put into a washing vessel and after adding deionized water and stirring, the mixture was allowed to stand, the organic silver salt dispersion was floated and the lower aqueous soluble salts were removed. The reaction mixture was filtered to remove soluble salts and washed with deionized water until the filtrate reached a conductivity of 2 μS/cm. After subjected to centrifugal dehydration, the reaction mixture was dries using a flush jet drier (available from SEISHIN KIGYO Co., Ltd.) at an inlet temperature of 75° C. until reached a moisture content of 0.3% to obtain powdery organic silver salt F. In this case, hot air prepared by heating atmospheric air with an electric heater was employed. The moisture content of the organic silver salt composition was measured by an infrared aquameter.

Preparation of Preliminary Dispersion F

Powdery polyvinyl butyral of 14.57 g (Butvar B-79, available from Monsanto Co.) was dissolved in 1457 g of methyl ethyl ketone (hereinafter, also denoted as MEK) and 500 g of powdery organic silver salt was gradually added with stirring dissolver DISPERMAT CA-40M type (available from VMA-GETZMANN Co.) to obtain preliminary dispersion F.

Preparation of Light Sensitive Emulsion F

The preliminary dispersion (E) was supplied by a pump to a media type dispersing machine, DISPERMAT SL-C12EXtype (available from VMA-GETZMANN Co.) filled with zirconia beads 0.5 mm in diameter (Toreselam, available from Toray Co., Ltd.) in an amount of 80% of the internal volume and dispersed at a nil circumferential speed of 13 m/sec. and a retention time in the mill of 10 min. to obtain a light sensitive emulsion F. After completing dispersion, the resultant organic silver salt particles were organic silver salt grains with respect to particle size and thickness revealed that 205 grains exhibited an aspect ratio (AR) of 3 or more and the organic silver salt grains were monodisperse, exhibiting a degree of dispersion of 25% and an average grain diameter of 0.7 μm. After coating, the organic silver salt grains were also observed and identical grains were confirmed.

Preparation of Stabilizer Solution

Stabilizer 1 of 0.9 g and potassium acetate of 0.28 g were dissolved in 10.1 g of methanol to obtain stabilizer solution (1).

Preparation of Infrared Sensitizing Dye solution

Infrared sensitizing dye 1 of 29 mg, 4.5 g of 2-chloro-bebzoic acid, 8.4 g of stabilizer 2 and 280 mg of 5-methyl-2-mercaptobenzimidazole were dissolved in 260 g of MEK to obtain an infrared sensitizing dye solution.

Preparation of Additive Solution a-2

Reducing agent A-4 of 107 g, 4.8 g of 4-methylphthalic acid, and 0.74 g of infrared dye were added to obtain additive solution a-2.

Preparation of Additive Solution b-2

In 136 g of MEK, 11.6 g of antifoggant 2 was dissolved to obtain additive solution b-2.

Preparation of Additive Solution c

In 204 g of MEK, 21 g of an alkoxysilne compound, ph—NH—(CH₂)—Si(OCH₃)₃, was dissolved to obtain additive solution c.

Preparation of Light sensitive Layer Coating Solution F

The light sensitive emulsion E of 1641 g and 526 g of MEK were mixed and maintained at 21° C. with stirring and 10.75 g of antifoggant 1 (11.2% methanol solution) was added thereto and stirred for 1 hr. Further thereto, 13.6 g of calcium bromide (11.2% methanol solution) was added and stirred for 20 min. As a result of electron microscopic observation of silver halide grains, silver halide grains of less than 0.01 μm were observed. As a result of measurement of 500 organic silver salt grains, 45% by number of the total grains was accounted for by grains of less than 0.01 μm.

Subsequently, 11.3 g of stabilizer solution 1 was added and after being stirred for 10 min., 90.5 g of infrared sensitizing dye solution was added and stirred for 1 hr. Thereafter, the temperature was lowered to 13° C. and stirred for 30 min. Polyvinyl butyral of 349.6 g (Butvar B-79, available from Monsanto Co.) was added and stirred for 30 min., while maintaining the temperature at 13° C. Then, 95 mg of 5-methyl-2-mercaptobenzimidazole and 3.5 g of tetrachlorophthalic acid were added and stirred for 30 min. Thereafter, 1.2 g of 5-nitrpindazole, 0.4 g of 5-nitrobenzimidazole, 0.4 g of 5-nitobenzimidazole, and 242 g of MEK were added. Further, 373.5 g of additive solution a-2, 148.6 g of additive solution b-2 and 225 g of additive solution c were successively added with stirring to obtain light sensitive layer coating solution F.

Preparation of Matting Agent Dispersion

Monodisperse silica having an average particle size of 6 μm, in an amount of 30 mg/m ² was added to 1.7 of MEK and dispersed with a dissolver type homogenizer at 8000 rpm for 30 min. to prepare a matting agent dispersion.

Preparation of Additive Solution d

Phthalazine of 0.17 g/m² was dissolved in MEK of 2.73 g/m² to prepare additive solution d.

Preparation of Surface protective layer Coating Solution 7

In 15.9 g/m² of MEK, 1.8 g of cellulose acetate-butylate (CAB171-15, available from Eastman Kodak Co.), 85 mg of polymethyl methacrylate (Paraloid A-21, available from Rohm & Haas Co.), 20 mg of benzotriazole, 13 mg of fluorinated surfactant F-1, 50 mg of fluorinated surfactant F-2, C₈F₁₂(CH₂CH₂O)₂₂C₈F₁₇, and 20 mg of silicone type antistatic agent AS-1, (CH₃)₃SiO—[(CH₃)₃SiO]₂₀—[CH₃SiO(CH₂CH₂CH₂O(CH₂CH₂O)₆(CH₂CH₂CH₂O)₆CH₂CH₂O)]₂₀—OSi(CH₃)₃, were dissolved. Further, 1.75 g of the matting agent dispersion and 2.9 g of additive solution d were successively added with stirring to obtain a surface protective layer coating solution.

Coating of Light Sensitive Layer Side

Viscosities of the light sensitive layer coating solution and surface protective layer coating solution were each adjusted to 0.228Pa·sec and 0.184 Pa·sec, respectively, by adjusting the amount of a solvent. The coating solution were each filtered with a filter of a semi-absolute filtration precision of 20 μm and simultaneously coated on sublayer A-2 of the support at a coating speed of 90 m/min., by extruding through a slit of an extrusion type die coater. In this case, the light sensitive layer coating solution and surface protective layer coating solution were coated in combination shown in Table 5. After 7 sec., drying was conducted for a period of 5 min., using hot air at a drying temperature of 75° C. and a dew point of 10° C. and reeled on a roll under a tension of 196 N/m (or 20 kg/m) in an atmosphere of 23° C. and 50% RH to obtain photothermographic material samples, as shown in Table 5. The silver coverage of the light sensitive layer was 1.5 g/m² and the dry thickness of the surface protective layer was 2.5 μm.

Sample 501 and 502 were thus obtained, as shown in Table 5. The amount of solvent methyl ethyl ketone (also denoted as MEK) remaining in each sample was 70 mg/m^{2.} The Vickers hardness of the surface of the image forming layer-side of Sample 501 was 100.

After allowed to stand in an atmosphere of 25° C. and 60% RH for 24 hrs., each sample film was cut to a size of 46.3 cm². After weighing, it was shredded to ca. 5 mm pieces and put into a vial; and after sealing with septum and aluminum cap, it was set into Head Space Sampler HP7694 (available from Hewlett Packard Corp.). After heating the Head Space Sampler at 120° C. for 20 min., the evaporated moisture was determined according to the Karl Fischer's method. The equilibrium moisture contents of Samples 501 and 502 were 0.7% and 6%, respectively.

Samples 501 and 502 were evaluated similarly to example 1, and the results thereof are shown in Table 5.

TABLE 5

| | | | | | | | | Storage | | |
|---|---|---|---|---|---|---|---|---|---|---|
| | Image | | Log | | | | Raw | Stability | | |
| Sample | Forming | Protective | (S₀/ | γ₁₁/ | γ₂₁/ | Dmax₁₁/ | Stock | After | Black | |
| No. | Layer | Layer | S₁₁) | γ₀ | γ₀ | Dmax₀ | Stability | Processing | Spot | Remark |
| 501 | B | 7 | 0.5 | 0.9 | 0.95 | 0.9 | 0.05 | 0.2 | 5 | Inv. |
| 502 | F | 8 | 1.5 | 0.5 | 0.65 | 0.6 | 0.8 | 0.95 | 2 | Comp. |

As can be seen from Table 5, inventive Sample 501 exhibited superior results, to comparative Sample 502.

### EFFECT OF THE INVENTION

According to this invention, there could be provided a photothermographic material improved in transport property in processing in an automatic processor, fogging after being processed and stability in variation of processing conditions, and an image forming process by use thereof. Disclosed embodiment can be varied by a skilled person without departing from the spirit and scope of the invention.

What is claimed is:

1. A photothermographic material comprising a support, a silver halide, an organic silver salt and a reducing agent, wherein the photothermographic material meets the following requirement:
γ₂₁/γ₀>0.7
wherein γ₀ is a gamma value obtained when the photographic material is subjected to thermal development at 120° C. for 25 sec., and γ₂₁ is a gamma value obtained when the photographic material is subjected to thermal development at 118° C. for 25 sec., provided that the gamma value is represented by a slope of a straight line connecting densities of 0.1 and 2.5 on a characteristic curve obtained when the photographic material is subjected to the thermal development.

2. The photothermographic material of claim 1, wherein the photothermographic material comprises an image forming layer, the image forming layer containing the silver halide and the organic silver salt.

3. The photothermographic material of claim 2, wherein the image forming layer contains the reducing agent.

4. The photothermographic material of claim 2, wherein the photothermographic material comprises a component layer adjacent to the image forming layer, the component layer containing the reducing layer.

5. The photothermographic material of claim 1, wherein the photothermographic material comprises a contrast-increasing agent.

6. The photothermographic material of claim 1, wherein the photothermographic material comprises an acid anhydride.

7. The photothermographic material of claim 1, wherein the photothermographic material comprises a compound represented by formula (1) or (2):
formula (1) 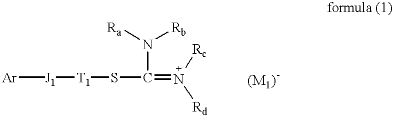
formula (2) 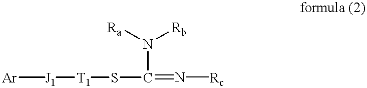
wherein Ar is an aromatic hydrocarbon group or an aromatic he terocyclic group; T₁ is a bivalent linkage group comprised of an aliphatic hydrocarbon group or a direct bond; J₁ is a bivalent linkage group containing at least one of an oxygen atom, a sulfur atom and a nitrogen atom or a direct bond; Ra, Rb, Rc and Rd are each a hydrogen atom, an acyl group, an aliphatic hydrocarbon group, an aryl group or a heterocyclic group, or in formula (1), Ra and Rb, Rc and Rd, Ra and Rc, or Rb and Rd combine with each other to form a nitrogen containing ring and in formula (2) Ra and Rb, Ra and Rc, or Rb and Rc combine with each other to form a nitrogen containing ring; (M₁)⁻represents an ion necessary to neutralize an intramolecular charge.

8. The photothermographic material of claim 1, wherein the photothermographic material exhibits an equilibrium moisture content of not more than 2% by weight.

9. The photothermographic material of claim 1, wherein the silver halide comprises silver halide grains having a grain size of less than 0.01 μm.

10. The photothermographic material of claim 1, wherein the organic silver salt is comprised of grains exhibiting an average grain diameter of not more than 2 μm.

11. The photothermographic material of claim 1, wherein the organic silver salt is comprised of monodisperse grains.

12. The photothermographic material of claim 1, wherein the organic silver salt is comprised of tabular grains.

13. The photothermographic material of claim 1, wherein the photothermographic material meets the following requirement:
log(S₀/S₁₁)<0.7
wherein S₀ is a sensitivity obtained when the photographic material is subjected to thermal development at 120° C. for 25 sec., and S₁₁ is a sensitivity obtained when the photographic material is subjected to thermal development at 120° C. for 20 sec., provided that the sensitivity is represented by a reciprocal of an exposure amount giving a density of 2.5 when the photographic material is subjected to the thermal development.

14. The photothermographic material of claim 1, wherein the photothermographic material meets the following requirement:
γ₁₁/γ₀>0.8
wherein γ₀ is a gamma value obtained when the photographic material is subjected to thermal development at 120° C. for 25 sec., and γ₁₁ is a gamma value obtained when the photographic material is subjected to thermal development at 120° C. for 20 sec., provided that the gamma value is represented by a slope of a straight line connecting densities of 0.1 and 2.5 on a characteristic curve obtained when the photographic material is subjected to the thermal development.

15. The photothermographic material of claim 1, wherein the photothermographic material meets the following requirement:
Dmax₁₁/Dmax₀>0.8
wherein Dmax₀ is a maximum density obtained when the photographic material is subjected to thermal development at 120° C. for 25 sec., and Dmax₁₁ is a maximum density obtained when the photographic material is subjected to the thermal development at 120° C. for 20 sec.

16. The photothermographic material of claim 1, wherein the photothermographic material meets the following requirement:
log(S₀/S₂₁)<1.0
wherein S₀ is a sensitivity obtained when the photographic material is subjected to thermal development at 120° C. for 25 sec., and S₂₁ is a sensitivity obtained when the photographic material is subjected to thermal development at 118° C. for 25 sec., provided that the sensitivity is represented by a reciprocal of an exposure amount giving a density of 2.5 when the photographic material is subjected to the thermal development.

17. The photothermographic material of claim 1, wherein the photothermographic material meets the following requirement:
Dmax₂₁/Dmax₀>0.7
wherein Dmax₀ is a maximum density obtained when the photographic material is subjected to thermal development at 120° C. for 25 sec., and Dmax₂₁ is a maximum density obtained when the photographic material is subjected to thermal development at 118° C. for 25 sec.

18. An image forming method of a photothermographic material comprising the steps of:
imagewise exposing the photothermographic material to a laser, and subjecting the exposed photothermographic material to thermal development by the use of an automatic thermal processor,
wherein the photothermographic material comprising a support, a silver halide, an organic silver salt and a reducing agent, wherein the photothermographic material meets the following requirement:
γ₂₁/γ₀>0.7
wherein γ₀ is a gamma value obtained when the photographic material is subjected to thermal development at 120° C. for 25 sec., and γ₂₁ is a gamma value obtained when the photographic material is subjected to thermal development at 118° C. for 25 sec., provided that the gamma value is represented by a slope of a straight line connecting densities of 0.1 and 2.5 on a characteristic curve obtained when the photographic material is subjected to the thermal development.

19. The image forming method of claim 18, wherein the automatic thermal processor comprises a planar heating member and a transport roller and the photothermographic material is allowed to pass through between the transport roller and the planar heating member, while the photothermographic material is brought into contact with the planar heating member to be thermally developed.

20. The image forming method of claim 19, wherein the planar heating member comprises a gigged material.
